(19) United States
(12) Patent Application Publication
(10) Pub. No.: US 2024/0295088 A1
(43) Pub. Date: Sep. 5, 2024

(54) SYSTEMS AND METHODS FOR MANUFACTURING LOW-CARBON WARM MIX ASPHALT AND HOT MIX ASPHALT

(71) Applicant: Lawrence Livermore National Security, LLC, Livermore, CA (US)

(72) Inventors: Thomas A. BUSCHECK, Pleasanton, CA (US); Jeffrey A. BUSCHECK, Davis, CA (US)

(21) Appl. No.: 18/116,191

(22) Filed: Mar. 1, 2023

(51) Int. Cl. E01C 23/14; F27D 1/00

(52) U.S. Cl. CPC E01C 23/14; F27D 1/0033; F27D 2099/0083

(57) ABSTRACT

The present disclosure relates to a system for storing and time-shifting at least one of electrical power, excess electrical power, or renewable electrical power, to create low-carbon heat for future use in assisting with a production of asphalt paving material. The system makes use of a first thermally insulated storage subsystem containing a quantity of an asphalt paving material manufacturing component, and a first furnace configured to heat the asphalt paving material manufacturing component using an available supplemental energy source. A second thermally insulated storage subsystem is used to store a quantity of asphalt binder, and a second furnace is used to heat the quantity of asphalt binder. An air blower is used to supply a quantity of air to the first furnace to assist in a heating during a heat-charge phase of operation of the system in which both the quantity of asphalt paving material manufacturing component and the quantity of asphalt binder are pre-heated.

### STATEMENT OF GOVERNMENT RIGHTS

This invention was made with Government support under Contract No. DE-AC52-07NA27344 awarded by the United States Department of Energy. The Government has certain rights in the invention.

### FIELD

The present disclosure relates to systems and methods for producing process heat with near-zero CO₂ emissions for the manufacture of warm mix asphalt (WMA) and hot mix asphalt (HMA). Conventional WMA and HMA plants use fossil fuel, mainly natural gas (NG), propane, or fuel oil to generate combustion heat required in the manufacturing process. The systems and methods of the present disclosure can replace combustion heat with renewable energy in the form of electricity from variable renewable energy (VRE), such as photovoltaic (PV) solar power and clean hydrogen (H₂).

### BACKGROUND

The statements in this section merely provide background information related to the present disclosure and may not constitute prior art.

Nearly a quarter of carbon emissions are from industrial heat, primarily from high-temperature industrial processes. Efforts to reduce greenhouse gas (GHG) emissions have heretofore focused on power generation and renewable (geothermal and solar) heat, which is primarily used for power generation. The embodiments in this disclosure can enable a low-carbon production process by replacing a natural gas (NG), propane, or fuel-oil burner used in conventional asphalt mixing operations with the use of low-carbon energy sources to heat the raw materials (e.g., and without limitation, aggregate, reclaimed asphalt payment (RAP), reclaimed asphalt shingles, reclaimed tires, reclaimed plastic, and asphalt cement binder) before the raw materials are fed to the mixing operation.

In addition to enabling low-carbon manufacturing operations, the embodiments and methods described in the present disclosure are intended to improve the sustainability of warm mix asphalt (WMA) and hot mix asphalt (HMA). Much of the energy required in conventional WMA and HMA operations is used to dry and heat wet aggregate. Rapid heating of the aggregate is needed for a high throughput of warm or hot mix asphalt product. Very high flame temperature is used to heat the aggregate, causing the phase transition of pore water to steam to occur in a few seconds. However, rapid heating of the aggregate can also cause aggregate particles to explode, which can be hazardous for workers. Rapid heating can also result in aggregate degradation, dust, particle attrition and breakage, which reduces aggregate strength. Reduced aggregate strength can translate to lower strength in the asphalt pavement.

High temperatures also can lead to volatization and oxidation of the asphalt cement binder, which can result in less ductile asphalt pavement. Volatization and oxidation of the asphalt binder can also lead to the creation of blue smoke, which can be of concern if the WMA or HMA production processes is/are located close to populated areas.

The embodiments and methods of the present disclosure are intended to heat aggregate more slowly and at lower temperatures to reduce aggregate degradation, the loss of asphalt cement binder, the creation of dust and the associated bag-house filtration cost, and the creation of blue smoke.

### SUMMARY

This section provides a general summary of the disclosure, and is not a comprehensive disclosure of its full scope or all of its features.

In one aspect the present disclosure relates to a system for storing and time-shifting at least one of electrical power, excess electrical power, or renewable electrical power, to create low-carbon heat for future use in assisting with a production of an asphalt paving material manufacturing component. The system may comprise a first thermally insulated storage subsystem containing a quantity of an asphalt paving material manufacturing component, and a first furnace configured to heat the asphalt paving material manufacturing component using an available supplemental energy source. The system may also include a second thermally insulated storage subsystem configured to store a quantity of asphalt binder, and a second furnace operably associated with the second thermally insulated storage subsystem for heating the quantity of asphalt binder. The system may also include an air blower configured to supply a quantity of air to the first furnace to assist in a heating during a heat-charge phase of operation of the system in which both the quantity of asphalt paving material manufacturing component and the quantity of asphalt binder are pre-heated.

The present disclosure also relates to a system for storing and time-shifting at least one of electrical power from a power grid, excess electrical power from a power grid, or renewable electrical power, to create low-carbon heat for use in preheating components used in manufacturing asphalt mix, and for manufacturing asphalt mix. The system may comprise a first thermally insulated storage subsystem containing a quantity of at least one of aggregate, reclaimed asphalt pavement (RAP), reclaimed asphalt shingles, reclaimed tires, or reclaimed plastic for use in manufacturing asphalt mix, and a first furnace configured to heat the at least one of the aggregate, the RAP, the reclaimed asphalt shingles, the reclaimed tires, or the reclaimed plastic using an available supplemental energy source. The system may include a second thermally insulated storage subsystem configured to store a quantity of asphalt binder, and a second furnace operably associated with the second thermally insulated storage subsystem for heating the quantity of asphalt binder. An air blower may be included and configured to supply a quantity of air to the first furnace to assist in a heating during a heat-charge phase of operation of the system. An asphalt mixing subsystem may be included which is configured to carry out a heat-discharge operation. The heat-discharge operation may include receiving at least one of the aggregate, RAP, reclaimed asphalt shingles, reclaimed tires, reclaimed plastic or a mixture thereof, and the asphalt binder, and then mixing the at least one of aggregate, RAP reclaimed asphalt shingles, reclaimed tires, reclaimed plastic or mixture thereof, and the asphalt binder to produce at least one of hot mixed asphalt (HMA) or warm mixed asphalt (WMA).

In still another aspect the present disclosure relates to a method for storing and time-shifting at least one of electrical power, excess electrical power, or renewable electrical power, to create low-carbon heat for future use in assisting with a production of asphalt mix. The method may comprise using a first thermally insulated storage subsystem to store at least one of a quantity of aggregate or a quantity of at least one of reclaimed asphalt pavement (RAP), reclaimed asphalt shingles, reclaimed tires, or reclaimed plastic. The method may further include using a first furnace to heat at least one of the aggregate, using an available supplemental energy source, to a temperature of between 120-200° C., or to heat the at least one of RAP, reclaimed asphalt shingles, reclaimed tires, reclaimed plastic or a mixture thereof, using the available supplemental energy source, to a temperature between 50-100° C. The method may further include using a second thermally insulated storage subsystem to store a quantity of asphalt binder, and using a second furnace to heat the quantity of asphalt binder. The method may further include supplying a quantity of air to at least one of the first furnace to assist in heating during a heat-charge phase of operation in which both the quantity of asphalt manufacturing component and the quantity of asphalt binder are pre-heated.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a high level block diagram illustrating one embodiment of the present disclosure relating to a multi-fluid, Earth Battery energy system, which can be called the CAES Earth Battery with Combined Cycle Power Generation, including recharging systems for air compression, plus brine heating and pressurization, and the discharging, power-generation system, with natural gas (NG) turbines, steam turbines, and CO₂ Brayton-cycle turbines, pre-heated by stored hot brine. In the drawing Figures and following text, it will be noted that “Brayton cycle” has been used, but it will be understood that this may include Rankine cycle systems, such as the CO₂ Allam cycle.

FIG. 1a is a high level block diagram illustrating one optional cooling subsystem that may be incorporated into the various embodiments described in the present disclosure, which involves a two-stage heat exchanger system in which water or brine at different temperatures may be used to help achieve the second stage cooling;

FIG. 2 is a high level block diagram showing another embodiment of the present disclosure relating to a CO₂ Earth Battery energy system, including a recharging system for CO₂ compression, plus brine heating and pressurization, and the discharging, power-generation system, with CO₂ Brayton-cycle turbines and steam turbines, pre-heated by stored hot brine;

FIG. 3 is a high level diagram illustrating a thermal recharge cycle for the system of FIG. 1 and/or FIG. 2;

FIG. 4 is a high level diagram illustrating operations associated with a supplemental, non-aqueous fluid recharge cycle for the system shown in FIG. 1 and/or FIG. 2;

FIG. 5 is a high level diagram illustrating operations associated with an energy discharge cycle for the system shown in FIG. 1 and/or FIG. 2;

FIG. 6 shows another embodiment of the present disclosure relating to a two-tank, insulated, pressurized, hot aqueous fluid storage system;

FIG. 7 is a high level block diagram showing another system in accordance with the present disclosure for storing excess energy as thermal energy in a plurality of distinct storage zones within a geologic region, and moving brine within the storage zones as needed to balance the quantities of different temperature stored brine;

FIG. 8 is a more detailed block diagram of a system similar to that shown in FIG. 7 for storing excess energy in three distinct brine-temperature storage zones within a permeable geologic region;

FIG. 9 is a high level block diagram of an embodiment of the compressed air energy storage (CAES) version of the Earth Battery of FIG. 1, which includes the option of operating in “baseload” mode where a high-pressure (HP) compressor is used to supply compressed air, rather than compressed air produced from the CAES subsurface storage reservoir, and which also incorporates the high-/very-high-temperature, thermal energy storage reservoir system to further enhance the overall efficiency of energy production of the CAES version of the system, and further illustrating with coded flow arrows the charge and discharge flows (high and low pressures, respectively) of the flows occurring in the overall system;

FIG. 9a shows an optional embodiment of the thermal energy storage reservoir system that employs a stack of two serially-connected, sand- and/or rock-filled tanks for the CAES version of the Earth Battery, a first tank operating as a high temperature thermal storage tank and which feeds a second tank operating as a very high temperature thermal storage tank;

FIG. 10 is a high level block diagram of an embodiment of the CO₂ Brayton-cycle version of the Earth Battery of FIG. 2 which includes the high-/very-high-temperature, thermal energy storage reservoir system to further enhance the overall efficiency of energy production of the overall system, and further illustrating with coded flow arrows the charge and discharge flows during the charge and discharge modes of operation of the overall system;

FIG. 10a shows an optional embodiment of the thermal energy storage reservoir system that employs a stack of two serially-connected, sand- and/or rock-filled tanks for the CO₂ Brayton-cycle version of the Earth Battery, a first tank operating as a high temperature thermal storage tank and which feeds a second tank operating as a very high temperature thermal storage tank;

FIG. 11 is a high level process flow block diagram of an embodiment for a steam-turbine version of the Thermal Earth Battery of FIG. 8 which incorporates the high-/very-high-temperature, thermal energy storage reservoir system, and which also illustrates coded flow arrows to show the charge and discharge flows during charge and discharge modes of operation of the overall system; and

FIG. 11a shows an optional embodiment of the thermal energy storage reservoir system that employs two serially-connected, sand- and/or rock-filled tanks for the steam-turbine version of the Thermal Earth Battery, a first tank operating as a high temperature thermal storage tank and which feeds a second tank operating as a very high temperature thermal storage tank;

FIG. 12 is a high level block diagram of one embodiment of a system in accordance with the present disclosure, with operations labeled to explain a “charge” process with oxy-combustion that the system carries out;

FIG. 13 is a high level block diagram of one embodiment of a system in accordance with the present disclosure, with operations labeled to explain a “charge” process with air combustion that the system carries out;

FIG. 14 shows additional components of the system to illustrate how a discharge operation may be carried out to generate electricity;

FIG. 15 is a high level block diagram of another embodiment of a system in accordance with the present disclosure which illustrate discharge operations undertaken for cement manufacture;

FIG. 16 is a high level block diagram of major components of another embodiment of a heat storage and time shifting system that makes use of supercritical CO₂ as a working fluid, and where the components shown in FIG. 16 are used during a charge cycle of operation of the system;

FIG. 17 is a high level block diagram of the system of FIG. 16 showing various additional components that are during a discharge cycle of operation, and which form a heat recuperation subsystem for assisting in driving a Brayton-cycle turbine using heated sCO₂ for a one-stage sCO₂-heating process;

FIG. 18 is a high level block diagram of the system of FIG. 16 showing various additional components that are during a discharge cycle of operation, and which form a heat recuperation subsystem for assisting in driving a Brayton-cycle turbine using heated sCO₂ for a two-stage sCO₂-heating process;

FIG. 19 is a high level block diagram showing components of one embodiment of the present disclosure which uses a pair of granular medium storage reservoir subsystems and an oxy-combustion furnace to store heat to be used in a subsequent manufacturing operation;

FIG. 20 is a high level block diagram showing additional components used with the system of FIG. 19 during a heat discharge stage of operation for carrying out one-step heating of H₂ using a steam methane reformer (SMR) and water-gas-shift operation;

FIG. 21 is a high level block diagram showing additional components used with the system of FIG. 19 used to carry out a heat discharge stage of operation for two-step heating of H₂ using a SMR/water-gas-shift operation;

FIG. 22 is a high level block diagram showing additional components used with the system of FIG. 19 to carry out a heat discharge stage of operation for one-step heating of crude oil for fractional distillation;

FIG. 23 is a high level block diagram showing additional components of the system of FIG. 19 used to carry out a heat discharge stage of operation for two-step heating of crude oil for fractional distillation;

FIG. 24 is a high level block diagram of a different embodiment of the present disclosure which uses dual granular media heat storage reservoir subsystems and an electrical furnace to help heat the granular media;

FIG. 25 is a high level block diagram of a different embodiment of the present disclosure which uses dual granular media heat storage subsystems, an oxy-combustion furnace, and electricity, including excess electricity from the power grid and/or electricity from variable renewable energy (VRE) sources, to create carbon-neutral or carbon-negative heat;

FIG. 26 is a high level block diagram of additional components used with the system of FIG. 24 for supplying carbon-neutral or carbon-negative heat to a steam methane reformer (SMR) for carrying out an SMR operation to produce a hit mixture of H₂ and CO, which are the reducing gasses for a direct reduced iron (DRI) shaft furnace;

FIG. 27 is a high level block diagram of another embodiment of the present disclosure for carrying out a heat discharge stage of operation for supplying carbon-neutral or carbon-negative H₂ and CO to a DRI shaft furnace to produce very-hot DRI, and wherein iron ore pellets deliver the majority of the heat needed by the DRI shaft furnace;

FIG. 28 is a high level block diagram of another embodiment of the present disclosure for carrying out a heat discharge stage of operation in which carbon-neutral or carbon-negative heat is supplied as a hot reducing gas, the hot reducing gas forming a mixture of carbon-neutral or negative H₂ and CO, to a DRI shaft furnace to produce very-hot DRI;

FIG. 29 is a high level block diagram of another embodiment of the present disclosure for carrying out a two-step pre-heating operation to pre-heat heat scrap metal, using one or more renewable energy sources; and

FIG. 30 is a high level block diagram of another embodiment of the present disclosure disclosing a liquid-to-gas-to-solid heat exchanger system and process which is used in the first step of pre-heating scrap metal.

FIG. 31 is a high level block diagram of a system in accordance with another embodiment of the present disclosure for implementing a heat charge operation for an asphalt mixing operation by storing granular media in a first insulated vessel, and using a first electrical furnace to create carbon-neutral heat when electricity can be supplied to the furnace from a variable renewable energy (VRE) source, or when electricity, such as excess power, available from a power grid is supplied to the electric furnace; and wherein a second electrical furnace is used to heat asphalt cement binder, which is stored in a second insulated vessel. The heat-storage medium used in the first insulated vessel may be either aggregate or reclaimed asphalt pavement (RAP);

FIG. 32 is a high level block diagram of a system in accordance with another embodiment of the present disclosure for carrying out a heat-charge stage for an asphalt mixing operation, and wherein granular media is stored in an insulated vessel, and a furnace using natural gas (NG), propane, fuel oil, biomass, hydrogen (H₂), or a combination thereof is used to create heated aggregate with a reduced carbon footprint; and

FIG. 33 is a high level block diagram of a system in accordance with another embodiment of the present disclosure illustrating a heat-discharge stage of operation for an asphalt mixing operation; and wherein the delivery of pre-heated raw materials allows the option of removing the gas burner from those operations; and wherein medium-temperature aggregate is conveyed from an insulated storage vessel to an asphalt mixing operation; and wherein optionally, cool aggregate may also be conveyed from aggregate stockpiles; and wherein reclaimed asphalt pavement (RAP), either from stockpiles or medium-low-temperature RAP from an insulated storage vessel, may also be conveyed to the asphalt mixing operation; and wherein medium-temperature asphalt cement binder is also sent from an insulated storage vessel to the asphalt mixing operation;

### DETAILED DESCRIPTION

The following description is merely exemplary in nature and is not intended to limit the present disclosure, application, or uses. It should be understood that throughout the drawings, corresponding reference numerals indicate like or corresponding parts and features.

Unlike pumped hydro energy storage (PHES), the systems and methods of the present disclosure require a permeable geologic formation, which is overlain by an impermeable geologic formation (also referred to as the “caprock”), and a surface power system having only a minimal surface footprint, compared to the subsurface storage aspects. The systems and methods disclosed herein are deployable in saline aquifers suitable for CO₂ storage that occur over half of the contiguous U.S. The systems and methods disclosed herein can also work in widespread hydrocarbon reservoirs, where resources and infrastructure can be leveraged to reduce cost and risk. Many geothermal reservoir systems are in low-to-medium temperature resources that limit power-conversion efficiency, using conventional systems and methods. Some saline aquifers and hydrocarbon reservoirs can be efficiently utilized by the systems and methods of the present disclosure as low-to medium-temperature geothermal resources, because those resources are used as a bottoming cycle before higher temperature thermal resources are used. Battery storage is associated with short operating lifetimes. Based on relevant well-field and power-system experience, operating lifetimes of the systems and methods disclosed herein may significantly exceed those of battery storage.

### CAES Earth Battery and Combined-Cycle Power Generation

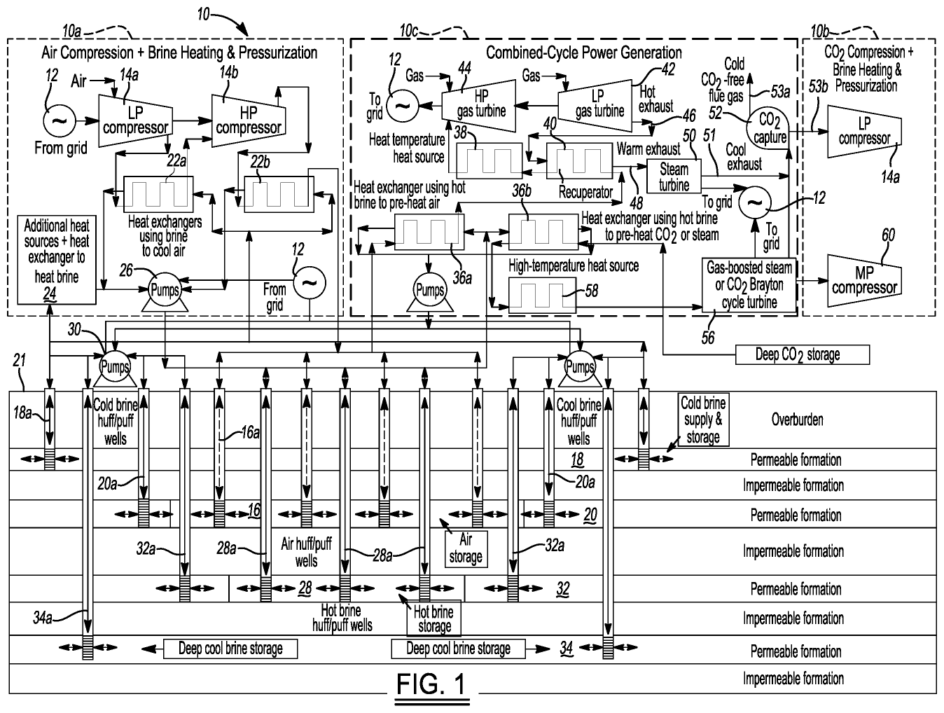

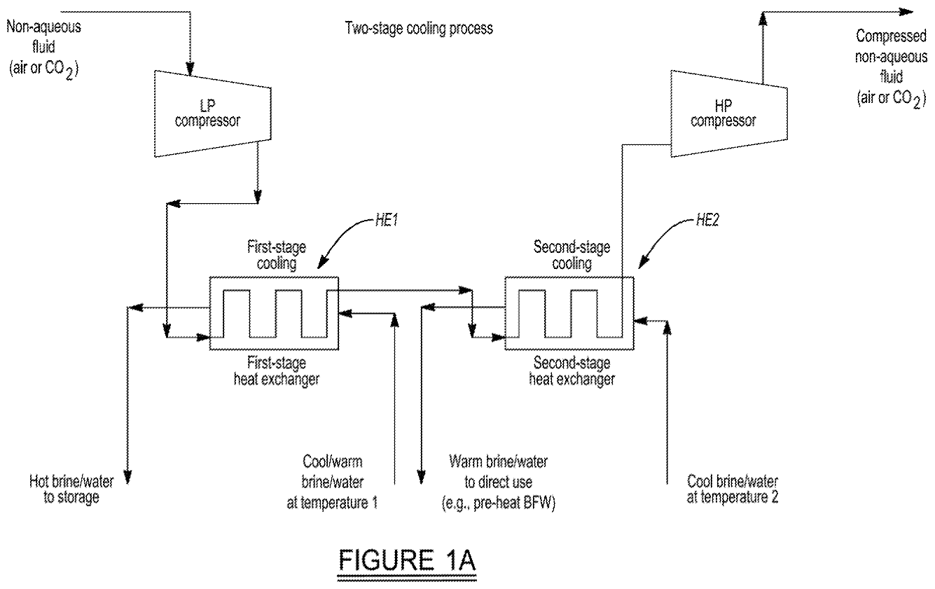

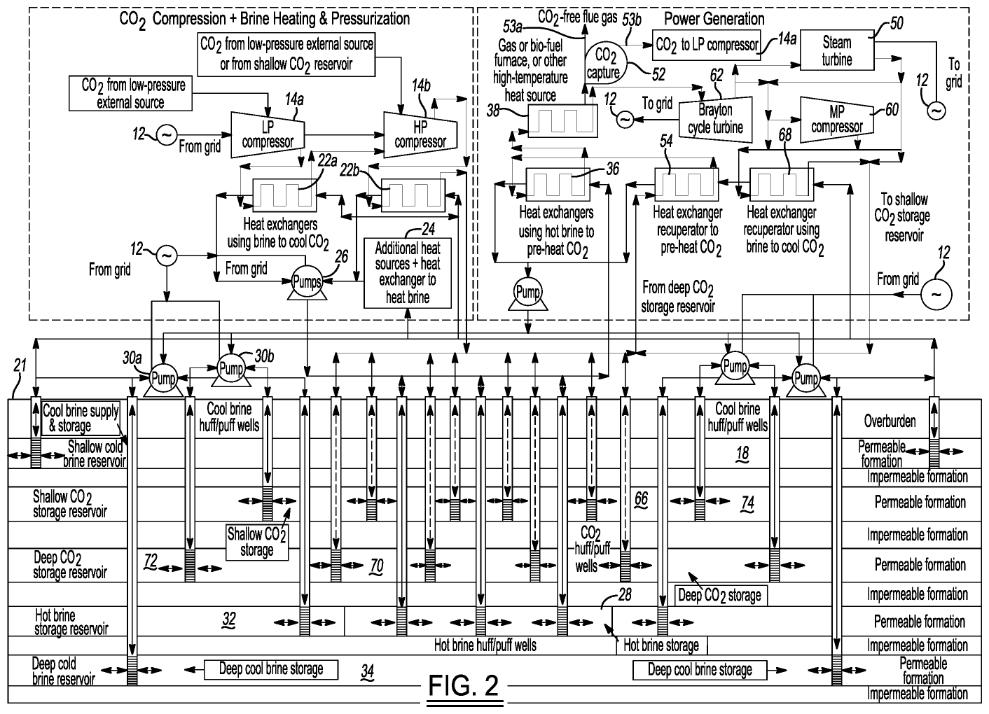

Referring to FIG. 1, an Earth Battery system 10 in accordance with one embodiment of the present disclosure is shown. More broadly, the Earth Battery system 10 is used to store excess electricity by using it to compress and store air and CO₂ in underground permeable reservoir formations (FIGS. 1 and 2). It will be understood that a reservoir formation can comprise either a geologic formation that has never been used in a reservoir operation or one that has been used in a reservoir operation. In the embodiment shown in FIG. 1, where it is used to store air underground, it is referred to as the CAES Earth Battery. The Earth Battery system 10 integrates conventional and renewable energy resources, allowing each resource to contribute more efficiently to an electric power grid than if operated independently of, or separately from, one another. The Earth Battery system 10 involves technology which makes use of existing technology that, when efficiently integrated, results in major, transformational advances for clean energy production and storage. To this end, the Earth Battery system 10 has a number of distinct advantages over previously developed systems which attempt to store energy using the Earth, some of which may be summarized as follows:
most of the wells used with the present disclosure may be termed “huff/puff” wells, which are used both for fluid injection and fluid production (also referred to as fluid withdrawal throughout this disclosure);
the heat of air, N₂, and CO₂ compression is used to heat formation brine, which is pressurized with excess electricity and stored in a reservoir;
when energy is needed, nonaqueous fluids (either air, N₂, CO₂, or mixtures of N₂ and CO₂) plus hot aqueous fluids (hot brine and/or hot water) are produced, with any of these nonaqueous fluids being pre-heated with hot aqueous fluids before, in the case of air, entering a either a NG turbine or an expander which does not include NG combustion, or, in the case of N₂ or CO₂ or mixtures of N₂ and CO₂, a coal-, biomass-, or NG-fired Brayton-cycle turbine, or a Brayton-cycle turbine that does not include NG combustion (in the drawing Figures it will be noted that “CO₂” has been used, but it will be understood that this includes CO₂, N₂ or mixtures thereof);
the compressed air energy storage (CAES)/NG-turbine system can provide short-duration (diurnal to several days) energy storage and the N₂/CO₂ Brayton-cycle power system can provide combinations of short-duration (diurnal to several days), medium-duration (week-long), and long-duration (seasonal) energy storage;
a steam turbine power system can also be used to provide combinations of short-duration, medium-duration, and long-duration energy storage;
the Earth Battery system 10 can also store heat from other sources, such as baseload or solar thermal energy (STE) thermo-electric power when heat is not needed to generate electricity from those resources;
all heat sources are sequentially used (from low-to high-temperature) to pre-heat air, N₂, CO₂, or mixtures of N₂ and CO₂, providing a bottoming cycle for either an expander, a NG turbine, a coal-, biomass-, or NG-fired N₂/CO₂ Brayton-cycle turbine, or a coal-, biomass-, or NG-fired steam turbine. Coal, biomass, or NG may be used in a topping cycle, so their value is even greater than in conventional power systems;
all CO₂ from flue gas may be captured and stored in the reservoir, enabling zero-carbon operation;
besides on-site and imported NG, the Earth Battery system 10 can make use of biomass for the topping cycle, adding a bioenergy (BE), CO₂-capture and storage (BECCS) operation, resulting in negative CO₂ emissions;
CO₂ can be imported to increase CO₂ and energy-storage capacity; CO₂ may also be stored at different depths underground to create a potential energy difference, similar to pumped hydro energy storage (PHES); but unlike PHES, the Earth Battery system 10 forms a subsurface approach which has a minimal surface footprint, compared to the subsurface storage aspects of the Earth Battery; and
while the Earth Battery system 10 can use two or more permeable reservoir formations, with each overlain by an impermeable caprock formation, it can also be deployed in just one permeable reservoir formation overlain by an impermeable caprock if huff/puff wells are used for a three-cycle process of thermal recharge, supplemental, non-aqueous fluid (air, N₂, CO₂, or mixtures of N₂ and CO₂) recharge, and energy discharge. Furthermore, it will be appreciated that any reference herein to an aqueous fluid shall encompass brine, or combinations of brine and fresh water, or fresh water.

Referring further to FIG. 1, the Earth Battery system 10 thus forms a combined-cycle CAES Earth Battery which is able to receive excess electricity from an electric power grid 12. The system 10 may be viewed as including an air compression and brine heating and pressurization subsystem 10a, a CO₂ compression and brine heating and pressurization subsystem 10b, and a combined-cycle power generation subsystem 10c. The system 10 may use the excess electricity to compress air in one or more compression stages 14a, 14b, with the compressed air being injected, using one or more huff/puff wells 16a, into a permeable reservoir formation 20 which forms an air storage zone 16. As is well known, the compression of air causes its temperature to rise. For efficient compression, air should be cooled after each compression stage. For cooling purposes, cool brine may be produced using one or more huff/puff wells 18a, from shallow permeable reservoir formations 18 below a ground surface 21, and/or deeper permeable reservoir formations 20,32,34 via one or more pluralities of huff/puff wells 20a, 32a and 34a, respectively. Cool brine can also be imported from an SBS (“separate brine source”) 340, which can comprise at least one of a separate geologic formation or a separate brine reservoir, including man-made structures. It will be understood what is meant by “cool” brine is brine at an ambient temperature from where it was produced underground, which is called “cool” brine because it is cooler than stored hot brine. In this disclosure we also call this ambient-temperature brine “warm” brine because it is derived from geologic formations that are typically warmer than room-temperature water and can be useful in pre-heating room-temperature fluids, such as boiler feedwater. The use of a shallow permeable reservoir formation may be particularly useful where such formations contain fresh water and where fresh water resources are abundant. Initially, the extraction of brine or fresh water may require down-hole pumps in the wells to extract the brine or fresh water, but eventually these permeable formations will become sufficiently overpressured with the storage of either air, cool brine, or hot brine to cause the cool brine to flow to the ground surface 21 under artesian conditions. The cool brine, or cool fresh water if it is available, may be put through heat exchangers 22a,22b that follow each compression stage. It should be noted that it may be necessary to use one or more booster pumps 13 so that the pressure of the cool brine is high enough to prevent the brine from flashing to steam when the cool brine is put through and heated in heat exchangers 22a,22b.

Following one or more compression stages, it is optional, but potentially desirable, to use a two-stage, air-cooling process that uses heat exchangers coupled in series, such as shown in FIG. 1a. In FIG. 1a, a first cooling stage, represented by a first stage heat exchanger HE1, and a second cooling stage, represented by a second stage heat exchanger HE2, are shown. Air (or even CO₂) is put through the first-stage heat exchanger HE1 where it is cooled by either cool or warm brine (as described above). The air that exits the first-stage heat exchanger HE1 may be put through the second-stage heat exchanger HE2 where it is cooled further. The additional cooling may be achieved using either cool water or brine having a temperature lower than the temperature of the cool or warm brine used in the first cooling stage with the first heat exchanger HE1. The two-stage cooling process improves the overall efficiency of the air-compression system. The two-stage cooling process also produces a stream of high-temperature brine, which may be pressurized and sent into storage, and a stream of medium-temperature water or brine, which can be used for some other purpose, such as pre-heating boiler feedwater in a steam-turbine power system in accordance with other embodiments of the present disclosure.

With further reference to FIG. 1, in addition to the heat of air compression, other sources of heat 24 may be used by our technology, such as from a baseload thermo-electric power plant when it is generating too much power for the demand on the electric power grid 12. Such power plants may include nuclear, coal-fired, NG-fired, biomass-fired, or solar thermal energy. Other heat sources may include geothermal energy.

As air is cooled, brine, or fresh water, is heated in the heat exchangers 22a,22b. The heated brine may be pressurized using one or more pumps 26 so that the heated brine can be injected, using one or more huff/puff wells 28a, into an underground permeable reservoir formation which forms a hot brine, or hot water, storage zone 28. In addition to the option of storing pressurized hot brine or water underground in the hot brine storage zone 28, the hot brine or water, which was pressurized using pump 26, may be sent to one or more insulated, hot brine/water storage tanks 27, which is/are part of the two-tank, insulated, pressurized, aqueous fluid storage embodiment described later. Whether done underground or above-ground, this process enables the storage of energy as pressurized hot brine or pressurized hot water. For the following discussion, it will be appreciated that while cool brine or hot brine may be referenced, that fresh water (i.e., for example water of drinking quality) could also be used, and the following references to cool brine or hot brine are intended to encompass the uses of cool fresh water and hot fresh water as well.

Excess electricity from the grid 12 may be used to power one or more pumps 30 to pressurize cool brine produced from the shallow permeable reservoir formation 18 and/or the deeper 20,32 permeable reservoir formations, for injection into a deep permeable reservoir formation 32, or an even deeper permeable warm brine, reservoir formation 34, for the purpose of storing energy as pressurized cool brine. The use of huff/puff wells 18a,20a,32a,34a enables efficient recovery of the stored, pressurized energy.

When electricity is demanded by the grid 12, pressurized air is allowed to flow from the air storage zone 16 up to the ground surface 21, after which it enters heat exchangers 36a and 36b. To assist the upward flow of air, pressurized warm brine from the deep permeable reservoir formation 34 may be produced, using one or more huff/puff wells 34a, and allowed to flow under pressure, or be further pressurized (if necessary) by one or more pumps 30, so that it can be injected into the air storage reservoir 20, using one or more huff/puff wells 20a, which is/are just outside of the air storage zone 16. Thus, the warm brine acts like a piston, providing pressure support to sustain the upward flow of air. Pressurized hot brine is allowed to flow up one or more huff/puff wells 28a from the hot brine storage zone 28 up to the heat exchangers 36a, 36b to heat the air. In addition, pressurized hot brine or hot water may be allowed to flow from the one or more insulated hot brine/water storage tanks 27 to the heat exchangers 36a,36b to heat the air. The cool brine leaving the heat exchangers 36a,36b is pressurized using one or more pumps 37 so it can be injected, using at least one of huff/puff wells 20a,32a, into the permeable reservoir formations 20,32 to provide pressure support to assist in the upward flow of air from the air storage zone 16 and the upward flow of hot brine from the hot brine storage zone 28. Some of the cool brine or cool water pressurized by pump 37 may also be sent to one or more cool brine/water storage tanks 35, which is/are part of the two-tank, insulated, pressurized, aqueous fluid storage embodiment described later. To further assist the upward flow of hot brine from the hot brine storage zone 28, pressurized warm brine from the deep permeable reservoir formation 34 may be produced, using one or more huff/puff wells 34a, and allowed to flow under pressure, or be further pressurized (if necessary) using one or more pumps 30, so that it can be injected into the hot brine storage reservoir 32, using one or more huff/puff wells 32a, which is/are just outside of the hot brine storage zone 28. Thus, warm brine acts like a piston, providing pressure support to sustain the flow of hot brine and to help prevent hot brine from flashing to steam. One such set of heat exchangers 38 may be heated by various above-ground high-temperature heat sources, such as from solar thermal energy. Still another set of heat exchangers 40 may form a “recuperative” set of heat exchangers and may be heated by the hot exhaust 46 from the final NG turbine 42. The heat-exchanger sequence in this example is from the lowest to the highest temperature heat source (i.e., from low-temperature heat exchanger 36 to medium-temperature heat exchanger 40 to high-temperature heat exchanger 38).

After the air exits one or more of the high-temperature heat exchangers 38, it enters a high-pressure NG turbine 44, or it may enter an expander (not shown) that does not include NG combustion. The air goes through one or more stages of the NG turbines 42 and/or 44, or expanders that do not include NG combustion, or an expander (not shown) that does not include NG combustion, which feeds one or more stages of the NG turbines. The NG turbines 42/44 and/or expanders may power generators that deliver electricity to the grid 12.

If NG turbines are used, hot exhaust flue gas 46 exiting the final NG turbine 42 enters the recuperator heat exchanger 40 that heats air prior to the air entering either the high-temperature heat exchanger 38, the NG turbine 44, or an expander that does not use NG combustion.

The warm exhaust flue gas 48 that exits the recuperator heat exchanger 40 may enter a heat recovery steam generator (HRSG) coupled to a steam turbine 50 to generate electricity for the grid 12. Cool exhaust flue gas 51 that exits the HRSG plus steam turbine 50 may enter a CO₂-capture system 52 that generates CO₂-free flue gas 53a and high-purity CO₂ (53b). The captured CO₂ enters a low-pressure compressor 14a where it is compressed for storage. Details of the CO₂ compression and storage process are described in the following paragraphs for the CO₂ Earth Battery embodiment.

The CO₂ Brayton-cycle turbine power system (components 56, 36b, 58, and 60) are described in greater detail in FIG. 2 and in the CO₂ Earth Battery embodiment.

### CO₂ Earth Battery

Referring now to FIG. 2, a CO₂ Earth Battery system 100 is shown in FIG. 2. This embodiment makes use of certain of the same components as the system 10 of FIG. 1, and common components will be designated using the same reference numbers. The system 100 uses excess electricity from the grid 12 to compress CO₂ in one or more compression stages 14a, 14b, with the compressed CO₂ being injected into a permeable reservoir formation 72 which forms a deep CO₂ storage zone 70, via one or more huff/puff wells 70a. The compression of CO₂ causes its temperature to rise. For efficient compression, CO₂ needs to be cooled after each compression stage. For cooling purposes, cool brine is produced, using one or more huff/puff wells 18a, from either the shallow permeable reservoir formation 18 or the deeper permeable reservoir formations 72,74, using at least one of huff/puff wells 72a, 74a. Initially, this may require down-hole pumps to extract the brine, but eventually these permeable formations will become sufficiently overpressured with the storage of either CO₂, cool brine, or hot brine to cause the cool brine to flow up to the ground surface 21 under artesian conditions. Cool brine can also be imported from an SBS (‘separate brine source”) 340, which can comprise at least one of a separate geologic formation or a separate brine reservoir, including man-made structures. The cool brine is put through heat exchangers 22a,22b that follow each compression stage. It should be noted that it may be necessary to use one or more booster pumps 25 so that the pressure of the cool brine is high enough to prevent the brine from flashing to steam when the cool brine is sent through and heated in heat exchangers 22a,22b. Following one or more compression stages, it may be possible to use a two-stage, CO₂-cooling process that uses heat exchangers coupled in series, such as describe above in connection with FIG. 1a. In the first cooling stage, CO₂ is put through the first-stage heat exchanger HE1 where it is cooled by either cool or warm brine (as described above). The CO₂ that exits the first-stage heat exchanger HE1 may be put through the second-stage heat exchanger HE2 where it is cooled further using either cool water or brine having a temperature lower than the temperature of the cool or warm brine used in the first cooling stage. The two-stage cooling process improves the overall efficiency of the CO₂-compression system, while producing a stream of high-temperature brine, which may be pressurized and sent into storage, and a stream of medium-temperature water or brine, which can be used for some other purpose, such as pre-heating boiler feedwater in a steam-turbine power system in accordance with other embodiments of the present disclosure.

In addition to the heat of CO₂ compression, other sources of heat 24 may be used, such as from a baseload thermo-electric power plant when it is generating too much power for the demand on the grid 12. Such power plants may include nuclear, coal-fired, NG-fired, biomass-fired, or solar thermal energy. The other heat sources 24 may include geothermal energy. As CO₂ is cooled, brine is heated in the heat exchangers 22a,22b. The heated brine is pressurized using one or more pumps 26 so that it can be injected, using one or more huff/puff wells 28a, into a permeable reservoir formation which forms a hot brine storage zone 28. In addition to the option of storing pressurized hot brine or water underground in the hot brine storage zone 28, the hot brine or water, which was pressurized using pump 26, may be sent to one or more insulated, hot brine/water storage tanks 27, which is/are part of the two-tank, insulated, pressurized, aqueous fluid storage embodiment described later. Whether done underground or above-ground, this process enables the storage of energy as pressurized hot brine or pressurized hot water.

Excess electricity from the electric power grid 12 is used to power the pumps 30a, 30b to pressurize cool brine produced from the shallow and/or deeper permeable reservoir formations 18 and 72,74, using at least one of huff/puff wells 18a, 72a,74a, respectively, for injection into a deep permeable reservoir formation 32, using one or more huff/puff wells 32a, and/or into the even deeper permeable reservoir formation 34, using one or more huff/puff wells 34a for the purpose of storing energy as pressurized cool or warm brine.

When electricity is demanded by the electric power grid 12, pressurized CO₂ is allowed to flow from the deep CO₂ storage zone 70 up to the ground surface 21, via one or more huff/puff wells 70a, and into one or more heat exchangers 36, or possibly into one or more heat exchangers 54, before entering one or more heat exchangers 36, and then possibly into one or more heat exchangers 38 (as discussed below). The cool brine leaving the heat exchangers 36 is pressurized using one or more pumps 37 so it can be injected into the permeable reservoir formations 32,72, using at least one of huff/puff wells 32a,72a, to provide pressure support to assist in the upward flow of CO₂ from the CO₂ storage zone 70, via one or more huff/puff wells 70a, and the upward flow of hot brine from the hot brine storage zone 28, via one or more huff/puff wells 28a. Some of the cool brine or cool water pressurized by one or more pumps 37 may also be sent to one or more cool brine/water storage tanks 35, which is/are part of the two-tank, insulated, pressurized, aqueous fluid storage embodiment described later. To further assist the upward flow of CO₂, pressurized warm brine from the deep permeable reservoir formation 34 may be produced, using one or more huff/puff wells 34a, and allowed to flow under pressure, or be further pressurized (if necessary) by one or more pumps 30a, so that it can be injected into the deep CO₂ storage reservoir, via one or more huff/puff wells 72a, which is/are just outside the deep CO₂ storage zone 70. This causes the warm brine to act like a piston, providing pressure support to sustain the upward flow of CO₂, via one or more huff/puff wells 70a. To further assist the upward flow of hot brine, pressurized warm brine from the deep permeable reservoir formation 34 may be produced, using one or more huff/puff wells 34a, and allowed to flow under pressure, or be further pressurized (if necessary) using one or more pumps 30a, so that it can be injected into the hot brine storage reservoir 32, via one or more huff/puff wells 32a, which is/are just outside of the hot brine storage zone 28. Thus, warm brine acts like a piston, providing pressure support to sustain the upward flow of hot brine, via one or more huff/puff wells 28a, and to prevent hot brine from flashing to steam. Pressurized hot brine is allowed to flow from the hot brine storage zone 28, via one or more huff/puff wells 28a, up to the heat exchangers 36 to heat the CO₂. Heated CO₂ may flow into the additional series of heat exchangers 38,54. One such set or series of heat exchangers 38 may be heated by various above-ground high-temperature heat sources, such as from solar thermal energy. The other set of heat exchangers 54 may be heated by hot CO₂ after it has exited a medium-pressure compressor 60. The series of high-temperature heat exchangers 38 may also include NG-fired, coal-fired, and/or biomass-fired furnaces. Thus, NG, coal, and/or biomass combustion may be used in the final stages of temperature boosting before the heated CO₂ enters one or more Brayton-cycle turbines 62. The heat-exchanger sequence is preferably always from the lowest to the highest temperature heat source.

If NG, coal, or biomass is combusted to heat the CO₂, the CO₂ that was generated during combustion may be sent to a CO₂-capture system 52, which generates CO₂-free flue gas 53a and high-purity CO₂ 53b, which is then sent to a low-pressure compressor 14a prior to storage in the shallow CO₂ storage zone 66.

After CO₂ is pre-heated by one or more heat exchanger stages 54,36,38 (from lowest to highest temperature) and exits the final stage, which is either the hot brine heat exchanger(s) 36 or the high-temperature heat exchanger(s) 38, it may enter one or more Brayton-cycle turbines 62 to generate electricity for the electric power grid 12. Note that the high-temperature heat exchangers 38 may comprise a series of heat exchangers with successively higher heat sources (not expressly shown). If it is sufficiently hot after exiting the Brayton-cycle turbine(s) 62, the CO₂ may be sent to the HRSG plus steam turbine 50 to generate electricity for the electric power grid 12. Depending on the depth of the shallow CO₂ storage zone 66, the CO₂ may be sent to the medium-pressure compressor 60. Depending on the temperature of the CO₂ exiting either the HRSG plus steam turbine 50 or the medium-pressure compressor 60, the CO₂ may be sent to one or more recuperator heat exchangers 68, where cool brine produced from either the shallow permeable reservoir formation 18 or the shallow permeable CO₂ storage reservoir formation 74 is used to cool the CO₂ prior to its storage in the shallow CO₂ storage zone 66, using one or more huff/puff wells 66a.

Brine that is heated in the recuperator heat exchangers 68 may be sent to the recuperator heat exchangers 54, where the heated brine may be used to pre-heat CO₂ produced from the deep CO₂ storage zone 70, prior to that CO₂ entering at least one of one or more heat exchangers 36 and one or more heat exchangers 38.

During periods of excess power supply, CO₂ may be produced from the shallow CO₂ storage zone 66, via one or more huff/puff wells 66a, and allowed to flow to the ground surface 21. From the ground surface 21 the CO₂ may continue on into the high-pressure compressor 14b. Excess electricity from the electric power grid 12 is used to compress the CO₂ for injection and storage in the deep CO₂ storage zone 70, using one or more huff/puff wells 70a. To assist the flow of CO₂ from the shallow CO₂ storage zone 66 to the deep CO₂ storage zone 70, pressurized cool brine may be allowed to flow under pressure from the deep CO₂ storage reservoir formation 72, via one or more huff/puff wells 72a, or cool or warm brine may be allowed to flow from the deep warm brine reservoir formation 34, via one or more huff/puff wells 34a, up to the surface 21, and then back down to the shallow CO₂ storage reservoir formation 74, via one or more huff/puff wells 74a. If further pressurization is needed, one or more pumps 30b may be used to pressurize the cool brine after it leaves either the deep CO₂ storage reservoir 72 or the deep warm brine reservoir 34, and before it enters the shallow CO₂ storage reservoir 74. Thus, stored cool or warm pressurized brine is used to function like a piston that provides pressure support, which reduces the power required to compress the CO₂, while moving it from the shallow CO₂ storage zone 66 to the deep CO₂ storage zone 70. It should be noted that it is far more efficient to pressurize brine than it is to compress CO₂.

### Multi-Use Huff/Puff Wells for Thermal and Supplemental, Non-Aqueous Fluid Recharge and Energy Discharge

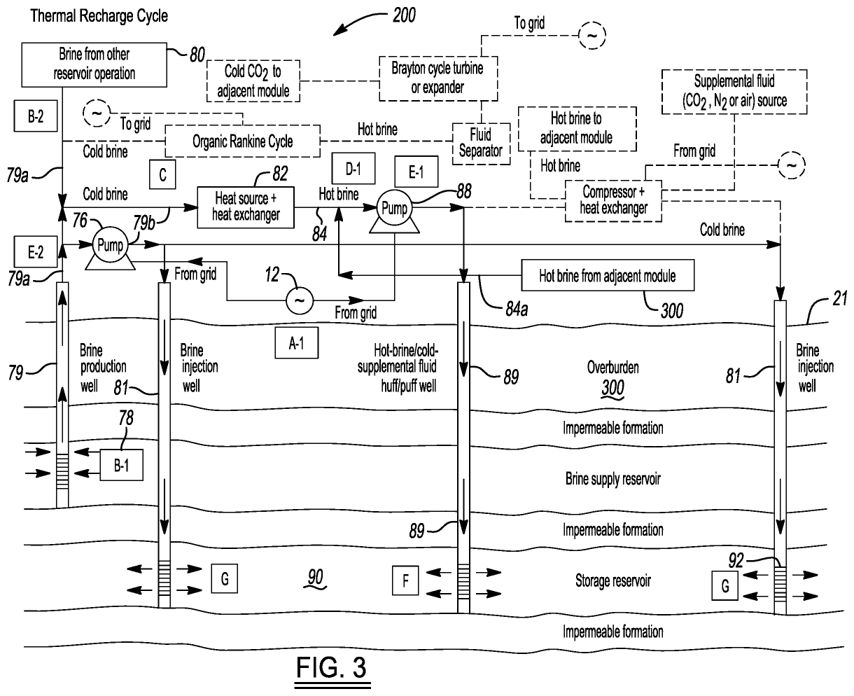

The present disclosure is able to utilize individual multi-use huff/puff wells for thermal recharge, supplemental, non-aqueous fluid recharge, and energy discharge. Referring to FIG. 3, a system 200 in accordance with another embodiment of the present disclosure is disclosed which implements thermal and supplemental, non-aqueous fluid recharge and energy discharge. Components in common with the systems 10 and 100 have been designated using the same reference numbers as those used to discuss the systems 10 and 100.

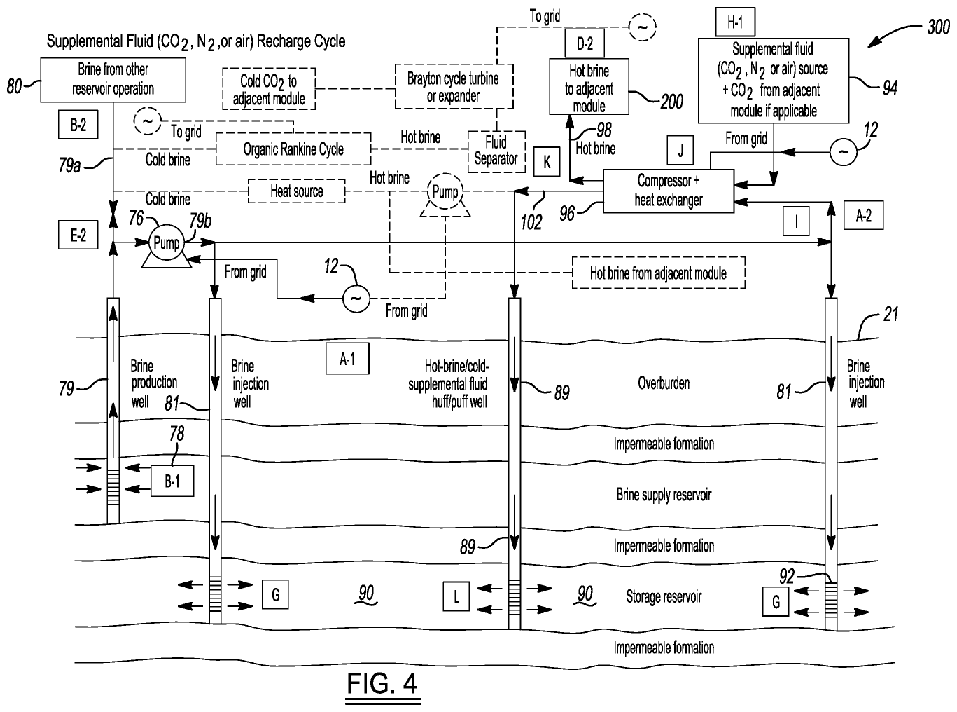

Excess electricity from the electric power grid 12 is used to power one or more pumps 76 that move cool brine 79a up through at least one brine production well 79 from at least one brine supply reservoir 78 and/or cool brine 80a from at least one separate reservoir operation 80, with one or more pumps 76 generating cool pressurized brine 79b, with is then sent into and through one or more brine injection wells 81, for use in the storage reservoir 90. Cool pressurized brine 79b may be fed to a heat exchanger 82, which uses a heat source to generate hot brine 84 for thermal energy storage. Hot brine 84a may also be brought in from at least one adjacent energy-storage module, which may comprise system 300 in FIG. 4, for thermal energy storage. Excess electricity from the electric power grid 12 is used to power one or more pumps 88 to pressurize the hot brine 84 (with or without hot brine 84a from an adjacent module) for injection into the storage reservoir 90 via at least one multi-use huff/puff well 89. Excess electricity from the electric power grid 12 may also be used to power one or more pumps 76 to inject cool pressurized brine 79b into one or more brine injection wells 81 for pressure support in the storage reservoir 90.

### Supplemental, Non-Aqueous Fluid Recharge

Referring to FIG. 4, a system 300 in accordance with another embodiment of the present disclosure is shown for performing supplemental, non-aqueous fluid recharging. Supplemental, non-aqueous fluid (CO₂, N₂, or air) is brought in from an external source 94, which is fed to a compressor and heat exchanger 96 powered with excess electricity from the electric power grid 12. Note that in the case of CO₂, the external source may be a CO₂ storage reservoir operated in conjunction with a geological CO₂ storage (GCS) operation. Excess electricity from the grid 12 is used to power one or more pumps 76 that move cool brine 79a from the brine supply reservoir 78 up through at least one brine production well 79, and/or cool brine 80a from at least one separate reservoir operation 80, with one or more pumps 76 generating cool pressurized brine 79b that is sent down through one or more brine injection wells 81 for use in the storage reservoir 90. Some of the cool brine 79a and/or 80a may also be put through one or more pumps 76 to generate cool pressurized brine 79b, which is used to cool compressed, supplemental, non-aqueous fluid flowing through the compressor and heat exchanger 96, which generates hot brine 98 and cooled, compressed, supplemental, non-aqueous fluid 102. The hot brine 98 may be sent to at least one adjacent energy-storage module, which may be system 200 discussed in connection with FIG. 3. It will be appreciated that a three-cycle system works especially well when deployed as two parallel modules. Thus, while module 300 is in cycle two, module 200 is in cycle one, and vice versa. The cooled, compressed, supplemental, non-aqueous fluid 102 may be injected into the storage reservoir 90, via at least one multi-use huff/puff well 89. Excess electricity from the electric power grid 12 may also be used to power the one or more pumps 76 to pressurize and inject cool brine 79b into one or more brine injection wells 81 to provide pressure support in the storage reservoir 90.

### Energy Discharge System

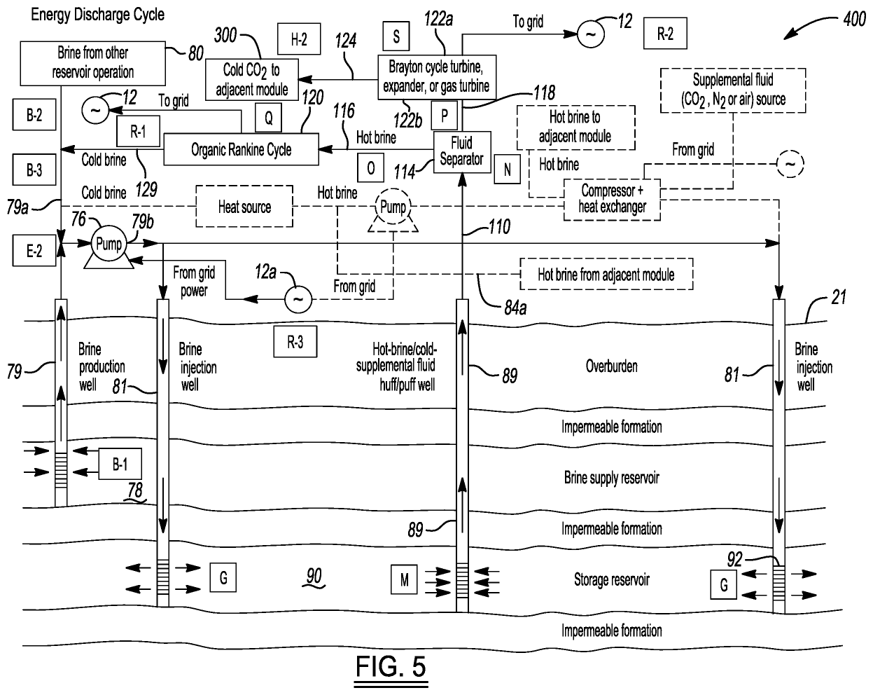

Referring to FIG. 5, an energy discharge system 400 is shown in accordance with still another embodiment of the present disclosure. The system 400 operates such that when electricity is needed, a mixture of pressurized fluids, including hot brine and hot, supplemental, non-aqueous fluid 110, is allowed to flow up at least one multi-use huff/puff well 89. The hot mixture of brine and supplemental non-aqueous fluid 110 is fed into a fluid separator 114 which separates hot brine 116 from hot, supplemental, non-aqueous fluid 118. The hot brine 116 may be fed to a conventional geothermal power system, such as an Organic Rankine Cycle system 120 or steam turbine system (not expressly shown), which generates electricity for the electric power grid 12. If the supplemental, non-aqueous fluid is N₂, CO₂, or a mixture of N₂ and CO₂, it may be fed to a Brayton-cycle turbine 122a, which generates electricity for the grid 12. If the supplemental, non-aqueous fluid is air, it may be fed to an expander or to a NG turbine 122b, which generates electricity for the grid 12. If air is used, it may be exhausted to the atmosphere (not expressly shown). If CO₂ is used, cold CO₂ 124 may be sent to at least one adjacent energy-storage module, which may be system 300 in FIG. 4, for compression and storage or it may be sent to a GCS operation. Some of the gross generated electric power 12a may be used to power the one or more pumps 76 to move cool brine from at least one brine supply reservoir 78 via at least one brine production well 79, and/or cool brine 80a imported from at least one separate reservoir operation 80, and/or cool brine 129 from the conventional geothermal power system (i.e., Organic Rankin Cycle system 120). This cool brine 129 may be sent to one or more pumps 76 to generate cool pressurized brine that is injected into the storage reservoir 90 via one or more brine injection wells 81 to provide pressure support in the storage reservoir 90.

### Two-Tank, Insulated, Pressurized, Aqueous Fluid Storage

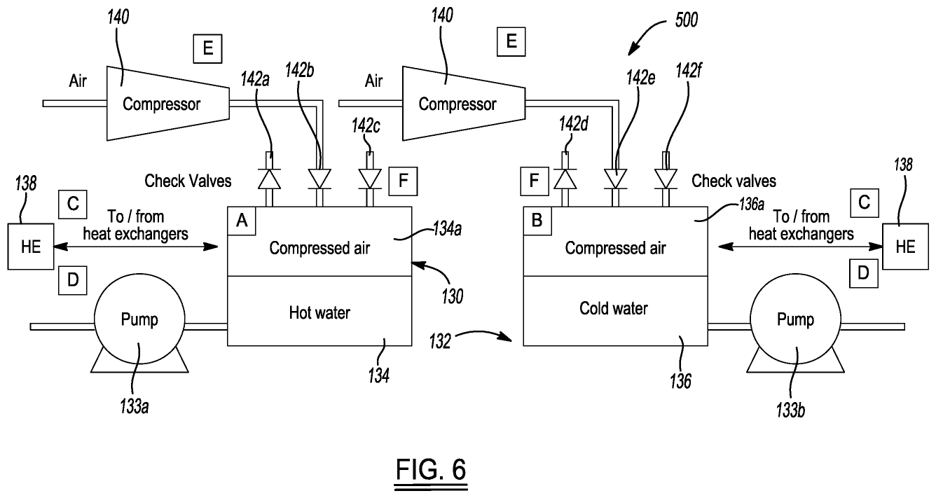

Referring now to FIG. 6, a two-tank, insulated, pressurized aqueous fluid (water, brine, or mixtures thereof) storage system 500 in accordance with another embodiment of the present disclosure is shown. Components used in this embodiment which are in common with one or more previously described embodiments are denoted with the same reference numbers.

The system 500 makes use a pair of insulated tanks, one being a hot tank 130 and one being a cool tank 132. (While the following description refers to water, it will be understood that this includes water, brine, or mixtures thereof.) The hot tank 130 may be used to store hot water 134 and the cool tank 132 may be used to store cool water 136. Both of the tanks 130 and 132 also serve to store their respective quantities of water under pressurization. It should be noted that these tanks may be located entirely above-ground, or they can be located either partially or fully underground. The high-temperature, pressurized water 134 may be fed to one or more heat exchangers 138, arranged in a loop, to transfer stored thermal energy from the hot water 134 to a supplemental, non-aqueous fluid (e.g., CO₂, N₂, or air). Each tank 130 and 132 is partially filled with pressurized water (i.e., either hot water 134 or cool water 136) and partially filled with quantities of compressed air 134a and 136a, respectively. To circulate fluids between the hot and cool storage tanks 130 and 132, and the heat exchangers 138, the pressure in the cool tank 132 needs to be close to that of the hot tank 130. One or more pumps 133a, 133b do most of the work required to circulate water through the heat exchangers 138. Air compressor(s) 140 is/are operated to maintain adequate pressure to prevent the hot water 134 from flashing to steam. Check valves 142a-142f may be used to protect the tanks 130 and 132 from over or under pressurization.

### Thermal Earth Battery

To even further augment the above-described Earth Battery system 10, additional new aspects of thermal energy storage (TES) can be used to form new Earth Battery energy systems which even further augment and enhance the capabilities of the Earth Battery system 10 described above. Such Earth Battery energy systems may be deployed using mature steam-turbine or compressed air energy storage (CAES) technologies, as well as with emerging CO₂ power technology. Because TES is the primary means of energy storage in this new form of the Earth Battery energy systems, we refer to our new system as the Thermal Earth Battery.

In this regard, the Thermal Earth Battery energy systems which will be discussed in the following paragraphs are designed to be highly flexibly, capable of being adapted to a wide range of thermo-electric power systems, including nuclear energy (NE), fossil fuel energy (FE) or solar thermal energy (STE) power systems, as well as combinations of such power systems. The underlying principal is to employ “time-shifting” techniques to enable full utilization of the heat generated by any given thermo-electric power system, such as STE. Thus, during those times when excess energy is being produced, for example when excess electricity is being produced, the excess heat is stored underground, and/or possibly above-ground, rather than being immediately converted to electricity and sent either to an electric power grid or to bulk energy storage, such as battery storage. It should be noted that battery storage is less efficient and more expensive than using TES to time-shift when heat is converted to electricity to correspond to when it is demanded. Time shifting when available heat is converted to electricity enables full utilization of the heat generated by any given thermo-electric power system, such as STE, without resorting to less efficient and more costly energy-storage means, such as battery storage.

In addition to time-shifting heat sources, the Thermal Earth Battery energy systems can also time-shift from when natural gas (NG) is available to when electricity that can be generated by NG combustion is required by an electric power grid. This is useful in regions, such as the Permian Basin, where NG that is co-produced with oil production often does not have a market, and because it can be costly to re-inject NG back into the hydrocarbon reservoir, NG may be flared off with no energy-resource benefit. Time-shifting the energy contained in NG to correspond to periods of energy demand enables better utilization of that energy resource and avoids wasteful flaring of that resource, with the flaring generating CO₂ with no energy-resource benefit. Because the Thermal Earth Battery energy systems include provisions to capture and geologically sequester the CO₂ generated by NG combustion, they can be deployed as a zero-carbon energy system.

For STE, which is an IRE source, as well as for baseload, thermo-electric power plants, one goal of the present disclosure is to store heat either underground or above-ground whenever energy supply exceeds demand. This approach aims to prevent STE from being wasted and to allow thermo-electric power plants (baseload in particular) to continuously generate heat at the full rated thermal capacity. The overarching goal is for heat generated by low-carbon, thermo-electric power resources to be converted to electricity only when demand exceeds energy supply. Another underlying principle is to efficiently sequence the utilization of heat sources in power generation, starting with the lowest-grade heat source, then progressing to successively higher-grade heat sources. By doing this, the highest-grade heat source, which can come from the combustion of FE and/or biomass, can be utilized with the greatest incremental value to generating power. This sequencing process also allows each heat source to be utilized with the greatest incremental value for power generation.

The process of sequencing heat sources can leverage considerable value from marginal geothermal resources, geographically broadening where the Earth Battery energy systems can be implemented. The Earth Battery system 10 and the following new embodiments of the Earth Battery can be configured to include the use of emerging CO₂ power-system technology to (1) improve efficiency, (2) reduce water consumption, and (3) add CO₂-capture, use, and storage (CCUS) benefits of enhanced oil recovery and CO₂ sequestration. The Earth Battery system 10 and the following new embodiments thereof can be operated as a self-contained, zero-carbon energy system without importing NG and CO₂ over long pipelines to reduce GHG leakage risk.

Three-Zone, Heated Brine, Thermal Energy Storage with Sequencing of Heat Sources

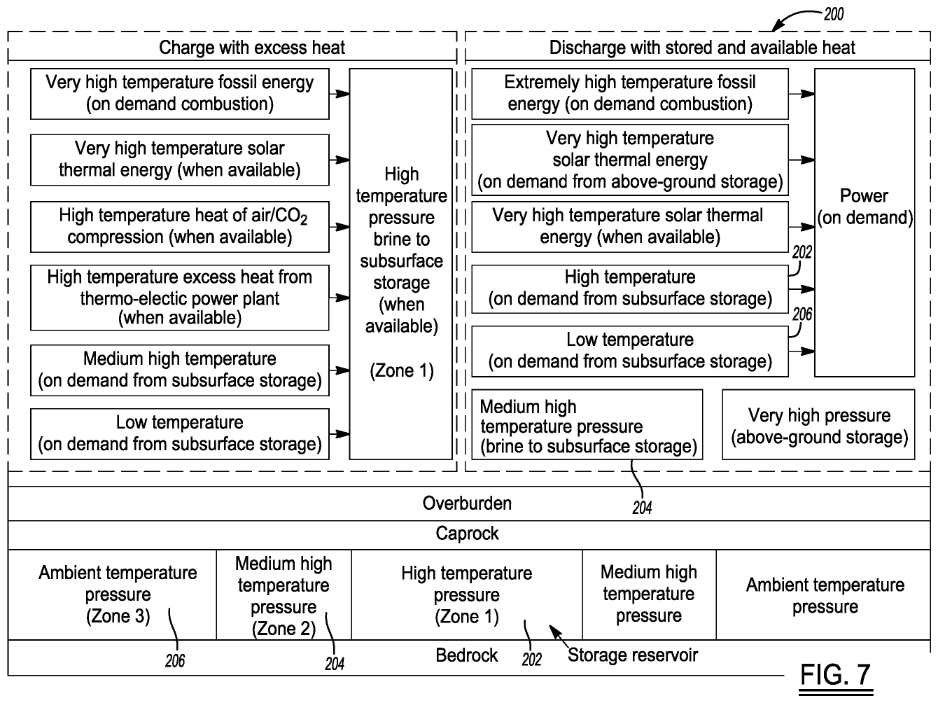

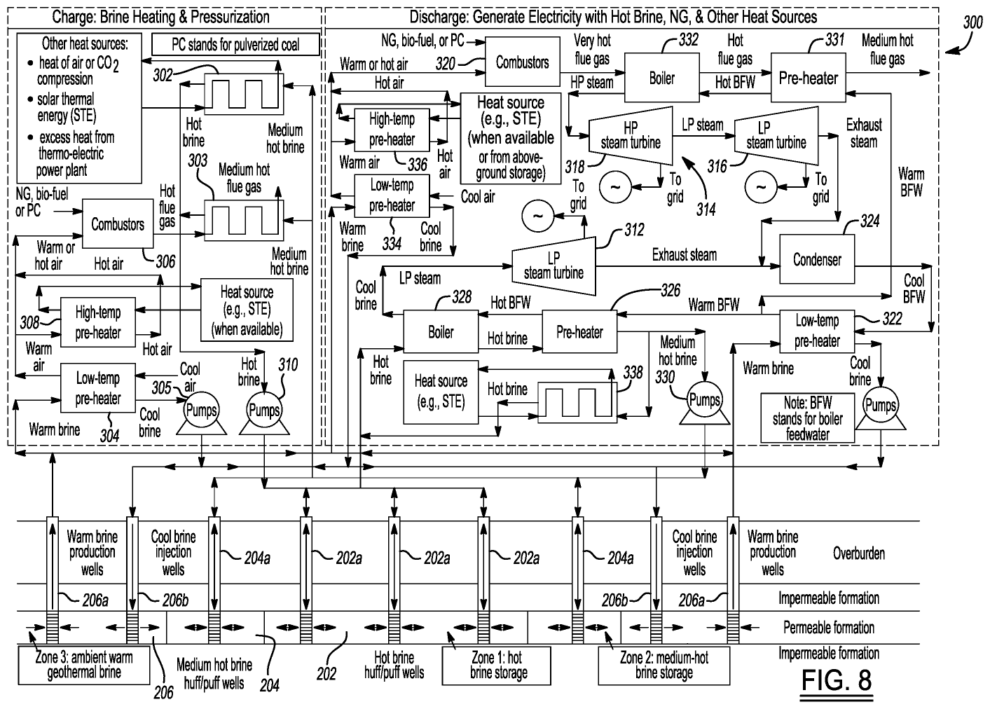

Referring to FIGS. 7, a high level new thermal energy storage (TES) system called the Thermal Earth Battery system 600 is shown which converts hot brine to power with even greater efficiently, and with even less pressure oscillations, by using a plurality of distinct brine-temperature zones within a permeable reservoir formation. The system 600 is shown in one specific implementation as system 700 in FIG. 8. In the examples shown in FIGS. 7 and 8, the distinct brine-temperature zones are generally formed as distinct, concentric zones, preferably within a horizontally common permeable geologic region, which is overlain by an impermeable geologic region (also called the caprock as shown in FIG. 7), although some of the third zone (Zone 3) need not be within that horizontally common permeable geologic region. A key function for Zone 3 is to provide enough warm brine for the first and second zones (Zones 1 and 2) to function efficiently. To assure an adequate supply of warm brine, the systems 600 and 700 may also import supplemental brine from one or more separate sources (SBS 340 in FIG. 8), which can comprise a separate geologic formation or brine reservoir, including man-made structures. In this example, the Thermal Earth Battery system 600, and the specific Thermal Earth Battery system 700 implementation shown in FIG. 8, make use of three distinct concentric brine-temperature zones, as shown in both of FIGS. 7 and 8: (1) an inner Zone 1 (region 202) of hot, high-pressure brine having a temperature within a first temperature range; (2) an intermediate Zone 2 (region 204) of medium-hot, medium-high-pressure brine having a temperature within a second temperature range less than the first temperature range; and (3) an outer Zone 3 (region 206) of warm, ambient brine having a third temperature within a third temperature range less than the second temperature range. Furthermore, it will be appreciated that any reference herein to hot brine comprises high-temperature brine and any reference herein to medium-hot brine comprises medium-high-temperature brine. The first temperature range may typically be within a range of about 240° C.-300° C.; the second temperature range may typically be within about 180° C.-220° C., and the third temperature range may typically be within about 40° C.-200° C., although it will be appreciated that these ranges may vary somewhat.

There are several reasons for arranging the three brine-temperature zones in a concentric configuration, with the primary reason being pressure management. To avoid high-temperature brine from flashing to steam, it is necessary for the brine pressure to always exceed the saturation pressure, which, as is well known, increases with brine temperature. In the three brine-temperature-zone configuration the highest brine pressure is needed in the center where brine has the highest temperature. Thus, hot brine in Zone 1 requires a higher pressure than medium-hot brine in Zone 2. Warm ambient brine in Zone 3 does not require very high pressure to prevent that brine from flashing to steam. However, for Zone 2 to have high enough pressure to prevent medium-hot brine from flashing to steam, the pressure within the portion of Zone 3 that is adjacent to Zone 2 needs to be relatively high, compared to ambient pressure conditions. Thus, as described below in greater detail, it is preferred to re-inject cool brine in wells that are in Zone 3, but relatively close to Zone 2, so that enough pressure support is provided to prevent medium-hot and hot brine from flashing to steam in Zones 2 and 1, respectively. For pressurized hot brine to reach the heat exchangers and deliver heat to the power-generation equipment, it is important that pressurized hot brine not flash to steam within the (1) permeable geologic formation, (2) huff/puff wells, and (3) piping through which hot brine flows. Avoiding hot brine from flashing to steam in the huff/puff wells and piping is also needed to limit chemical scale and plugging of the wells and piping, as well as any equipment that may be in contact with the hot brine, such as the heat exchangers. It should also be noted that it is preferred that Zones 1 and 2 lie directly below an impermeable geologic region to contain the pressurized, buoyant medium-hot and hot brine.

The concentric configuration of three brine-temperature-zone zones is also aimed at limiting thermal losses that result from convective mixing of hot brine with ambient-temperature warm brine. Thus, hot brine in Zone 1 mixes with medium hot brine in Zone 2, rather than with warm ambient-temperature brine in Zone 3, while medium-hot brine in Zone 2 mixes with warm brine in Zone 3.

Before steady-state, cyclical charge/discharge occurs, the systems 600 and 700 are charged by storing heat in two pre-steady-state charging stages (Stages 1a and 1b). The multiple stages in the Thermal Earth Battery systems 600 and 700, shown in FIGS. 7 and 8, are described below in greater detail.

### Pre-Steady-State Stage 1a Charging

It should be noted that pre-steady Stages 1a and 1b are one-time processes, which are required prior to conducting the steady-state charge/discharge stages, which are conducted in a cyclical manner, as discussed below. Warm ambient geothermal brine is supplied from at least one of produced brine from Zone 3 (region 206 in FIGS. 7 and 8), via one or more production wells 206a, and imported brine, via one or more separate brine sources (SBS) 340, pressurized to medium-high pressure brine via one or more booster pumps 311 (FIG. 8), heated to medium-hot brine (e.g., 200° C.) using one or more heat exchangers 302,303, possibly pressurized further via one or more pumps 310, and injected using one or more huff/puff wells 202a into the center of Zone 1 (region 202). The heat exchangers 302,303 (FIG. 8) may use one or more heat sources such as combustion of FE and/or biomass, and/or STE, and/or excess heat from thermo-electric power plants. Also, during charging, warm ambient brine may be produced from Zone 3 (region 206), via one or more production wells 206a, and fed into one or more low-temperature pre-heaters 304 (called Low-temp pre-heaters in FIG. 8) to pre-heat cool air to warm air, which may be used as inlet combustion air in one or more FE combustors 306 (FIG. 8). It should be appreciated that although we refer to the combustors as FE combustors in the current discussion, they can also be used for the combustion of biomass. The one or more low-temperature pre-heaters 304 also generate cool brine that may be pumped via one or more pumps 305 into one or more cool brine injection wells 206b to be injected back into Zone 3 (region 206). The one or more cool brine injection wells 206b provide pressure support for Zones 1 and 2 (regions 202 and 204). It is preferred that one or more cool brine injection wells 206b be located close enough to Zone 2 to provide the pressure support needed to prevent hot and medium-hot brine from flashing to steam in Zones 1 and 2.

Collectively, the one or more FE combustors 306 may use one or more FE sources, such as pulverized coal (PC), biomass, or NG. If STE is available either directly or indirectly from either shallow below-ground or above-ground storage, it may be fed into one or more high-temperature pre-heaters 308 (called High-temp pre-heater in FIG. 8) to heat warm air to hot air, which may be used as inlet combustion air in one or more FE combustors 306. Hot flue gas leaving the one or more FE combustors 306 may be fed into one or more heat exchangers 303 to heat warm ambient brine produced from Zone 3 (region 206), via one or more production wells 206a, and/or brine imported from one or more separate brine sources 340, to either medium-hot brine or hot brine, which is injected via one or more pumps 310 into the center of Zone 1 (region 202), via one or more huff/puff wells 202a. Medium hot flue gas leaving one or more heat exchangers 303 may enter a CO₂-capture operation (not expressly shown) that generates CO₂-free flue gas and high-purity CO₂, which may be compressed for storage or export.

### Pre-Steady-State Stage 1b Charging

Stage 1a described above is repeated with the change that during Stage 1b, warm geothermal brine is produced from Zone 3 (region 206) using one or more production wells 206a, pressurized to high-pressure brine via one or more booster pumps 311 (FIG. 8), heated to hot brine (e.g., 250° C.) using one or more heat exchangers 302,303, possibly pressurized further via one or more pumps 310, and re-injected into the center of Zone 1 (region 202) using one or more huff/puff wells 202a. The heat exchangers 302,303 may use a combination of heat sources, as in Stage 1a. Also, during charging, warm ambient brine may be produced from one or more production wells 206a of Zone 3 (region 206) and fed into one or more low-temperature pre-heaters 304 to pre-heat cool air to warm air, which may be used as inlet combustion air in the one or more FE combustors 306. Collectively, the FE combustors 306 may use one or more FE sources, such as PC, biomass, or NG. If STE is available either directly or indirectly from either shallow below-ground or above-ground storage, it may be fed into one or more high-temperature pre-heaters 308 to heat warm air to hot air, which may be used as inlet combustion air in one or more FE combustors 306. Hot flue gas leaving one or more FE combustors 306 may be fed into one or more heat exchangers 303 to heat warm ambient brine produced from Zone 3 (region 206), via one or more production wells 206a, and/or warm brine imported from one or more separate brine sources 340, to hot brine, which is pressurized via one or more pumps 310 and injected into the center region of Zone 1 (region 202), via one or more huff/puff wells 202a. Because high-pressure, hot brine is injected into the center of Zone 1, it displaces the medium-high-pressure, medium-hot brine radially outward, so that medium-high-pressure, medium-hot brine flows into Zone 2 (region 204), with Zone 1 then being fully occupied with high-pressure, hot brine (FIG. 8). After Zones 1 and 2 are charged with enough quantities of hot and medium-hot brine, respectively, the subsurface Thermal Earth Battery systems 600 and 700 are ready for steady-state charge/discharge operations.

### Steady-State Stage 2 Charging

Medium-high-pressure, medium-hot brine is produced from the huff/puff wells 204a of Zone 2 (region 204), pressurized to high-pressure brine via one or more booster pumps 311 (FIG. 8), heated to high-pressure hot brine (e.g., 250° C.), using one or more heat exchangers 302,303 and a combination of heat sources, as in Stages 1a and 1b, possibly sent through one or more pumps 310, where it is further pressurized and re-injected back into the center of Zone 1 (region 202), via one or more huff/puff wells 202a. Also, during charging, warm ambient brine may be produced from Zone 3 (region 206) via one or more production wells 206a and fed into one or more low-temperature pre-heaters 304 to pre-heat cool air to warm air, which may be used as inlet combustion air in one or more FE combustors 306. Collectively, the FE combustors 306 may use one or more FE sources, such as PC, biomass, or NG. When STE is available either directly or indirectly from shallow below-ground or above-ground storage, it may be fed into one or more high-temperature pre-heaters 308 to heat warm air to hot air, which may be used as inlet combustion air in one or more FE combustors 306. Hot flue gas leaving the FE combustors 306 may be fed into one or more heat exchangers 303 to heat medium-hot brine produced from Zone 2 (region 204), via one or more huff/puff wells 204a, to hot brine, which, if necessary, is further pressurized via one or more pumps 310 before being injected into the center of Zone 1 (region 202), via one or more huff/puff wells 202a.

### Steady-State Stage 3 Discharging

The discharge process may involve two parallel power-generating systems. The first power system is a low-pressure (LP) steam-turbine system 313 (FIG. 8), which is primarily heated with hot brine produced from Zone 1 (region 202). It may also be heated with STE, either directly when STE is available or indirectly with STE taken from shallow below-ground or above-ground storage. The second power system is a multi-stage, steam-turbine system 314, with at least LP steam turbines 316 and high-pressure (HP) steam turbines 318, and optionally medium-pressure (MP) turbines (not expressly shown). If one or more medium-pressure turbines are used, it/they may be placed in series between turbines 316 and 318.

The multi-stage LP-/HP-turbine power system 314 may be heated primarily by FE combustion. It may also be heated primarily by STE, either directly when STE is available or indirectly with STE taken from shallow below-ground or above-ground storage. It may also be heated by STE, either directly when STE is available or indirectly with STE taken from shallow below-ground or above-ground storage, before it is heated by FE combustion. Collectively, the FE combustors 320 may use one or more FE sources, such as PC, biomass, or NG. Both the LP-turbine power system 313 and multi-stage LP-/HP-turbine power system 314 may utilize warm ambient brine produced from Zone 3 (region 206) for pre-heating purposes. Warm ambient brine produced from Zone 3 may be fed into one or more low-temperature pre-heaters 322 to heat initially cool boiler feed water (BFW) that has exited condensers 324 to warm BFW. Warm BFW is fed to at least one of pre-heaters 326,331 where it is heated to hot BFW, using at least one of hot brine produced from Zone 1 (region 202), via one or more huff/puff wells 202a, and very hot flue gas from one or more FE combustors 320. Hot BFW is fed to at least one of boilers 328,332 and heated by at least one of hot brine produced by Zone 1, via one or more huff/puff wells 202a, and very hot flue gas from one or more FE combustors 320. For the LP-turbine power system 313, hot brine produced from Zone 1 (region 202) is used to heat hot BFW so that it becomes LP steam, which is fed to the LP steam turbine 312 where it is used to generate electricity, which is then sent to the grid 12. LP steam leaves the LP steam turbine 312 as an exhaust steam, which is sent to one or more condensers 324. At the condensers 324, it is cooled to become cool BFW. After hot brine leaves one or more pre-heaters 326, it has become medium-hot brine, which is pressurized via one or more pumps 330 to become medium-high-pressure, medium-hot brine and injected into Zone 2, using one or more huff/puff wells 204a. For the LP-/HP-turbine power system, hot BFW is created using one or more preheaters 331 which heats warm BFW received from one or more low-temperature pre-heaters 322 to become hot BFW. It is also possible to send the warm BFW leaving one or more low-temperature pre-heaters 322 through one or more high-temperature pre-heaters (not expressly shown), which is heated using a heat source such as STE, either directly when that heat is available or indirectly with that heat is taken from shallow below-ground or above-ground storage, to create hot BFW, which is then sent to one or more pre-heaters 331. Medium hot flue gas leaving pre-heater 331 may enter a CO₂-capture operation (not expressly shown) that generates CO₂-free flue gas and high-purity CO₂, which may be compressed for storage or export. The hot BFW enters one or more boilers 332 where it is turned into high-pressure (HP) steam, which is fed to one or more HP steam turbines 318. The HP steam turbine 318 uses the HP steam to generate electricity, which is then sent to the grid 12. HP steam exits the HP steam turbine 318 as LP steam, which is fed to one or more LP steam turbines 316 where it also generates electricity, which is then sent to the grid 12. Exhaust steam leaving one or more LP steam turbines 316 is sent to one or more condensers 324 where it cools and becomes cool BFW. The multi-stage LP-/HP-turbine power system 314 may use warm ambient brine to pre-heat inlet combustion air for one or more FE combustors 320. Warm ambient brine is produced using one or more production wells 206a from Zone 3 (region 206) and sent to one or more low-temperature pre-heaters 334 to heat cool air to warm air, which may be sent to one or more FE combustors 320. When STE is directly available, or when STE is taken from shallow below-ground or above-ground storage, it may be sent to one or more high-temperature pre-heaters 336 where it is used to heat warm air to hot air, which may be fed to one or more FE combustors 320. The LP-turbine power system 313 may also use STE. When STE is directly available or when STE is taken from shallow below-ground or above-ground storage, it may be sent to one or more heat exchangers 338 to heat medium-hot brine, which has exited one or more pre-heaters 326. This results in the medium-hot brine becoming hot brine, which is sent to one or more boilers 328 to heat hot BFW to LP steam, which is then sent to one or more LP steam turbines 312 to generate electricity which may be sent to the grid 12. Note that this may require one or more booster pumps 329 to pressurize the medium-hot brine prior to entering the one or more heat exchangers 338.

The new Thermal Earth Battery systems 600 and 700 with three brine-temperature storage zones can be operated as a zero-net-injection, closed-loop process with Zones 1 (region 202) and 2 (region 204) interacting like a piston. Because during steady-state Stage 2 charging, the rate at which high-pressure, hot brine enters Zone 1 can be specified to be the same as the rate at which medium-high-pressure, medium-hot brine leaves Zone 2, the systems 600 and 700 can be operated with no net change in the quantity of stored brine contained within Zones 1 and 2 at any time during the steady-state Stage 2 charging period. Furthermore, because during steady-state Stage 3 discharging, the rate at which high-pressure, hot brine leaves Zone 1 can be specified to be the same as the rate at which medium-high-pressure, medium-hot brine enters Zone 2, the systems 600 and 700 can be operated with no net change in the quantity of stored brine contained within Zones 1 and 2 at any time during the steady-state Stage 3 discharging period. Keeping a constant quantity of stored brine contained within Zones 1 and 2 limits the magnitude of pressure oscillations within these two storage zones during the cyclical charge/discharge process. An important outcome of this approach is that by limiting pressure oscillations, the risk of induced seismicity can be significantly reduced.

The various embodiments described herein all enable a plurality of different, possibly separated, possibly at different elevations, storage zones within the Earth be used to temporarily store heated and/or cooled brine and/or compressed air, N2, CO₂, or mixtures of N2 and CO₂. Another significant advantage is the system 10 makes highly efficient use of the wells by implementing most of the wells as huff/puff wells, which are used both for fluid injection and for fluid production. The heat of air, N₂, and CO₂ compression can be used to heat brine, which can also be pressurized using excess electricity, and then stored in a reservoir within the Earth. When energy is needed, either air, N₂, CO₂, or mixtures of N₂ and CO₂, plus hot brine, may be produced, with any of these being pre-heated with hot brine before entering an expander, a NG turbine or a PC-, biomass-, or NG-fired N₂/CO2 Brayton-cycle turbine, or any other power generating implement. For the Thermal Earth Battery systems 600 and 700, a significant advantage is that it only requires the storage of pressurized, hot brine or hot water for storing energy and dispatching it as electricity when it is demanded by an electric power grid. In the Thermal Earth Battery systems 600 and 700, produced hot brine can be used to heat boiler feedwater in a steam-turbine power system or to heat N₂ or CO₂, or mixtures of N₂ and CO₂, in an N₂- or CO₂-turbine power system. The various embodiments of the present disclosure provide the benefit of short-duration energy storage via the compressed air energy storage NG-turbine system, along with combinations of short-duration, medium-duration and long-duration energy storage via the N₂/CO₂ Brayton-cycle power system. Optionally, a steam turbine power system can also be used to provide combinations of short-duration, medium-duration and long-duration (seasonal) energy storage. Still another advantage of the system 10 is that it enables heat from other sources, such as a baseload thermo-electric power plant or solar thermal energy, to be stored along with heated fluids (e.g., heated brine), which were heated by the heat of air and/or CO₂ compression. Still another advantage of the systems 600 and 700 is that it can store the energy contained in excess natural gas in the form of pressurized hot brine, which can be stored along with heat from other sources. The various embodiments of this disclosure therefore can leverage a plurality of different energy sources simultaneously, and in various combinations, to heat a fluid which can be stored in the Earth for either short or long durations, for the purpose of more efficiently producing electrical power on an electric power grid when needed.

Earth Battery Augmented with Thermal Energy Storage Granular-Medium-Filled Reservoirs

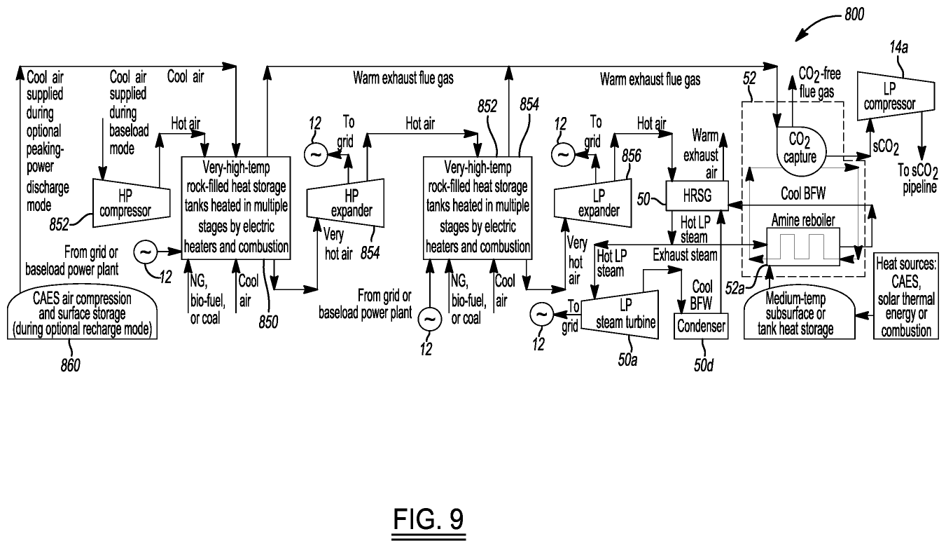

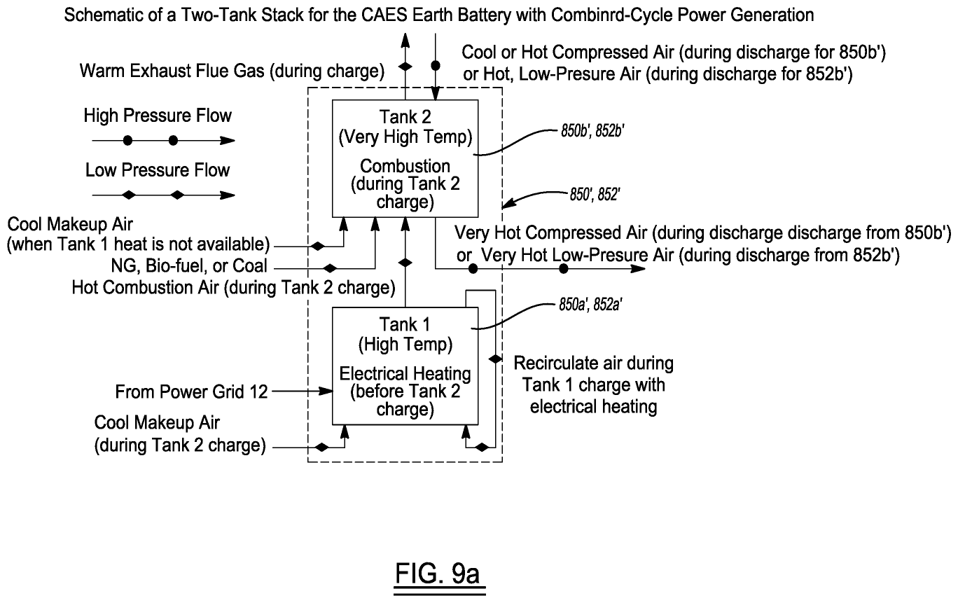

Referring to FIGS. 9-11, further embodiments of a CAES Earth Battery system are shown. The embodiments of FIGS. 9-11 provide systems which meet present day challenges of providing low-cost, high-capacity energy storage by synergistically integrating conventional and renewable-energy resources, allowing each to contribute more efficiently to the grid than if operated independently.

In particular, the Earth Battery systems of FIGS. 9-11 provide large-scale, long-duration energy storage via a combination of bulk-energy-storage (BES) of excess electricity from the grid and power plants and thermal-energy-storage (TES) of various thermal resources, such as geothermal heat, solar thermal energy (STE), heat generated by nuclear energy (NE), the heat of air and CO₂ compression, and the heat of fossil energy (FE) combustion, as well as the heat of biomass combustion. These embodiments take advantage of the Earth's vast storage capacity, insulative properties, and ability to store fluids at high pressure (hundreds of bars) and intermediate temperature (up to ˜270° C.), by storing heated pressurized brine in permeable geologic formations, overlain by impermeable caprocks. Such formations are found in hydrocarbon and saline reservoirs across much of the U.S. Above-ground, TES can use various approaches, such as medium-high temperature (up to −565° C.) heat stored in tanks filled with hot (up to 565° C.) and cold (>260° C.) molten salt. Still another approach for high temperature, or very high temperature, TES is to use granular media, including sand or rocks, or even a mixture of sand and rocks, in reservoir storage devices (e.g., metal storage tanks). Sand and rocks are stable at very high temperature. For example, quartz sand melts to glass at temperature>1700° C. High temperature heat can be generated by electrical resistance heaters, while very high temperature heat can be generated by the heat of FE and biomass combustion. Earth-based granular materials offer the advantages of low cost and an abundant and readily available supply. The addition of above ground, high/very-high temperature TES means that the embodiments of the Earth Battery shown in FIGS. 9-11 can be deployed virtually anywhere, even in regions that do not have suitable geology for subsurface TES.

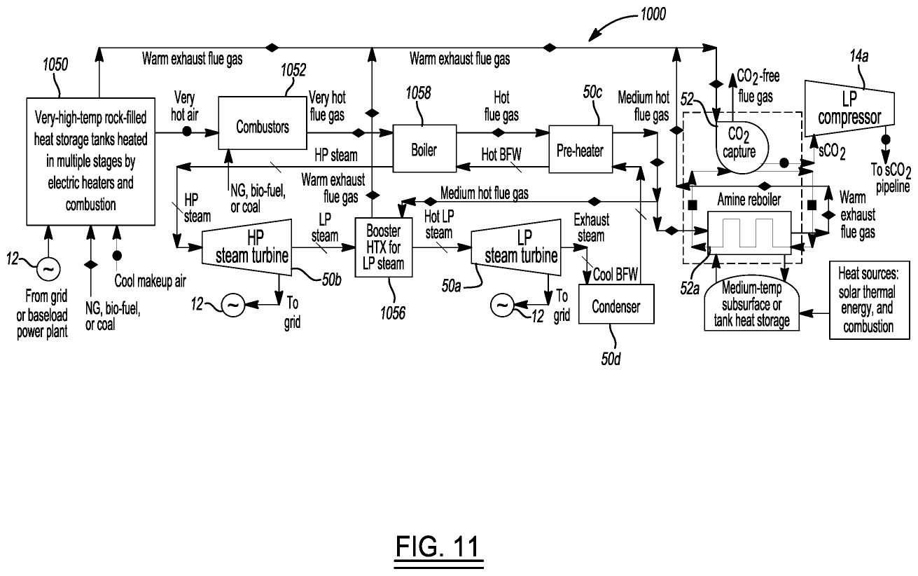

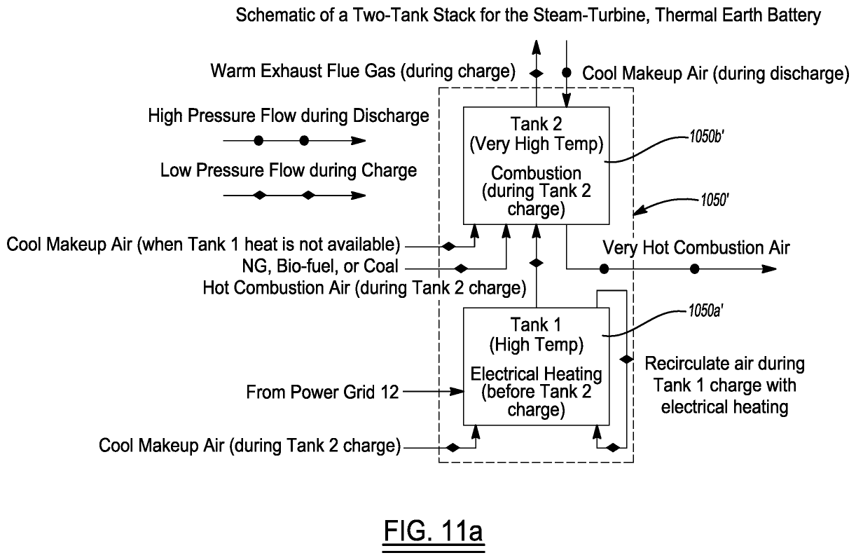

As will be discussed further in connection with the embodiment of FIG. 11, TES/HTX tanks can be used to retrofit a steam-turbine power plant for dispatchable electricity generation, to enable combustion and CO₂ generation to occur at a constant or specified rate, and to reduce thermal cycling. These TES/HTX tanks can also be applied to a gas peaker plant or a combined-cycle power plant (FIG. 9) to enable FE combustion to occur at a constant or specified rate, and to reduce thermal cycling. Because FE combustion can occur with minimal excess air, the concentration of CO₂ in the flue gas would be greater than in a conventional gas peaker or combined-cycle plant, which would reduce the cost of CO₂-capture. Continuous FE combustion at a constant rate allows for continuous CO₂ generation at a constant rate. This allows the CO₂-capture facility to be sized for the average electricity dispatch rate, rather than the peak dispatch rate, which would maximize the return on capital investment. For a CAES Earth Battery, the heat of air compression can be stored in the form of pressurized hot brine or hot water that may be used to supply the heat required for CO₂-capture. Thus, much of the power dispatched from a CAES Earth Battery power plant can be derived from excess electricity, which is used to compress and store air and to generate and store pressurized hot brine or hot water.

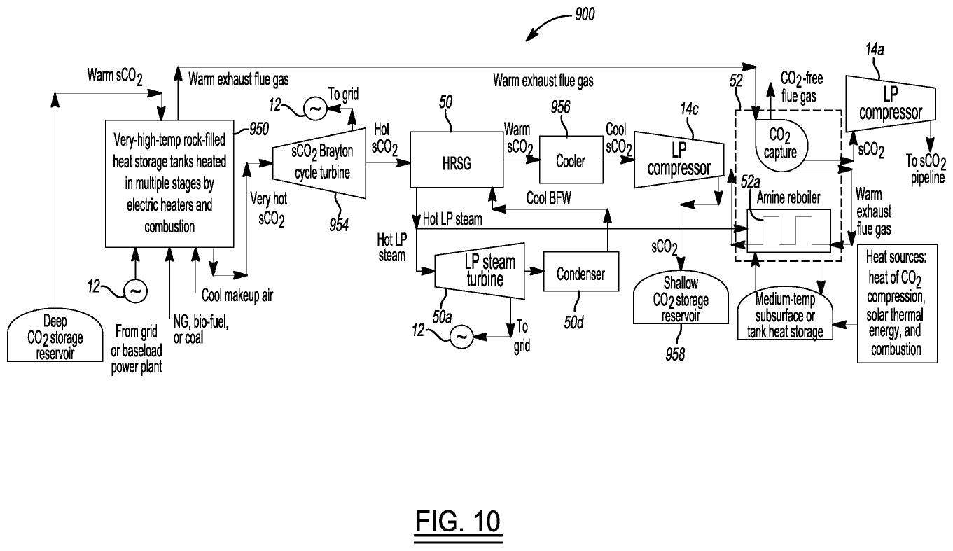

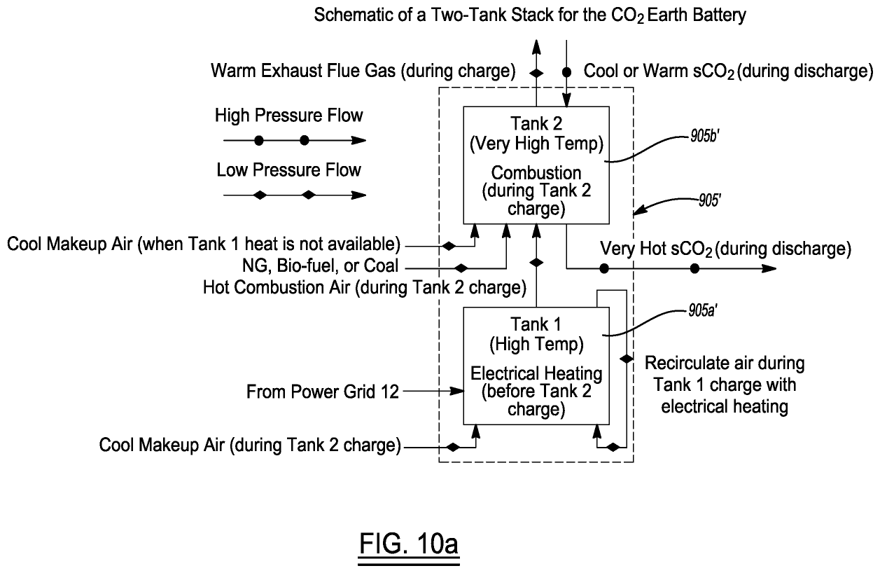

TES/HTX tanks can also be used in a CO₂ Earth Battery power plant (FIG. 10) for dispatchable electricity generation, to enable combustion and CO₂ generation to occur at a constant or specified rate, and to reduce thermal cycling. FE combustion may be implemented by using a conventional furnace that uses combustion air, or it instead may use the pressurized oxy-fuel combustion process that produces a high-purity stream of CO₂ in the flue gas.

Earth Battery technology can be used to upgrade a conventional steam-turbine power plant to become a cost-effective, zero-carbon power system that efficiently incorporates all forms of conventional and renewable energy whenever those sources are available, and allow electricity to be dispatched when it is demanded. Earth Battery technology can also be used to upgrade conventional gas-turbine and combined-cycle plants to become a cost-effective, zero-carbon power system that efficiently incorporates all forms of conventional and renewable energy sources whenever those sources are available, and allow electricity to be dispatched when it is demanded.

CAES Earth Battery with Combined-Cycle Power Generation

Referring now specifically to FIG. 9, a system 800 is shown for forming an Earth Battery which builds on the CAES Earth Battery 10 of FIG. 1 and uses additional resources to generate electricity for the power grid 12 using additional features and methods including high-/very-high-temperature, heat-storage reservoirs. Components shown in FIG. 9 which are common to those discussed in connection with FIG. 1 are designated using the same reference numbers used in discussing system 10 of FIG. 1.

The system 800 includes thermal storage reservoir systems 850 and 852, which can be used to further pre-heat the hot compressed air being supplied to a high-pressure (HP) expander 854 and a low-pressure (LP) expander 856, respectively. Each of the reservoir systems 850 and 852 will contain multiple (two or more) stacks of one, two or more distinct reservoirs that are arranged serially such that an output of one feeds another, and so forth. Multiple stacks of tanks are required because to enable continuous combustion there will always be at least one stack in charge mode until that stack is either partially or fully heated, while other stacks may be in discharge mode until the very-high-temperature heat contained in those stacks has been either partially or fully discharged. FIG. 9a shows such an embodiment of an individual stack of a multi-stack, multi-tank tank reservoir system 850′ which incorporates independent, serially-connected first and second metal tanks forming separate reservoirs 850a′ and 850b′. If at least two distinct reservoirs are formed by the reservoir system 850, then one (e.g., reservoir 850a′) may form a high heat reservoir that outputs heated air to the input of a very high heat reservoir (i.e., reservoir 850b′).

Referring to FIG. 9a, during the charge mode, reservoirs 850a′ and 850b′ may be heated successively in two stages. Optionally, reservoir 850b′ may be heated in just one stage. During the first stage, reservoir 850a′ may be heated with electrical heaters whenever excess electricity is available from the power grid 12. Air may be recirculated in reservoir 850a′ to evenly distribute the heat. The second stage may begin after reservoir 850a′ has been either partially or fully heated. During the second stage, cool makeup air is sent through reservoir 850a′ to become hot combustion air, which is sent to reservoir 850b′ where it is combusted with NG, biomass, or coal to form very-high-temperature flue gas that heats up the granular media in reservoir 850b′ before the flue gas leaves reservoir 850b′ as warm exhaust flue gas. If reservoir 850b′ is heated in one stage, cool makeup air enters reservoir 850b′ where it is combusted with NG, biomass, or coal to form very-high-temperature flue gas that heats up the granular media in reservoir 850b′ before the flue gas leaves reservoir 850b′ as warm exhaust flue gas.

Referring to FIG. 9a, during the discharge mode, cool compressed air from the CAES subsystem 860 or hot compressed air from the high-pressure HP compressor 858 enters reservoir 850b′ where it is heated by the very-high-temperature heat stored in the granular media in reservoir 850b′. After it is heated by the granular media, very hot compressed air leaves reservoir 850b′ and is sent to the high-pressure HP expander 854 where it is used to generate electricity for the grid 12.

Referring to FIG. 9a, reservoir system 852 may also be formed as a multi-stack, multi-tank reservoir system like that described above for reservoir system 850. The charge mode in reservoir system 852 is the same as that described above for reservoir system 850. The discharge mode in reservoir system 852 is similar to that described above for the reservoir system 850, but with the two following differences. Rather than being supplied by the cool compressed air from the CAES subsystem 860 or by the hot compressed air from the HP compressor 858, reservoir 852b′ is supplied by the hot, low-pressure air that leaves the HP expander 854. After the hot, low-pressure air is further heated by the very-high-temperature granular media in reservoir 852b′, very hot, low-pressure air leaves reservoir 852b′ and is sent to the low-pressure LP expander 856 where it is used to generate electricity for the grid 12.

Each of the reservoir systems 850 and 852 (or reservoir tanks 850a′ and 850b′) may contain a thermal energy storage (“TES”) medium that is able to store a large quantity of heat. For example, sand or rock may form the thermal storage medium, or even a combination of sand and rock may be used. Relatively small grain size is preferred for rapid thermal equilibration with the air or sCO₂ that is passing through. However, if the grain size is too small it will cause too much flow resistance, with the pressure loss decreasing system efficiency. The reservoir systems 850 and 852 may each be formed by one or more individual metal tanks, as noted above, which are filled with the selected thermal storage medium. For convenience, the following discussion of the operation of the system 800 will be made with reference to use of the reservoir systems 850 and 852.

The system 800 may operate in two distinct modes: a charge mode and a discharge mode. The system 800 shows flow arrows to help explain the flows for both the charge mode and the discharge mode. It will also be appreciated that the system 800 is for a compressed air energy storage (CAES) version of the Earth Battery system 10 of FIG. 1, which includes combined cycle power generation.

For the charge mode, air and flue gas flow under low pressure. For the discharge mode, compressed air flows under high pressure (e.g., typically, 100 bar or greater). Where local geologic conditions do not allow for a CAES subsystem 860, or when it is decided to operate the system in baseload mode (i.e., without the CAES subsystem 860), a high-pressure (HP) compressor 858 is used to supply compressed air in real time in place of the CAES subsystem 860. Some of the heat from the heat recovery steam generator (HRSG) 50 may be sent to amine reboilers 52a, which support the CO₂-capture system 52. Other medium-temperature heat sources for the CO₂-capture system 52 may include (1) heat of air compression from CAES, (2) solar thermal energy, (3) fossil fuel combustion, and (4) biomass combustion. The CAES subsystem 860 allows peaking power-discharge mode, which can discharge electricity at a higher rate than during the baseload mode, which uses compressed air supplied by the HP compressor 858, rather than compressed air supplied by the CAES subsystem 860. By “baseload” mode it is meant that the system is operating as a standard baseload power plant would, with no assistance from compressed air supplied from a CAES system, such as from the CAES subsystem 860 shown in FIG. 9.

The system of FIG. 9 also discloses that the HRSG 50 may incorporate a steam turbine system 50a turbine and condenser 50b. The CO₂-capture system 52 may incorporate the CO₂-capture operation 52 and amine reboilers 52b. Furthermore, the option exists for using some or all steam from the HRSG 50 to supply heat to the amine reboilers 52a used in the CO₂-capture process.

Cool air may enter the reservoir systems 850 and 852. Optionally, the reservoir system 850 may even be heated by electrical heaters powered by excess electricity from the grid 12 (as noted in FIG. 9a) or from a baseload power plant, which creates high temperatures in the sand and/or rock contained in the reservoir system 850.

Referring to FIGS. 1 and 9, very hot compressed air that leaves the reservoir system 850 may be used as combustion air for combustion in the NG-fired HP turbine 44 and the NG-fired LP turbine 42, respectively. The fossil fuel used to help heat the thermal storage medium in the reservoir system 850 may be biomass, NG, coal or virtually any other available fossil energy source. The sand, rock and/or sand/rock mixture in the reservoir system 850 serves as the TES storage medium.

Cool, makeup air may be sent to the reservoir systems 850 and 854 for combustion, which heats up the sand and/or rock in the reservoir system. Warm exhaust flue gas that leaves the reservoir systems 850 and 852 may be sent to the CO₂-capture system 52. The amine reboilers 52a, which supports the CO₂-capture system 52, may be heated by medium-temperature TES from either hot brine produced from a hot-brine storage reservoir or by hot brine or water from a hot brine/water two-tank system.

When hot brine from the subsurface hot-brine storage reservoir is used, it is possible to use seasonally-stored, medium-temperature heat to supply the heat needed by the amine reboilers 52a throughout the year. This is particularly attractive for the case where solar thermal energy (STE) is the source of stored medium-temperature heat. The ability of the Earth Battery to store medium-temperature heat seasonally makes it possible for STE collected throughout the year to be available to supply the heat needed by the amine reboilers 52a on a daily and hourly basis, regardless of whether the sun is shining. Thus, our technology enables STE, which is a VRE, to be utilized as a reliable energy source throughout the year, regardless of when it was collected and stored. Utilizing STE for the purpose of capturing CO₂ is very attractive, because it allows increased penetration of VRE without the typical burden that VRE imposes on electric grids.

The amine reboilers 52a used in the CO₂-capture process, may also be pre-heated with warm geothermal brine prior to being heated by the hot brine and/or water. Nearly CO₂-free exhaust leaves the CO₂-capture system 52 and high-purity, cool sCO₂ is sent to the low-pressure (LP) compressor 14a where it is compressed. Compressed sCO₂ leaving the LP compressor 14a may be sent to a sCO₂ pipeline and/or a sCO₂ storage reservoir.

Cold, compressed air is produced from the CAES reservoir 860 and enters the reservoir system 850 where it becomes very hot compressed air by the time it is discharged. The very hot air leaves the reservoir system 850 and enters the HP expander 854, which is a fossil-fuel-free turbine, to generate electricity for the grid 12. The air leaves the HP expander 854 at reduced pressure and reduced temperature to form low-pressure (LP) hot air. The LP hot air enters the reservoir system 852 where it becomes very hot air. The very hot air enters the LP expander 856, which is a fossil-fuel-free turbine, to generate electricity for the grid 12. The air leaves the LP expander 856 at nearly atmospheric pressure and reduced temperature to form hot air. The hot air may enter the heat recovery steam generator (HRSG) 50, which is used to generate hot LP steam which is fed into the LP steam turbine 50a to generate electricity for the grid 12. The air discharged from the HRSG 50 is cooled to warm exhaust air.

### CO₂ Earth Battery

Referring now to FIG. 10, a system 900 is shown which augments the capabilities of the CO₂ Earth Battery system 100 of FIG. 2. Again, components in the system 900 in common with those of the system 100 will be denoted with the same reference numbers used to describe the system 100, and components in common with the system 800 will be denoted with the same reference number used to describe the system 800. The CO₂ Earth Battery system 100 (FIG. 2) combines energy resources to generate electricity for the grid 12, and further is adapted to use the additional features and methods described below to form the new system 900 of FIG. 10.

With reference to FIGS. 10 and 10a, as in the CAES Earth Battery system with combined-cycle power generation 800, a reservoir system 950, which may be the same in its construction, thermal storage medium, and operation as the reservoir system 850, is incorporated and operates in both of the above-described charge and discharge modes of operation. As is the case for the CAES Earth Battery, multiple (two or more) stacks of tanks are required because to enable continuous combustion there will always be at least one stack in charge mode until that stack is either partially or fully heated, while other stacks may be in discharge mode until the very-high-temperature heat contained in one or more of those stacks has been either partially or fully discharged. FIG. 10a shows the two-stage heating process in an individual stack of serially-connected tanks for the CO₂ Earth Battery system.

Referring to FIG. 10a, during the charge mode, reservoirs 950a′ and 950b′ may be heated successively in two stages. Optionally, reservoir 950b′ may be heated in just one stage. During the first stage, reservoir 950a′ may be heated with electrical heaters whenever excess electricity is available from the power grid 12. Air may be recirculated in reservoir 950a′ to evenly distribute the heat. The second stage may begin after reservoir 950a′ has been either partially or fully heated. During the second stage, cool makeup air is sent through reservoir 950a′ to become hot combustion air, which is sent to reservoir 950b′ where it is combusted with NG, biomass, or coal to form very-high-temperature flue gas that heats up the granular media in reservoir 950b′ to very high temperature before the flue gas leaves reservoir 950b′ as warm exhaust flue gas. If reservoir 950b′ is heated in one stage, cool makeup air enters reservoir 950b′ where it is combusted with NG, biomass, or coal to form very-high-temperature flue gas that heats up the granular media in reservoir 950b′ before the flue gas leaves reservoir 950b′ as warm exhaust flue gas.

Referring to FIG. 10a, during the discharge mode, sCO2 enters reservoir 950b′ where it is heated by the very-high-temperature heat stored in the granular media in reservoir 950b′. After it is heated by the granular media, very hot sCO₂ leaves reservoir 950b′ and is sent the sCO₂ Brayton-cycle turbine 954 where it is used to generate power for the grid 12.

FIGS. 10 and 10a show the process flow for both the charge and discharge mode with the CO₂ Brayton-cycle version of the Earth Battery (i.e., the underlying system 100 of FIG. 2). For the charge mode, air and flue gas flow under low pressure. For the discharge mode, sCO₂ flows under high pressure. Some of the heat from the HRSG 50 may be sent to the amine reboilers 52a used in the CO₂-capture process. Other medium-temperature heat sources for CO2-capture may include solar thermal energy, heat of CO₂ compression, and fossil fuel combustion.

For the charge mode, FE combustion occurs in the tank of the reservoir system 950, with very hot flue gas flowing through the reservoir system from bottom to top under low pressure as shown in the drawings of FIG. 10 and FIG. 10a. For the discharge mode, the tank of the reservoir system 950 may be filled with sCO₂, which flows from top to bottom under very high pressure (e.g., typically, 100 bar or more).

The flue gas loop for the charge mode is also indicated in FIGS. 10 and 10a. Cool air may enter the reservoir system 950 and may be optionally heated in multiple stages using electrical heaters powered by excess electricity from the grid 12 or from a baseload power plant, followed by combustion heating using NG, biomass, or coal as shown in FIG. 10a. Or, optionally, it may be heated in one stage by combustion using NG, biomass, or coal. The heating creates very high temperatures in the sand and/or rock contained in the reservoir system 950.

Warm exhaust flue gas that leaves the reservoir 950 may be sent to the CO₂-capture system 52. Optionally, the amine reboilers 52a used in the CO₂-capture process, may be heated by medium-temperature TES from either hot brine produced from a subsurface, hot-brine, storage reservoir or by hot brine or water from a hot brine/water two-tank system. The heat contained in the hot brine or hot water may also be used directly in the amine reboilers 52a used in the CO₂-capture process. Optionally, the amine reboilers 52a used in the CO₂-capture process may also be pre-heated with warm geothermal brine prior to being heated by the hot brine and/or water. Nearly CO₂-free exhaust leaves the CO₂-capture system 52 and cool, high-purity sCO₂ is sent to the LP compressor 14a where it is compressed. Compressed sCO₂ leaving the LP compressor 14a may be sent to a pipeline and/or a CO₂ storage reservoir.

The sCO₂ power cycle for the discharge mode is also shown in FIG. 10. Warm sCO₂ is produced from a deep, relatively-warm, CO₂ storage reservoir 952 and enters the reservoir system 950, and then flows through the reservoir system 950 where it becomes very hot sCO₂. Very hot sCO₂ leaves the reservoir system 950 and enters a sCO₂ Brayton-cycle turbine 954, which is a fossil-fuel-free turbine, to generate electricity for the grid 12. The sCO₂ leaves the sCO₂ turbine 954 at reduced pressure and temperature to form hot sCO₂.

The hot sCO₂ enters the heat recovery steam generator (HRSG) 50, where the hot sCO₂ is cooled to form warm sCO₂. Steam from the HRSG 50 is sent to the LP steam turbine 50a to generate electricity for the grid 12. The warm sCO₂ that leaves the HRSG 50 is input to a cooler 956, which turns it into cool sCO₂. The cool sCO₂ leaving the cooler 956 may then be sent to either a pump (not shown) where it is pressurized, or a LP compressor 14c where it is compressed, and sent to a CO₂ storage reservoir 958, which can be a shallow or deep reservoir. The purpose of using a shallow reservoir is to minimize the pumping or compression costs needed to store the sCO₂.

### Thermal Earth Battery

Referring to FIG. 11, an Earth Battery system 1000 is shown which augments the Earth Battery system 700 of FIG. 8 through the use of a thermal energy storage reservoir system 1050. Components in common with the Earth Battery system 700 are shown in FIG. 11 using the same reference numbers, and components in common with those used to describe the system 700 are shown with the same numbers used in FIG. 8.

The reservoir system 1050, shown in FIG. 11a, may be similar to the reservoir system 850 described hereinbefore, shown in FIG. 9a and the reservoir system 950, shown in FIG. 10a. One noteworthy difference is that during discharge, reservoir system 1050 operates under low-pressure conditions (e.g., <10 bar), rather than under high-pressure conditions (100 bars or greater) for reservoir systems 850 and 950. The Earth Battery system 1000 combines energy resources to generate electricity for the grid using the reservoir system 1050 and may operate in the charge and discharge modes in a similar manner as described herein for the Earth Battery systems 800 and 900.

As described above for the reservoir system 850 and in connection with FIG. 9a, the reservoir system 1050 shown in FIG. 11a may also be formed from two or more stacks of serially-connected metal tanks. FIG. 11a shows one stack of serially-connected tanks for the Thermal Earth Battery. Multiple stacks of tanks are required because to enable continuous combustion there will always be at least one stack in charge mode until that stack is either partially or fully heated, while other stacks may be in discharge mode until the very-high-temperature heat contained in one or more of those stacks has been either partially or fully discharged. Continuous combustion at a constant rate generates a continuous and constant-rate stream of CO₂, which enables the full and continuous utilization of the amine reboilers 52a and the CO₂-capture system 52.

Referring to FIG. 11a, during the charge mode, reservoirs 1050a′ and 1050b′ may be heated successively in two stages. Optionally, reservoir 1050b′ may be heated in just one stage. During the first stage, reservoir 1050a′ may be heated with electrical heaters whenever excess electricity is available from the power grid 12. Air may be recirculated in reservoir 1050a′ to evenly distribute the heat. The second stage may begin after reservoir 1050a′ has been either partially or fully heated. During the second stage, cool makeup air is sent through reservoir 1050a′ to become hot combustion air, which is sent to reservoir 1050b′ where it is combusted with NG, biomass, or coal to form very-high-temperature flue gas that heats up the granular media in reservoir 1050b′ before the flue gas leaves reservoir 1050b′ as warm exhaust flue gas. If reservoir 1050b′ is heated in one stage, cool makeup air enters reservoir 1050b′ where it is combusted with NG, biomass, or coal to form very-high-temperature flue gas that heats up the granular media in reservoir 1050b′ before the flue gas leaves reservoir 1050b′ as warm exhaust flue gas.

Referring to FIG. 11, warm exhaust flue gas that leaves the reservoir system 1050 is sent to CO₂-capture system 52, which forms cool, high-purity sCO₂ and nearly CO₂-free exhaust that leaves the CO₂-capture system 52. Cool sCO₂ that leaves the CO₂-capture system 52 is sent to the LP compressor 14a. Cool sCO₂ that leaves the LP compressor 14a may be sent to a CO₂ storage reservoir and/or a sCO₂ pipeline.

Referring to FIG. 11a, during the discharge mode, cool makeup air enters reservoir 1050b′ where it is heated by the very-high-temperature heat stored in the granular media in reservoir 1050b′. After it is heated by the very hot granular media, very hot air leaves reservoir 1050b′ and is sent to the combustors 1052, shown in FIG. 11, where it is used as very-high-temperature combustion air for the combustion of fossil fuel, which can be NG, biomass, or coal. The combustors 1052 generate very high temperature flue gas, which is sent through the very hot flue gas loop, which heats the boiler feedwater (BFW)/steam loop as described below.

The very hot flue gas loop is shown as arrows with diamond-shaped indicators in FIG. 11. The BFW/steam loop is shown as arrows with slanted lines in FIG. 11. Very hot flue gas that leaves the combustors 1052 is sent to the boilers 1058 where it creates high-pressure (HP) steam and forms hot flue gas. The HP steam is sent to HP steam turbines 50b where it generates electricity for the grid 12 and forms low-pressure (LP) steam. Hot flue gas that leaves the boilers 1052 is sent to the pre-heaters 50c where it heats cool BFW to become hot BFW and forms medium hot flue gas. The hot BFW is sent to the boilers 1052 and some or all of the medium hot flue gas is sent to the booster HTX 1056, which may be used to boost the steam temperature between steam-turbine stages, such as between the high-pressure (HP) steam turbine 50b and the low-pressure (LP) steam turbine 50a. Optionally, some or all of the medium hot flue gas that leaves the pre-heater 50c may be sent to supply heat required by the amine reboilers 52a used in the CO₂-capture process. Optionally, the amine reboilers 52a that support the CO₂-capture system 52 may be heated by medium-temperature TES from either hot brine produced from a subsurface, hot-brine storage reservoir or by hot brine or hot water from a hot brine/water two-tank system. Also, optionally, the amine reboilers 52a used in the CO₂-capture process, may be pre-heated with warm geothermal brine prior to being heated by the hot brine and/or hot water.

Referring to FIG. 11, LP steam that leaves the HP turbine 50b may be sent directly to the LP turbine 50a where it is used to generate electricity for the grid 12 and to form exhaust steam that is sent to the condensers 50d where it becomes cool BFW. Optionally, LP steam that leaves the HP turbine 50b may be sent to the booster HTX 1056 where it becomes hot LP steam that is sent to the LP turbine 50a where it is used to generate electricity for the grid 12 and to form exhaust steam that is sent to the condensers 50d where it becomes cool BFW. Cool BFW that leaves the condensers 50d is sent to the pre-heaters where it is heated by hot flue gas to become hot BFW.

While not expressly shown in FIG. 11, when electricity is not being generated, high-temperature or very-high-temperature air may be recirculated between reservoir system 1050 and the combustors to maintain high enough temperatures in the combustors to mitigate thermal cycling. This enables the power system to quickly ramp up to create steam and to generate electricity when it is demanded.

While not expressly shown in FIG. 11, when electricity is not being generated, thermal cycling is mitigated by recirculating medium hot BFW between the medium-temperature subsurface reservoir or two-tank TES system and the pre-heaters and boilers.

In addition to steam turbines, the system 1000 may incorporate the option of using organic Rankine cycle (ORC) turbines and replacing BFW with an organic fluid, such as isopentane, or refrigerants, such as Freon. This option allows the Thermal Earth Battery system 1000 to operate efficiently at lower temperatures, when local conditions may dictate that.

### Oxy-Combustion, Zero-Carbon and Negative Carbon Power and Heat Generation

Producing electric power from carbon neutral sources has been gaining significant interest in recent years. To attain carbon neutrality, in addition to zero-carbon technologies, negative-carbon technologies are also needed, which can include those that capture CO₂ directly from air and those that generate biofuels from biomass, such as in hydrogen fuel-cell technology, which can be used to power transportation. The systems and methods in the present disclosure can be used to provide new zero-carbon and negative-carbon pathways needed to achieve carbon neutrality. One such new zero-carbon and negative-carbon pathway that can be implemented by the present disclosure is to enable greater penetration of variable renewable energy (VRE) on grids. Rather than storing the excess electricity from VRE, the excess electricity is directly used to power air separation units (ASUs) and CO2 compressors needed to generate zero-carbon and negative-carbon electricity on demand. This capability can be used instead of bulk energy storage (BES), such as battery storage. Because excess electricity is directly used for a valuable function, this eliminates the conversion and degradation losses inherent to BES. Rather than storing or wasting electricity generated by VRE during periods of oversupply, its direct, immediate use enables the delivery of zero-carbon and negative-carbon electricity when it is needed, including periods of high demand. This will assure a continuous, uninterrupted supply of zero-carbon and negative-carbon electricity, without resorting to BES.

Another pathway implemented by the present disclosure is the uninterrupted use of nuclear energy. A co-located nuclear-power facility, such as a small modular reactor, generates electricity continuously at its optimal design output. When there is excess electricity on the grid, the nuclear power facility has its power diverted to powering the ASUs and CO₂ compressors of the system described herein, thus allowing the generation of zero-carbon and negative-carbon electricity during periods of undersupply. The nuclear-power facility could be designed to deliver 100% of the power requirements for the ASU and CO2 compressors. When there is a demand for electricity, the nuclear power facility delivers 100% of its power to the grid. Because the oxy-combustion system of the present disclosure can be configured to have its power output modulated, unlike nuclear power, the oxy-combustion power system can be operated to follow the load, while the co-located, nuclear-power facility can deliver electricity constantly at its optimal design output.

Still another pathway implemented by the present disclosure is expanded deployment of geothermal power. This is accomplished by using local geothermal resources (even those with relatively low temperatures) at a very high thermal efficiency (e.g., 35-40%) to pre-heat boiler feedwater (BFW), which reduces fuel consumption and the quantity of captured CO2 that needs to be sent to a geological CO₂ storage (GCS) reservoir for zero-carbon or negative-carbon electricity.

Still another pathway implemented by the present disclosure is the expanded deployment of solar thermal energy (STE). Even if not strongly concentrated, STE can be used at a very high thermal efficiency (e.g., 35-40%) by boosting the temperature of boiler feedwater (BFW) before it is fed to a boiler to create steam for a steam turbine, which reduces fuel consumption and the quantity of captured CO₂ that needs to be sent to a GCS reservoir for zero-carbon or negative-carbon electricity.

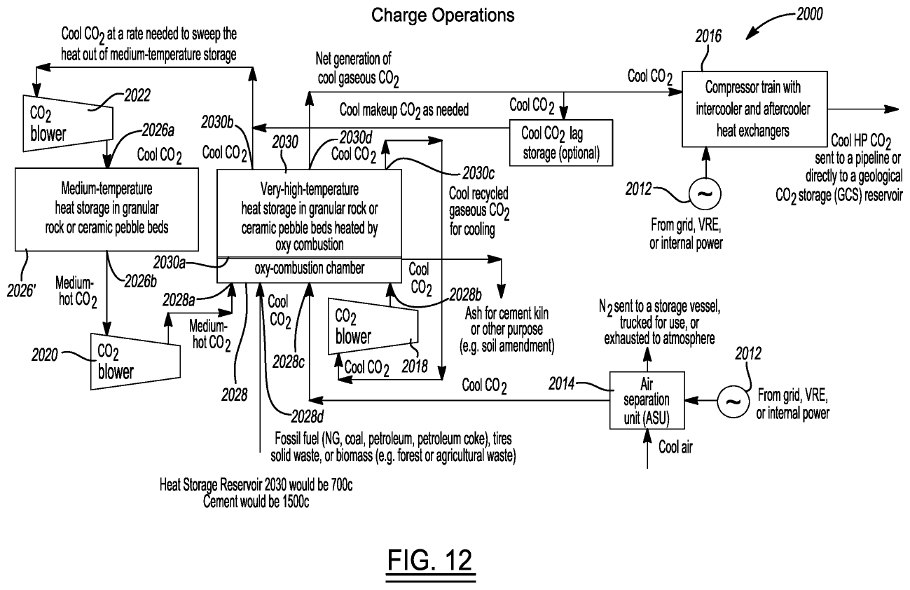

Still another pathway implemented by the present disclosure is replacing carbon-emitting electricity and carbon-emitting transportation with zero-carbon electricity and zero-carbon transportation. For electricity generation, combustion with air is replaced with oxy-combustion. Also, combustion is moved from furnaces inside the power plant to outside the power plant in oxy-combustion chambers sitting beneath insulated heat-storage vessels filled with granular-rock or ceramic pebble beds that store high-grade heat (FIG. 12, to be discussed below). Although in the present disclosure we show the oxy-combustion chambers sitting beneath the insulated heat-storage vessels, there may be situations where it is preferred that the oxy-combustion chambers sit above, or possibly adjacent to, the insulated heat-storage vessels. It shall be also noticed that oxy-combustion chambers are also referred to as oxy-combustion furnaces in this disclosure and that they are meant to refer to the same component. Excess electricity, including excess electricity from VRE and nuclear energy, is directly and immediately used to power the ASUs needed to generate high-purity O₂. Electricity and excess electricity, including excess electricity from VRE, is also used to power the CO₂ compressors needed to send the CO₂ to a GCS reservoir. Combusting fossil fuel in high-purity O₂ generates high-purity CO₂, which is a pre-combustion, CO₂-capture process that captures 100% of the generated CO₂, without incurring an additional CO₂ separation cost. This is in contrast to post-combustion CO₂ capture systems, which can only capture about 90% of the generated CO₂ contained in the exhaust flue gas and which incur a large separation cost. The present system and method enables zero-carbon electricity to be dispatched on demand to electrical grids instead of electricity from carbon-emitting power plants, while zero-carbon electricity can be used to power (i.e., charge) electric vehicles and transportation systems that replace carbon-emitting vehicles and transportation systems.

Still another pathway enabled by the present disclosure is replacing carbon-emitting electricity and transportation with negative-carbon electricity and transportation. When biomass, including forest biomass, forest-waste biomass, agricultural-residue biomass, and municipal solid waste (MSW), replaces fossil fuel in an oxy-combustion power plant, negative-carbon electricity is generated, rather than zero-carbon electricity or carbon-emitting electricity from conventional power plants. The combustion of biomass, and the subsequent geologic sequestration of the generated CO₂, is a negative-carbon process because it prevents that biomass from naturally decaying, which would release CO₂ and methane (if attacked by termites) to the atmosphere. The combustion of MSW is also a negative-carbon process, because had that MSW been left in a landfill, it would degrade and release methane, which possibly could be emitted to the atmosphere. It should be noted that methane is a greenhouse gas (GHG) that is much more potent than CO₂ in trapping heat. When biomass or MSW displace natural gas from power production, the unused natural gas can remain underground, eliminating the possibility of methane leakage, which, as stated above, is a more potent GHG than CO₂. Negative-carbon electricity can be used to power electric vehicles and transportation systems instead of zero-carbon electricity; it can also be used in electric vehicles and transportation systems that replace carbon-emitting vehicles and transportation systems.

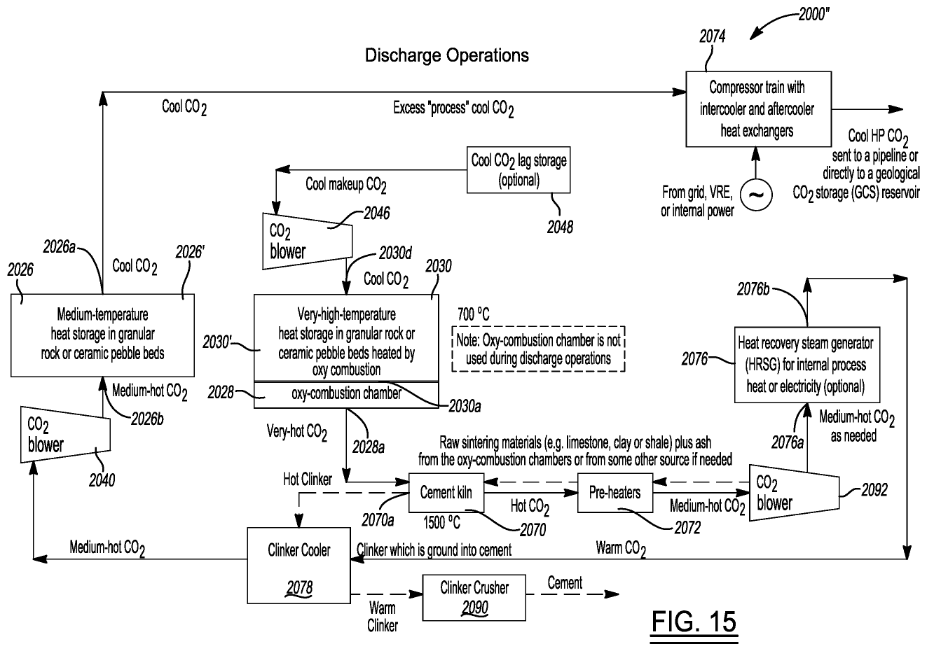

The systems and methods of this disclosure can be used to apply oxy-combustion, rather than combustion with air, for heavy industrial applications that require high-grade heat, such as cement manufacturing, which also generates “process” CO₂ from chemical processes (primarily the thermal decomposition of limestone). For cement manufacturing, combustion is moved from inside the cement kiln to outside the kiln in oxy-combustion chambers sitting beneath insulated heat-storage vessels filled with granular-rock or ceramic pebble beds that store high-grade heat (FIG. 12, to be discussed below). Although in the present disclosure we show the oxy-combustion chambers sitting beneath the insulated heat-storage vessels, there may be situations where it is preferred that the oxy-combustion chambers sit above, or possibly adjacent to, the insulated heat-storage vessels. Electricity and excess electricity, including excess electricity from VRE and nuclear energy, is used to power the ASUs used to generate high-purity O₂ for oxy-combustion of fuel mixtures, which may include coal, petroleum, petroleum coke, solid waste, tires, and biomass, to create hot, high-purity CO₂ to heat the granular beds. Electricity and excess electricity, including excess electricity from VRE and nuclear energy, is also used to power the CO₂ compressors needed to compress and send the high-purity CO₂ by pipeline to a GCS reservoir. Heat storage allows heat to be generated when it is advantageous, such as when there is excess electricity from VRE and nuclear energy, and/or the price of electricity to power the ASUs and compressors is low. Heat storage allows high-grade heat to be delivered continuously, enabling uninterrupted cement-plant operations. Very-hot CO₂ is sent through the kiln to heat and sinter the raw materials to form clinker, which is ground to cement (FIG. 15). Hot CO₂ leaving the kiln is sent to pre-heaters to pre-heat the raw materials, which may also include ash from the oxy-combustion chambers or from some other source. Medium-hot CO₂ leaving the pre-heaters is sent to a heat recovery steam generator (HRSG) to generate steam for process heat and/or to generate electricity from steam turbines, which cools the CO₂ to become warm CO₂. The warm CO₂ leaving the HRSG is sent to clinker coolers, where it cools hot clinker to become warm clinker, which heats the CO₂ to become medium-hot CO₂. The medium-hot CO₂ leaving the clinker coolers is sent to medium-temperature heat storage, which is part of the high-grade heat-storage system. It should be noted that this cooling process assures that no valuable heat is lost during the process of cooling the clinker, which reduces the fuel required to generate high-grade combustion heat. The medium-hot CO2 transfers its heat to the granular media in the medium-temperature insulated heat-storage vessels, thereby being cooled before being compressed and sent by pipeline to a GCS reservoir.

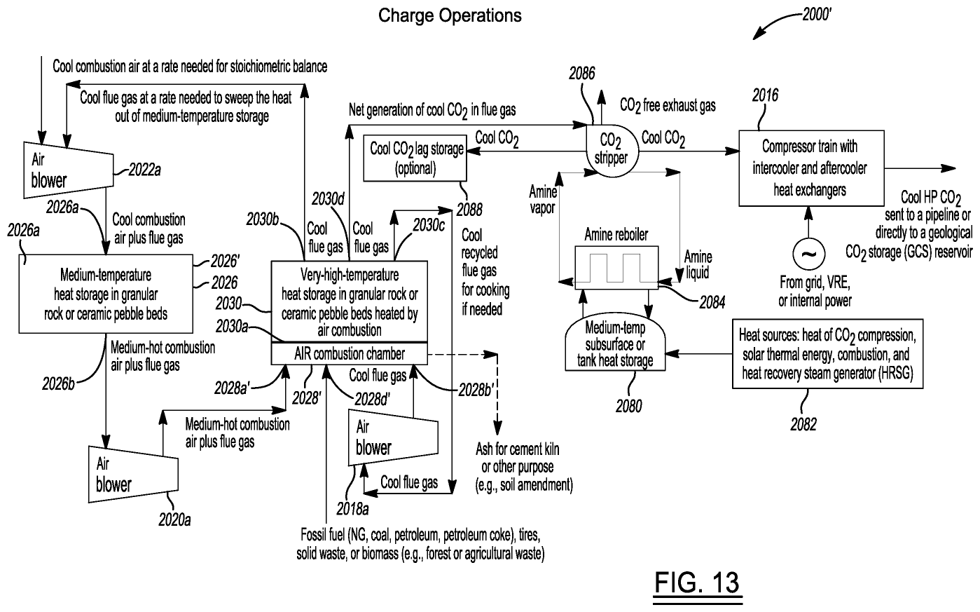

The systems and methods of this disclosure can be used to apply air-combustion of fossil fuel and/or biomass outside a power plant, rather than air-combustion of fossil fuel and/or biomass inside that power plant. For electricity generation, air-combustion is moved from furnaces inside a power plant to outside the power plant in air-combustion chambers sitting beneath insulated heat-storage vessels filled with granular-rock or ceramic pebble beds that store high-grade heat (FIG. 13, to be discussed below). Although in the present disclosure we show the air-combustion chambers sitting beneath the insulated heat-storage vessels, there may be situations where it is preferred that the air-combustion chambers sit above, or possibly adjacent to, the insulated heat-storage vessels. Electricity and excess electricity, including excess electricity from VRE and nuclear energy, may be used to power the CO₂ compressors needed to compress high-purity CO₂ after that CO₂ leaves CO₂ strippers (FIG. 13, to be discussed below). Solar thermal energy (STE) or excess STE may be used to supply the heat needed by amine reboilers used to strip CO₂ from flue gas. The combustion of biomass or MSW can also be used to supply heat to the amine reboilers. It should be appreciated that biomass or MSW combustion does not result in net CO₂ emissions because, had the biomass or MSW been allowed to naturally degrade, it would have released CO₂ and methane to the atmosphere.

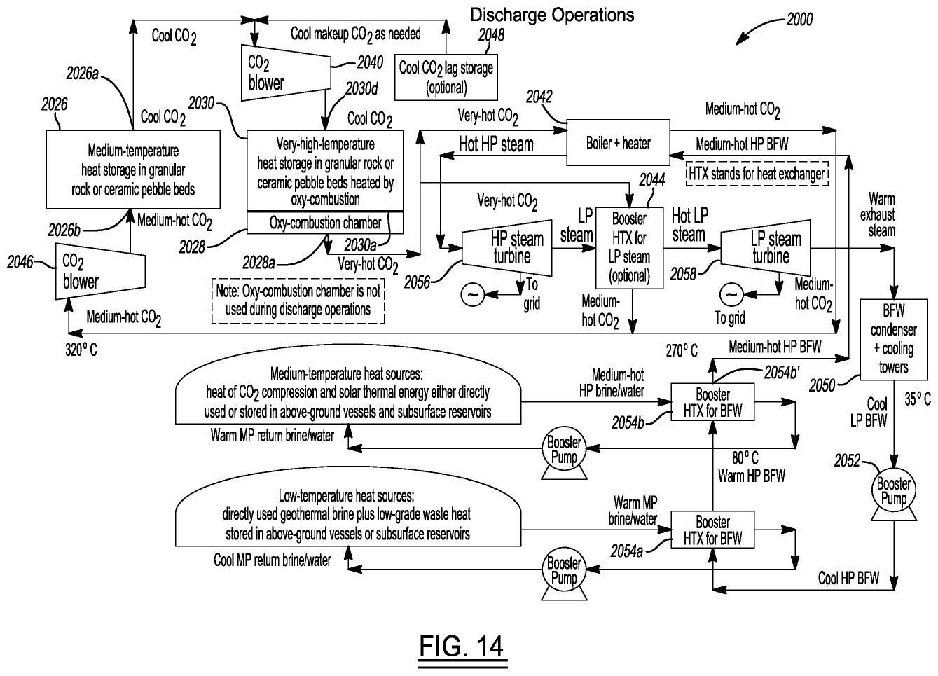

Heat storage allows heat to be generated when it is advantageous, such as when there is excess STE to supply heat to the amine reboilers and/or when there is excess electricity from VRE or nuclear energy, and/or the price of electricity to power the CO₂ compressors is low. Heat storage allows high-grade heat to be delivered to the power plant to generate electricity when VRE electricity is not available, and/or the price of electricity is high. It is important to note that when the systems and methods of this disclosure are used to apply air-combustion of biomass or MSW outside a power plant to generate electricity, it is not necessary to capture any of the generated CO₂ in order to achieve zero CO₂ emissions because the CO₂ that is generated would have been emitted to the atmosphere as a result of natural decay processes. Regardless of whether oxy-combustion (FIG. 12) or air-combustion (FIG. 13) are used to charge (i.e., heat) the high-grade heat-storage system, the process of delivering high-grade heat to the electricity-generating power plant (FIG. 14) is exactly the same.

The systems and methods of this disclosure can be used to apply air-combustion of fossil fuel and/or biomass (for the purpose of generating high-grade heat for heavy industrial applications) outside an industrial plant, rather than air-combustion of fossil fuel and/or biomass inside that industrial plant. For cement manufacturing, air-combustion is moved from inside the cement kiln to outside the cement kiln in air-combustions chambers sitting beneath insulated heat-storage vessels filled with granular-rock or ceramic pebble beds that store high-grade heat (FIG. 13, to be discussed below). Electricity and excess electricity, including excess electricity from VRE and nuclear energy, may be used to power the CO₂ compressors needed to compress high-purity CO₂ after that CO₂ leaves CO₂ strippers (FIG. 13, to be discussed below). Solar thermal energy (STE) or excess STE may be used to supply the heat needed by amine reboilers used to strip CO₂ from flue gas. The combustion of biomass or MSW can also be used to supply heat to the amine reboilers.

Heat storage allows heat to be generated when it is advantageous, such as when there is excess STE to supply heat to the amine reboilers and/or when there is excess electricity from VRE and nuclear energy, and/or the price of electricity to power the CO₂ compressors is low. Heat storage allows high-grade heat to be delivered continuously, enabling uninterrupted cement-plant operations. It is important to note that when the systems and methods of this disclosure are used to apply air-combustion of biomass or MSW outside a heavy industrial plant to generate high-grade heat, it is not necessary to capture any of the generated CO₂ in order to achieve zero CO₂ emissions because the CO₂ that is generated would have been emitted to the atmosphere as a result of natural decay processes. Regardless of whether oxy-combustion (FIG. 12) or air-combustion (FIG. 13) are used to charge (i.e., heat) the high-grade heat-storage system, the process of delivering high-grade heat to the cement kiln (FIG. 15) is exactly the same.

Referring to FIG. 12, one embodiment of a system 2000 in accordance with the present disclosure is shown, which included a process flow description for carrying out a charge operation. For the charge operation, electricity, including excess electricity from a power grid 2012, or electricity from variable renewable energy (VRE) sources, nuclear energy, and excess electricity from the power plant itself, may be used to power at least one (but optionally more than one) air separation unit (ASU) 2014 and at least one (but optionally more than one) compressor train 2016. The compressor train 2016 typically may include one or more independent compressors, with each compressor followed by one or more independent intercooler or aftercooler heat exchangers. The ASU 2014 is used to obtain high-purity oxygen (O₂) from air. The high-purity oxygen (e.g., 95-99% pure) in this embodiment thus forms a “first gaseous medium”.

The system 2000 also includes one or more CO₂ blower(s) 2018, 2020 and 2022. The CO₂ in this embodiment thus forms a “second gaseous medium”. One or more CO₂ blower(s) 2022 assist in blowing cool CO₂ (e.g., 25-50° C.) into port 2026a of at least one (or optionally more than one) medium-temperature, insulated heat-storage vessel 2026, which is filled with a granular media such as granular-rock or ceramic-pebble beds, which had been heated to a medium-hot temperature (e.g., 320-360° C.) during an earlier discharge cycle, as discussed below. This operation drives medium-hot CO₂ (e.g., 320-360° C.) out of port 2026b at an opposite (medium-hot) end 26′ of the vessel 2026 and, with the possible assistance of one or more CO₂ blower(s) 2020, into port 2028a of at least one (but optionally more than one) oxy-combustion chamber 2028. The oxy-combustion chamber 2028 is positioned beneath at least one (but optionally more than one) very-high-temperature insulated heat-storage vessel 2030. The very-high-temperature insulated heat-storage vessel 2030 is insulated and filled with a granular medium, for example and without limitation, granular-rock or ceramic-pebble beds.

With the assistance of one or more CO₂ blower(s) 2018, cool CO₂ (e.g., 25-50° C.), which leaves the top of the very-high-temperature insulated heat-storage vessel 2030 through port 2030c, is recirculated back into the oxy-combustion chamber 2028, through port 2028b, located at the bottom of the oxy-combustion chamber 2028, for temperature modulation of the flame temperature, as discussed below.

High-purity, cool O2 from the ASU 2014, entering through port 2028c, may be mixed with medium-hot CO₂ (e.g., 320-360° C.) entering through port 2028a, from the medium-temperature insulated heat-storage vessel 2026, and also with an additional fuel of choice (e.g., natural gas, coal, petroleum, petroleum coke, tires, solid waste, or biomass, such as forest biomass, forest-waste biomass, agricultural-residue biomass, and municipal solid waste, MSW) or a combination thereof, entering through port 2028d. Additionally, a sufficient amount of cool, recycled CO₂ is also blown into port 2028b, with the assistance of at least one CO₂ blower 2018, for temperature modulation of the flame temperature and thereby maintain the oxy-combustion chamber within a desired temperature range (e.g., 650° C.-700° C. for electricity generation and 1450° C.-1550° C. for cement manufacturing).

Fossil fuel, tires, solid waste, or biomass, or a combination thereof, enters through port 2028d and is combusted in high-purity O₂, which enters through port 2028c, inside the oxy-combustion chamber 2028 to create very-hot CO₂ and a very small quantity of water vapor within the desired temperature range (e.g., 650° C.-700° C. for electricity generation and 1450° C.-1550° C. for cement manufacturing), which is sent through port 2030a to at least one very-high-temperature, insulated heat-storage vessel 2030 to heat the one or more granular-rock or ceramic-pebble beds contained therein. The water vapor generated in the oxy-combustion process is easily separated from the CO₂ by condensation. This process advantageously creates a high-purity CO₂ stream and enables 100% of the combustion-generated CO₂ to be captured for geologic sequestration, without incurring a separation cost. It will be appreciated that for the present discussion, the terms “very-hot” and “highly heated” are intended to mean the same thing.

Combusting fossil fuel, solid waste, tires, or biomass, or a combination thereof, in high-purity O₂ creates a high flame temperature. To maintain a target combustion temperature (e.g., 700° C. for electricity, 1500° C. for cement manufacturing), additional CO₂ is recirculated through the one or more granular-rock or ceramic-pebble beds within the very-high-temperature insulated heat-storage vessel 2030 using the one or more CO₂ blower(s) 2018. Recirculation of CO₂ also helps to evenly distribute heat in the one or more granular-rock or ceramic-pebble beds contained within the very-high-temperature insulated heat-storage vessel 2030. The one or more granular-rock or ceramic-pebble beds are not fully heated during the high-grade, thermal-charging process. Heating continues until most (e.g., 80-85%) of the one or more granular-rock or ceramic-pebble beds have been heated to the target temperature (e.g., 700° C. for electricity, 1500° C. for cement manufacturing), which places the thermal front within 15-20% of the cool end (opposite the oxy-combustion chambers or adjacent ports 2030b, 2030c, and 2030d) of the one or more granular-rock or ceramic-pebble beds contained in the very-high-temperature insulated heat-storage vessel 2030. This assures that the downstream portion (e.g., 15-20%) of the one or more granular-rock or ceramic-pebble beds remains relatively unheated. This also ensures that CO₂ that exits the granular-rock or ceramic-pebble bed is relatively cool, thereby limiting the loss of heat as combustion-generated CO₂ is sent, through port 2030d, to the at least one compressor train 2016. The estimates of 80-85% and 15-20% cited above should be understood to be reasonable approximations. Cool combustion-generated CO₂ leaves the downstream portion of the one or more granular-rock or ceramic-pebble beds within the very-high-temperature insulated heat-storage vessel 2030 and is sent to the at least one compressor train 2016. The compressor train 2016 typically includes multiple compression stages and intercooler and aftercooler heat exchangers, placed after each compression stage, and produces CO₂ suitable for geologic sequestration. Cool high-pressure (HP) CO₂ (e.g., 25-50° C.) leaving the one or more aftercooler heat exchangers of the compressor train 2016 is either sent to a pipeline or sent directly to a geologic CO₂ storage (GCS) reservoir. If applicable, ash may be removed from the oxy-combustion chamber 2028 for use, if applicable and needed, in one or more cement kilns or for use for some other purpose, such as for soil amendment. Soil amendment may be applicable if agricultural-residue biomass, forest biomass, forest-waste biomass, or agricultural-residue biomass was used for oxy-combustion.

The system 2000 of the present disclosure also takes advantage of a closed-loop circulation path for the CO₂, which uses the CO₂ to transfer heat between the high-grade heat-storage system (shown in FIG. 12), which includes at least one medium-temperature insulated heat-storage vessel 2026, and at least one very-high-temperature insulated heat-storage vessel 2030, and either the electricity generation system (shown in FIG. 14), which includes at least one boiler plus heater assembly 2042 and, optionally, at least one booster heat exchanger 2044, or the cement-manufacturing system (shown in FIG. 15), which includes at least one cement kiln 2070 and at least one pre-heater 2072, both of which to be discussed below. Merely to avoid cluttering the drawing figure, only a single medium-temperature insulated heat storage-vessel 2026 and a single very-high-temperature insulated heat-storage vessel 2030 are shown. The purpose of this arrangement of medium-temperature and very-high-temperature insulated heat-storage vessels is for the closed CO₂ heat-transfer loop to operate between a high-grade temperature (e.g., 700° C. for electricity generation and 1500° C. for cement manufacturing) and a medium-grade temperature (e.g., 320-360° C. for electricity generation and 350-500° C. for cement manufacturing). When operated over this temperature range, more energy-efficient use of high-grade heat is possible for both electricity generation and heat-intensive industrial applications, such as cement manufacturing. The very-high-temperature insulated heat-storage vessel 2030 and the medium-temperature insulated heat-storage vessel 2026 are operated both in parallel and in series to allow the closed-loop recirculation of gaseous CO₂ to operate continuously during discharge operations. This makes it possible for medium-hot (e.g., 320-360° C.) gaseous CO₂ to always be returned to at least one of the medium-temperature insulated heat-storage vessels 2026. A separate, closed CO₂ temperature modulation loop is formed between the CO₂ blower 2018 and the very-high-temperature insulated heat-storage vessel 2030 which enables precise control over the temperature in the oxy-combustion chamber 2028.

Referring now to FIG. 13, the following description is for a charge operation with air-combustion. Thus, in this embodiment of FIG. 13, air forms the “first gaseous medium”. Note that it has many similarities with a charge operation with oxy-combustion, described immediately above. Referring to FIG. 13, one embodiment of a system 2000′ in accordance with the present disclosure is shown, which includes a process flow description for carrying out a charge operation using air. Components in common with the system 2000 have been denoted with the same reference numbers used in FIG. 12. For the charge operation, electricity, including excess electricity from the power grid 2012, or electricity from variable renewable energy (VRE) sources, nuclear energy, and excess electricity from the power plant itself, may be used by at least one (but optionally more than one) compressor train 2016. The compressor train 2016 typically may include one or more independent compressors, with each compressor followed by one or more independent intercooler or aftercooler heat exchangers. Additionally, medium-grade heat, such as from solar thermal energy (STE), including excess STE, may be used to heat amine re-boilers 2084, which heat amine liquid to form the amine vapor used by CO₂ strippers 2086 to strip CO₂ from flue gas.

The system 2000′ also includes one or more air blower(s) 2018a, 2020a and 2022a. The air blower 2022a assist in blowing cool combustion air (e.g., 15-30° C.) into port 2026a of at least one (or optionally more than one) medium-temperature, insulated heat-storage vessel 2026, which is filled with a granular media such as granular-rock or ceramic-pebble beds, which had been heated to a medium-hot temperature (e.g., 320-360° C.) during an earlier discharge cycle, as discussed below. This operation drives medium-hot combustion air (e.g., 320-360° C.) out of port 2026b at an opposite (medium-hot) end 2026′ of the vessel 2026 and, with the possible assistance of the air blower 2020a, into port 2028a′ of at least one (but optionally more than one) air-combustion chamber 2028′. The air-combustion chamber 2028′ is positioned beneath at least one (but optionally more than one) very-high-temperature insulated heat-storage vessel 2030. The very-high-temperature insulated heat-storage vessel 2030 is insulated and filled with a granular medium, for example and without limitation, granular-rock or ceramic-pebble beds.

With the possible assistance of the at least one air blower 2022a, a near-stoichiometric (or slightly greater) quantity of cool combustion air (e.g., 15-30° C.) is sent to port 2026a of the least one medium-temperature insulated heat-storage vessel 2026. The cool combustion air (e.g., 15-30° C.) is heated by the granular media contained therein to become medium-hot combustion air (e.g., 320-360° C.) that leaves port 2026b of the at least one medium-temperature storage vessel 2026.

The following describes the air-combustion process that occurs with the system 2000′. With the possible assistance of the at least one air blower 2020a, a near-stoichiometric (or slightly greater) quantity of medium-hot combustion air (e.g., 320-360° C.) leaving port 2026b of the at least one medium-temperature insulated heat-storage vessel 2026, is sent to port 2028a′ of the least one air-combustion chamber 2028′, where it is mixed with an additional fuel of choice (e.g., and without limitation, natural gas, coal, petroleum, petroleum coke, tires, solid waste, such as municipal solid waste (MSW), or biomass, such as forest biomass, forest-waste biomass, and agricultural-residue biomass) or a combination thereof, which has been sent to port 2028d′ of the at least one air-combustion chamber 2028′. Additionally, with the possible assistance of the at least one air blower 2018a, a sufficient amount of cool, recycled flue gas (e.g., 25-50° C.) is also blown into port 2028b′ for temperature modulation of the flame temperature to thereby help maintain the air-combustion chamber 2028′ within a desired temperature range (e.g., 650° C.-700 C for electricity generation and 1450° C.-1550° C. for cement manufacturing). If applicable, ash may be removed from the at least one air-combustion chamber 2028a′ for use, if applicable and needed, in at least one cement kiln 70 (FIG. 4) or for use for some other purpose, for example and without limitation, soil amendment. Soil amendment may be applicable if agricultural-residue biomass, forest biomass, or forest-waste biomass was part of the fuel mix in the air-combustion process and no hazardous materials were included in the fuel mix.

Fossil fuel, tires, solid waste, or biomass, or a combination thereof, sent to port 2028d′ of the at least one air-combustion chamber 2028′ is combusted in a near-stoichiometric quantity of air. This creates very-hot flue gas and a very small quantity of water vapor within the desired temperature range (e.g., 650° C.-700° C. for electricity generation and 1450° C.-1550° C. for cement manufacturing), which is sent to port 2030a of the at least one very-high-temperature, insulated heat-storage vessel 2030 to heat at least one granular-rock or ceramic-pebble bed contained therein. The water vapor generated by the air-combustion process is easily separated from the flue gas by condensation. It should be noted that a near-stoichiometric quantity of air is desired for the air-combustion process in order to maximize the concentration of CO₂ in the flue gas and thereby enable the optional process of CO₂ stripping, which is described later, to be more efficient.

Combusting fossil fuel, solid waste, tires, or biomass, or a combination thereof, in a stoichiometric quantity of combustion air creates a high flame temperature. To maintain a target combustion temperature (e.g., 700° C. for electricity, 1500° C. for cement manufacturing), with the assistance of at least one air blower 2018a, additional cool flue gas (e.g., 20-30° C.) may be recirculated through at least one granular-rock or ceramic-pebble bed within the at least one very-high-temperature insulated heat-storage vessel 2030. Recirculation of flue gas also helps to evenly distribute heat in the at least one granular-rock or ceramic-pebble bed within the at least one very-high-temperature insulated heat-storage vessel 2030. The at least one granular-rock or ceramic-pebble bed is not fully heated during the high-grade, thermal-charging process. Heating continues until most (e.g., 80-85%) of the at least one granular-rock or ceramic-pebble bed within the at least one very-high-temperature insulated heat-storage vessel 2030 has been heated to the target temperature (e.g., 700° C. for electricity, 1500° C. for cement manufacturing). This places the thermal front within 15-20% of the cool end (opposite the air-combustion chambers or adjacent ports 2030b, 2030c, and 2030d) of the at least one granular-rock or ceramic-pebble bed contained in the at least one very-high-temperature insulated heat-storage vessel 2030. This assures that the downstream portion (e.g., 15-20%) of the granular-rock or ceramic-pebble bed remains relatively unheated. This also ensures that flue gas that exits port 2030d of the at least very-high-temperature insulated heat-storage vessel 2030 is cool (e.g., 20-30° C.), thereby limiting the loss of heat as flue gas is sent to at least one CO₂ stripper 2086.

It will be appreciated that the estimates of 80-85% and 15-20% cited above should be understood to be reasonable approximations. It shall also be noted that sending flue gas to at least one CO₂ stripper 2086 is an option. If biomass or MSW had been the fuel for air-combustion, it may have been deemed unnecessary to capture the generated CO₂ because that CO₂ would have been released to the atmosphere by natural degradational processes had that biomass and/or not been used for air-combustion.

With further reference to FIG. 13, a quantity of cool flue gas (e.g., 20-30° C.), corresponding to the net generation of flue gas from the at least one air-combustion chamber 2028′, leaves port 2030d, which is at the downstream (cool) portion of the at least one granular-rock or ceramic-pebble bed within the at least one very-high-temperature insulated heat-storage vessel 2030, and is sent either to at least one CO₂ stripper 2086 or is exhausted to the atmosphere. The remaining portion of the cool flue gas (e.g., 20-30° C.) (if any) leaving the at least one very-high-temperature insulated heat-storage vessel 2030 exits through port 2030b. With the assistance of the at least one air blower 2022a, the cool flue gas (e.g., 20-30° C.) that leaves port 2030b is sent to port 2026a of the at least one medium-temperature, insulated, heat-storage vessel 2026, where the cool flue gas (e.g., 20-30° C.) is heated by the granular media contained therein to become medium-hot flue gas (e.g., 320-360° C.). The medium-hot flue gas is then mixed with medium-hot combustion air (e.g., 320-360° C.). Note that this process may not be necessary and that it is likely that the majority (if not all) of the gas leaving port 2026b of the at least one medium-temperature insulated heat-storage vessel 2026, will be medium-hot combustion air.

With further reference to FIG. 13, the following describes the optional process of stripping CO₂ from flue gas to form cool high-purity CO₂ (e.g., 20-30° C.). Medium-hot HP brine and/or water (e.g., 210-280° C.) from at least one of a subsurface reservoir and storage tank 2080, which contain stored heat from at least one of solar thermal energy and the heat of CO₂ compression, is sent to at least one amine reboiler 2084, where it is used to heat amine liquid to become amine vapor. Alternatively, heat can be sent directly to the at least one amine reboiler 2084 from a medium-temperature heat source 2082, for example and without limitation, solar thermal energy, heat of CO₂ compression, steam from a heat recovery steam generator, and the combustion of at least one of biomass and municipal solid waste. Amine vapor leaving the at least one amine reboiler 2084 is sent to at least one CO₂ stripper 2086, where it is used to strip CO₂ from flue gas. This process produces a stream of nearly CO₂-free exhaust gas, which is released to the atmosphere and a stream of cool high-purity CO₂ (e.g., 20-30° C.), which is sent to the at least one compression train 2016. The at least one compressor train 2016 typically includes multiple compression stages and intercooler and aftercooler heat exchangers, placed after each compression stage, and produces CO₂ suitable for geologic sequestration. Cool high-pressure (HP) CO₂ (e.g., 20-30° C.) leaving the one or more aftercooler heat exchangers of the at least one compressor train 2016 is either sent to a pipeline or sent directly to a geologic CO₂ storage (GCS) reservoir. A portion of the cool high-purity CO₂ (e.g., 20-30° C.) leaving the at least one CO₂ stripper 2086 may be sent to cool CO₂ lag storage 2088 for use during discharge operations, described later.

Referring now to FIG. 14, a process flow description will be provided for the CO₂ heat-transfer loop associated with a discharge operation for electricity generation using the system 2000. Initially, the high-grade, thermal-discharge process involves a gaseous-CO₂ heat-transfer loop and preferably using parallel sets of the very-high-temperature insulated heat-storage vessels 2030 filled with granular-rock or ceramic-pebble beds, and also preferably using parallel sets of the medium-temperature insulated heat-storage vessels 2026 filled with one or more granular-rock or ceramic-pebble beds. The very-high-temperature insulated heat-storage vessel 2030 and the medium-temperature insulated heat-storage vessel 2026 are operated both in parallel and in series to allow the closed-loop recirculation of gaseous CO₂ to operate continuously during discharge operations. This makes it possible for medium-hot (e.g., 320-360° C.) gaseous CO₂ to always be returned to at least one of the medium-temperature insulated heat-storage vessels 2026. Again, it will be appreciated that two or more of each of the vessels 2026 and 2030 may be employed, but FIG. 14 illustrates just one subsystem of each to avoid unnecessarily cluttering the figure.

With the assistance of at least one (possibly more than one) CO₂ blower 2040 and/or 2046, the high-grade, thermal-discharge process begins with cool CO₂ (e.g., 25-50° C.) being blown into the at least one very-high-temperature insulated heat-storage vessel 2030 through port 2030d thereof. This operation drives very hot CO₂ out through port 2030a of the opposite (very hot) end of the vessel 2030, where the oxy-combustion chamber 2028 is located. It also may drive very hot CO₂ out through port 2028a, which is located at the bottom of the oxy-combustion chamber 2028. Note that the cool CO₂ is blown into the end of the very-high-temperature insulated heat-storage storage vessel 2030 opposite the end with the oxy-combustion chamber 2028, which is not used during discharge operations. Because this is a closed-loop process, the cool CO₂ has already exited port 2026a at a cool end of the medium-temperature insulated heat-storage vessel 2026.

With the assistance of at least one (possibly more than one) CO₂ blower 2040 and/or 2046, cool CO₂ (e.g., 25-50° C.) continues to be blown into the very-high-temperature insulated heat-storage vessel 2030, through port 2030d, driving very-hot CO₂ out of port 2030a at the opposite (hot) end of the vessel, and possibly out of port 2028a, until only a small percentage (e.g., 15-20%) of the granular bed in the vessel is at the target temperature (e.g., 700° C.). This results in a large percentage (e.g., 80-85%) of the granular bed in the very-high-temperature insulated heat-storage storage vessel 2030 being cooled to less than the target temperature. The largely cool granular bed is now ready to be thermally charged during the subsequent charge operations. It will be understood that the estimates of 80-85% and 15-20% cited above are approximations and may be refined upon further analysis.

Very-hot CO₂ (e.g., 700° C.) that leaves the at least one very-high-temperature insulated heat-storage vessel 2030 is sent to a subsystem (i.e., collection of at least components 2042, 2056, 2044, 2058) that, in this embodiment uses the very-hot CO₂ to eventually generate electricity, as will be described in greater detail below. FIG. 15, to be described momentarily, shows another embodiment of the present disclosure in which the subsystem forms a system for making cement.

The subsystem shown in FIG. 14 includes at least one (but optionally more than one) boiler plus heater assembly 2042, where it heats hot high-pressure (HP) BFW, which cools the very-hot CO₂, causing it to become medium-hot (e.g., 320-360° C.) CO₂.

With the possible assistance of one or more CO₂ blower(s) 2046, medium-hot CO₂ (e.g., 320-360° C.) that leaves the boiler/heater assembly 2042 is sent back to the one or more medium-temperature insulated heat-storage vessels 2026. This completes the CO₂ heat-transfer loop, which as noted above is a closed loop operation.

Very-hot (e.g., 700° C.) CO₂ that leaves the very-high-temperature insulated heat-storage vessel 2030 may be sent to at least one (but optionally more than one) booster heat exchanger (HTX) 2044 where it heats low-pressure (LP) steam, causing very-hot CO₂ to become medium-hot (e.g., 320-360° C.) CO₂. It will be appreciated, however, that the use of the booster HTX 2044 is an option and is not required with the system 2000.

With the possible assistance of one or more CO2 blower(s) 2046, medium-hot (e.g., 320-360° C.) CO₂ that leaves the booster HTX 2044 is sent back to at least one medium-temperature insulated heat-storage vessel 2026, thereby completing the CO₂ heat-transfer loop.

With the possible assistance of at least one CO₂ blower 2046, medium-hot CO₂ (e.g., 320-360° C.) continues to be blown into port 2026b of the medium-temperature insulated heat-storage vessel 2026 until only a small percentage (e.g., 15-20%) of the granular media at the cool end (the end adjacent port 2026a) is cool (e.g., 20-30° C.). This results in a large percentage (e.g., 80-85%) of the granular bed at the medium-hot end of the medium-temperature insulated heat-storage vessel 2026 (i.e., the end adjacent port 2026b) having been heated to the target temperature (e.g., 320-360° C.). The largely medium-hot granular bed within the medium-temperature insulated heat-storage vessel 2026 is now ready to be thermally discharged during the subsequent charge operations.

With the possible assistance of the one or more CO₂ blower 2040, the cool CO₂ (e.g., 25-50° C.) leaving the medium-temperature insulated heat-storage vessel 2026 through port 2026a is blown into the very-high-temperature insulated heat-storage vessel 2030 through port 2030d. This operation drives very-hot CO₂ out of the opposite end (i.e., the hot end of the vessel 2030 adjacent the oxy-combustion chamber 2028), through port 2030a, and possibly out of port 2028a located at the bottom of the combustion chamber 2028, until only a small percentage (e.g., 15-20%) of the granular bed in the vessel 2030 is at the target temperature (e.g., 700° C.). Note that some cool makeup CO₂, taken from an optional cool CO₂ lag storage reservoir 2048, may be also blown into the very-high-temperature insulated heat-storage vessel 2030, through port 2030d.

Referring further to FIG. 14, the process flow description for the boiler feedwater (BFW) loop of the discharge operations will now be described. Initially, cool (e.g., 35-45° C.) low-pressure (LP) boiler feedwater (BFW) that leaves at least one (or optionally more than one) BFW condenser 2050, along with makeup BFW, if needed, is sent to at least one (or optionally more than one) more booster pump 2052. This causes the cool LP BFW to become cool high-pressure (HP) BFW. It shall be appreciated that for the purpose of this disclosure, what is meant by high-pressure (HP) BFW is boiler feedwater with a pressure high enough to prevent it from flashing to steam when heated to a desired temperature. So, for example, if HP BFW is to be heated to 270° C., then the pressure of that BFW must be at least 56 bar to prevent it from flashing to steam. Whenever HP BFW is referred to in the present disclosure, it is to be understood that the pressure is high enough to prevent the BFW from flashing to steam.

Cool (e.g., 35-45° C.) HP BFW is successively heated in a series of one or more booster heat exchangers (HTXs) 2054a and 2054b (two being shown in this example) for BFW. The HTXs 2054a and 2054b use progressively higher temperature heat sources, causing cool HP BFW to become medium-hot (e.g., 200-270° C.) HP BFW at output 2054b′. The heat sources may include, for example and without limitation, one or more of geothermal brine, low-grade waste heat, the heat of CO₂ compression, solar thermal energy (STE), combustion of biomass, and nuclear energy. The biomass may comprise, without limitation, forest biomass, forest-waste biomass, agricultural-residue biomass, and municipal solid waste (MSW).

Medium-hot (e.g., 200-270° C.) HP BFW that leaves the booster HTX 2054b for BFW is sent to the boiler/heater assembly 2042 where it is heated by very-hot (e.g., 650-700° C.) CO₂. This causes the medium-hot HP BFW (e.g., 200-270° C.) to become hot (e.g., 600-650° C.) HP steam. Hot (e.g., 600-650° C.) HP steam that leaves the boiler/heater assembly 2042 is sent to at least one (and optionally more than one) HP steam turbine 2056, which generates electricity for the grid. This causes the hot HP steam to become LP steam.

The LP steam that leaves the HP steam turbine 2056 may be sent to at least one booster HTX 2044 where it is heated by very-hot CO₂ (e.g., 650-700° C.). This causes the LP steam to become hot LP steam (e.g., 600-650° C.). Note that this is an option, however, and is not necessarily required for operation of the system 2000.

Hot (e.g., 600-650° C.) LP steam that leaves the booster HTX 2044 is sent to at least one (but optionally more than one) LP steam turbine 2058, which generates electricity for the grid. This process also causes the hot LP steam to become warm exhaust steam (e.g., 210° C.).

If the booster HTX 2044 is not used to reheat steam, then LP steam leaving the HP steam turbine 2056 is sent directly to the LP steam turbine 2058, which generates electricity for the grid. This process causes the hot LP steam to become warm exhaust steam (e.g., 50° C.).

Warm exhaust steam (e.g., 50-210° C.) that leaves the LP steam turbine 2058 may be sent directly to the BFW condenser 2050, where with the assistance of cooling towers, it becomes cool (e.g., 35-45° C.) BFW. The cool LP BFW is then recycled for the BFW-loop process. This process causes the pressure of the cool LP BFW to be less than 1 atm.

Referring to FIG. 15, the following process flow description is for the discharge operations for an embodiment 2000″ of the present disclosure which is tailored specifically for cement production. While it may be possible that discharge operations occur intermittently with the system 2000″, it is more likely that the discharge operations for a cement manufacturing plant will occur continuously. Note that the first three steps listed below are the same as those for discharge operations for electricity generation as explained for the system 2000 of FIG. 14. Also note that components in common with those described for FIG. 13 have been designated with the same reference numbers used in FIG. 14.

In FIG. 15, the high-grade, thermal-discharge process using the system 2000″ involves a gaseous-CO₂ heat-transfer loop and the at least one medium-temperature insulated heat-storage vessel 2026, and the at least one very-high-temperature insulated heat-storage vessel 2030, but preferably more parallel sets of such storage vessels. Merely to avoid cluttering the drawing figure, only a single medium-temperature insulated heat storage-vessel 2026 and a single very-high-temperature insulated heat-storage vessel 2030 are shown. The very-high-temperature insulated heat-storage vessel 2030 is filled with, without limitation, one or more granular-rock or ceramic-pebble beds. At least one medium-temperature insulated heat-storage vessel 2026 is used, although parallel sets of such vessel are even more preferred. The medium-temperature insulated heat-storage vessel 2026 is filled with, without limitation, granular-rock or ceramic-pebble beds. The very-high-temperature insulated heat-storage vessel 2030 and the medium-temperature insulated heat-storage vessel 2026 are operated both in parallel and in series to allow the closed-loop recirculation of gaseous CO₂ to operate continuously during discharge operations. This makes it possible for medium-hot (e.g., 350-500° C.) gaseous CO₂ to always be returned to at least one of the medium-temperature insulated heat-storage vessels 2026.

With the assistance of at least one (possibly more than one) CO₂ blower(s) 2040 and/or 2046, the high-grade, thermal-discharge process begins with cool CO₂ (e.g., 25-50° C.) being blown into port 2030d of the very-high-temperature insulated heat-storage vessel 2030. This operation drives very-hot CO₂ (e.g., 1450° C.-1550° C.) out of port 2030a at the opposite (very hot) end of the vessel 2030 where the oxy-combustion chamber 2028 is located. It may also drive very hot CO₂ out of port 2028a, located at the bottom of the oxy-combustion chamber 2028. Note that the oxy-combustion chamber 2028 is not used during discharge operations. Because this is a closed-loop process, the cool CO₂ has already exited port 2026a at the cool end 2026′ of the medium-temperature insulated heat-storage vessel 2026.

With the assistance of at least one (possibly more than one) CO₂ blower(s) 2040 and/or 2046, cool CO₂ (e.g., 25-50° C.) continues to be blown into port 2030d of the very-high-temperature insulated heat-storage vessel 2030. This operation drives very-hot CO₂ (typically 1450° C.-1550° C.) out of port 2030a at the opposite (hot) end of the vessel 2030, and possibly out of port 2028a, located at the bottom of the oxy-combustion chamber 2028, until only a small percentage (e.g., 15-20%) of the granular media bed in the vessel is at the target temperature (e.g., 1500° C.). This results in a large percentage (e.g., 80-85%) of the granular media bed in the very-high-temperature insulated heat-storage vessel 2030 having been cooled to less than the target temperature. The largely-cool granular media bed in the very-high-temperature insulated heat-storage vessel 2030 is now ready to be thermally charged during the subsequent charge operations.

Very-hot CO2 (e.g., 1450° C.-1550° C.) that leaves port 2030a of at least one very-high-temperature insulated heat-storage vessel 2030, and possibly out of port 2028a, located at the bottom of the oxy-combustion chamber 2028, is sent to at least one cement kiln 2070. As noted above, in this embodiment 2000″ the subsystem comprises the cement kiln 2070 and may also include one or more components 2072, 2076, 2078, 2090, 2092, and 2074 (to be discussed momentarily). Optionally, a plurality of cement kilns 2070 may be used, but for simplicity only one is shown in FIG. 15. The very-hot CO₂ enters the cement kiln 2070 where it heats and sinters the raw materials. The raw materials used in the sintering process may include, without limitation, limestone, clay or shale, ash, or other waste products.

The sintering process generates hot clinker (1400-1500° C.), which leaves an upstream end 2070a of the at least one cement kiln 2070 and enters at least one clinker cooler 2078, where it is cooled by warm CO₂ (e.g., 70-90° C.), which has left the at least one heat recovery steam generator (HRSG) plus condensing steam-turbine power system 2076 (as discussed momentarily). In the at least one clinker cooler 2078, hot clinker (1400-1500° C.) transfers its heat to the warm CO₂ (e.g., 70-90° C.) to form warm clinker (e.g., 90-110° C.) and medium-hot CO₂ (e.g., 350-500° C.). Warm clinker (e.g., 90-110° C.) leaves the at least one clinker cooler 2078 and is sent to at least one clinker crusher 2090, where it is crushed into cement.

The sintering process also generates “process” CO₂ (primarily from the thermal decomposition of limestone), which flows out of the at least one cement kiln 2070, along with the “heat-transfer” CO₂, which is used in the high-grade CO₂ heat-transfer loop between the at least one very-high-temperature insulated heat-storage vessel 2030 and the at least one cement kiln 2070.

Hot CO₂ (800-900° C.), which includes “heat-transfer” CO₂ and “process” CO₂, leaving the cement kiln 2070 is sent to at least one pre-heater 2072 (or optionally a plurality of pre-heaters 2072 coupled in series or parallel) where it is used to pre-heat the raw materials before the raw materials are fed into the at least one kiln 2070. Pre-heating the raw materials cools the hot CO₂ (e.g., 800-900° C.), causing it to become medium-hot CO₂ (e.g., 350-500° C.).

With the assistance of at least one CO₂ blower 2092, medium-hot CO₂ (e.g., 350-500° C.) leaving the pre-heater 2072 is sent to port 2076a of at least one heat recovery steam generator HRSG plus condensing steam-turbine power system 2076, where it supplies heat to generate steam for process heat and/or steam for at least one condensing LP steam turbine used to generate power for the cement plant and/or the grid. The HRSG 2076, cools medium-hot CO₂ (e.g., 350-500° C.) to become warm CO₂ (e.g., 70-90° C.), which leaves port 2076b and is sent to at least one clinker cooler 2078, where it cools hot clinker (e.g., 1400-1500° C.) to become warm clinker (e.g., 90-110° C.), as previously described. This process creates medium-hot CO₂ (e.g., 350-500° C.), which leaves the at least one clinker cooler 2078 and is sent to port 2026b of at least one medium-temperature insulated heat-storage vessel 2026, where it heats the granular media contained therein. The purpose is for medium-hot CO₂ to transfer its heat to the granular media within the medium-temperature insulated heat-storage vessel 2026, thereby cooling the CO₂ before the cool CO₂ leaves port 2026a of the medium-temperature insulated heat-storage vessel and is sent to a compressor train 2074, which typically includes multiple compression stages and multiple intercooler and aftercooler heat exchangers, placed after each compression stage, and produces CO₂ suitable for geologic sequestration. The compressor train preferably includes one or more compression stages and one or more each of intercooler and aftercooler heat exchangers. Stored medium-grade heat in the granular media of the medium-temperature insulated heat-storage vessel 2026 is subsequently sent, via medium-hot CO₂, to the very-high-temperature insulated heat-storage vessel 2030 during charging operations. This reduces, typically by 20% or possibly more, the fuel required to generate high-grade heat.

With the assistance of at least one CO₂ blower 2040 and/or 2046, medium-hot CO₂ (e.g., 350-500° C.) continues to be blown into port 2026b of at least one medium-temperature insulated heat-storage vessel 2026 until only a relatively small percentage (e.g., 15-20%) of the granular media at a cool end 2026′ of the medium-temperature insulated heat-storage vessel 2026 is cool (e.g., 25° C.). This results in a large percentage (e.g., 80-85%) of the granular media bed at the medium-hot end of the medium-temperature insulated heat-storage vessel 2026, adjacent to port 2026b having been heated to the target temperature (e.g., 350-500° C.). This process assures that cool CO₂ (e.g., 25-50° C.) leaves port 2026a at the cool end 2026′ of the medium-temperature insulated heat-storage vessel 2026 before being sent to the one or more CO₂ compressor trains 2074.

With the assistance of at least one CO₂ blower 2040 and/or 2046, a portion (corresponding to the “heat-transfer” CO₂ used to deliver heat to the kilns) of the cool CO₂ (e.g., 25-50° C.) leaving port 2026a of at least one medium-temperature insulated heat-storage vessels 2026 is blown into port 2030d of at least one very-high-temperature insulated heat-storage vessels 2030. This operation drives very-hot CO₂ (e.g., 1450° C.-1550° C.) out of port 2030a at the opposite (very hot) end 2030′ of the vessel, and possibly out of port 2028a, until only a small percentage (e.g., 15-20%) of the granular media bed in the vessel is at the target temperature (e.g., 1500° C.). Note that to assist in this process some cool makeup CO₂, taken from cool CO₂ lag storage vessel 2048, may be also blown into the very-high-temperature insulated heat-storage vessel 2030 through port 2030d. This completes the CO₂ heat-transfer loop.

With the assistance of at least one CO₂ blower 2040 and/or 2046, a portion (corresponding to the “process” CO₂ that primarily results from the thermal decomposition of limestone) of the cool CO₂ (e.g., 25-50° C.) leaving port 2026a of at least one medium-temperature insulated heat-storage vessel 2026 is sent to the at least one compressor train 2074, which as noted may contain one or more compressor(s) followed by one or more heat exchangers.

In conventional cement manufacturing plants, the heat in the flue gas that leaves the pre-heaters is sometimes wasted. The heat removed from hot clinker is also sometimes released to the atmosphere and wasted. The systems and methods of the present disclosure assure that 100% of the heat leaving the pre-heaters is used to assist in the cement manufacturing process, such as in providing additional process heat to the cement plant and to generate electricity needed to power the cement-plant infrastructure, such as the grinders. The systems and methods of the present disclosure also assure that 100% of the heat removed from the clinker-cooling operations is returned to medium-grade heat storage, which is part of the high-grade heat-storage system. Altogether, the systems and methods of this disclosure can reduce fuel consumption by 20% or possibly more, which reduces fuel cost and the quantity of CO₂ generated by combustion. The reduction in generated CO₂ reduces the cost of CO₂ compression and geological sequestration. Because both combustion and process CO₂ are high-purity, the CO₂ can be compressed and sent to a GCS reservoir without incurring an additional CO₂ separation cost. With 100% of the generated CO₂ being sent to a GCS reservoir, it is unnecessary to modify cement composition or use alternative materials to reduce the CO₂ intensity of cement. This allows cement manufacturers to optimize the composition of their cement for strength, durability, and cost. It should be noted that fundamental changes to the composition of cement could have a disruptive impact on cement manufacturers because it may require replacing core components of their facilities. The systems and methods of the present disclosure allow cement manufacturers to continue to use the major core components of their facilities, which is less disruptive than the potential impact that fundamental changes in cement composition may result in. Because much of the CO₂ intensity associated with construction projects is derived from the CO₂ intensity of cement, it is expected that there will be a high demand for zero-carbon and/or negative-carbon cement manufactured using the systems and methods of the present disclosure. There are also Federal tax credits under the U.S. Federal tax code for CO₂ capture and geologic sequestration that may apply to cement manufacturers who use the technology covered by the systems and methods disclosed herein. Altogether, it is expected that the systems and methods described herein are likely to find strong interest among cement manufacturers, as well as in other industries which require large amounts of high-grade heat to produce a product or to carry out an industrial process.

The systems and methods of the present disclosure enable cement to be manufactured with near-zero CO₂ emissions, transforming cement from a CO₂-intensive material to a green building material. When biomass is used, cement can be manufactured with negative CO₂ emissions, and cement becomes environmentally competitive with sustainable building materials, such as wood. The record-setting 2020 year wildfires in the United States have burnt millions of acres across much of the western United States. The huge inventory of forest-waste biomass resulting from those wildfires and forest-thinning projects planned by the U.S. Forest Service creates a synergistic opportunity for create negative-carbon, cement plants throughout the western U.S., using the systems and methods of the present disclosure, for producing “green” or “sustainable” cement. The use of agricultural-residue biomass can also increase the opportunity for manufacturing negative-carbon cement.

The large inventory of forest-waste biomass in the United States also creates a synergistic opportunity to generate electricity with negative CO₂ emissions, using the systems and methods of the present disclosure.

It will be appreciated that the foregoing discussion has used various terms (e.g., “warm CO₂”) in explaining the operation of the various embodiments. For this purpose, it may be understood that “cool CO₂” may be, for example and without limitation, CO₂ between 25° C. and about 50° C. For this purpose, it may be understood that “cool combustion air” may be, for example and without limitation, combustion air between 15° C. and about 30° C. For this purpose, it may be understood that “cool recycled flue gas” may be, for example and without limitation, recycled flue gas between 20° C. and about 30° C. For this purpose, it may be understood that “warm CO₂” may be, for example and without limitation, CO₂ between 70° C. and about 90° C. For this purpose, it may be understood that “medium-hot CO₂” may be, for example and without limitation, CO₂ between 320° C. and about 360° C. for the generation of electricity. For this purpose, it may be understood that “medium-hot flue gas” may be, for example and without limitation, flue gas between 320° C. and about 360° C. for the generation of electricity. For this purpose, it may be understood that “medium-hot CO₂” may be, for example and without limitation, CO₂ between 350° C. and about 500° C. for manufacturing cement. For this purpose, it may be understood that “hot CO₂” may be, for example and without limitation, CO₂ between 800° C. and about 900° C. for manufacturing cement.

It will be appreciated that for the foregoing discussion, the terms “very-hot” and “highly-heated” are intended to mean the same thing. For this purpose, it may be understood that “very-hot CO₂” may be, for example and without limitation, CO₂ between about 650° C. and about 700° C. for the generation of electricity. It may be also understood that “very-hot flue gas” may be, for example and without limitation, flue gas between about 650° C. and about 700° C. for the generation of electricity. It may be also understood that “very-hot CO₂” may be, for example and without limitation, CO₂ between about 1450° C. and about 1550° C. for cement manufacturing. It may be also understood that “very-hot flue gas” may be, for example and without limitation, flue gas between about 1450° C. and about 1550° C. for cement manufacturing.

With regard to the terminology “high-purity” oxygen, it will be appreciated that the embodiments of the system 2000, 2000′ and 2000″ can tolerate less than pure O₂ or CO₂. This is principally an economic consideration that requires a technological-economic analysis as to how pure one wishes the oxygen to be. The question to be considered is if the incremental cost of obtaining even higher purity cost O₂ or CO₂ justifies the incremental benefits. So, the question of how pure the O₂ or CO₂ should be is one that preferably is addressed through a cost/benefit analysis for a particular implementation of the system 2000, 2000′ or 2000″. But with these considerations in mind, it is expected that in most implementations, the “high-purity” O₂ may be at least about 95% pure O₂ for acceptable system operation, but again, the exact value should be arrived at through a suitably detailed engineering and cost analysis.

It will be appreciated that for the foregoing discussion on cement manufacturing, “very-hot clinker” may be, for example and without limitation, clinker between about 1400° C. and about 1500° C. It will also be understood that “warm clinker” may be, for example and without limitation, clinker between about 90° C. and about 110° C.

It will also be understood that for the foregoing discussion on the boiler feedwater (BFW) loop, that “cool LP BFW” may be, for example and without limitation, low-pressure BFW between about 35° C. and about 50° C. It will also be understood that “cool HP BFW” may be, for example and without limitation, high-pressure BFW between about 35° C. and about 50° C. It will also be understood that “medium-hot HP BFW” may be, for example and without limitation, high-pressure BFW between about 200° C. and about 270° C. It will also be understood that “medium-hot HP brine may be, for example and without limitation, high-pressure brine between about 210° C. and about 280° C. It will also be understood that “medium-hot HP water” may be, for example and without limitation, high-pressure water between about 210° C. and about 280° C. It will also be understood that “high pressure BFW” corresponds to BFW at a pressure high enough to prevent the BFW from flashing to steam. It will also be understood that “hot HP steam” may be, for example and without limitation, high-pressure steam between about 600° C. and about 650° C. It will also be understood that “hot LP steam” may be, for example and without limitation, low-pressure steam between about 600° C. and about 650° C. It will also be understood that “warm exhaust steam” may be, for example and without limitation, steam between about 50° C. and about 210° C.

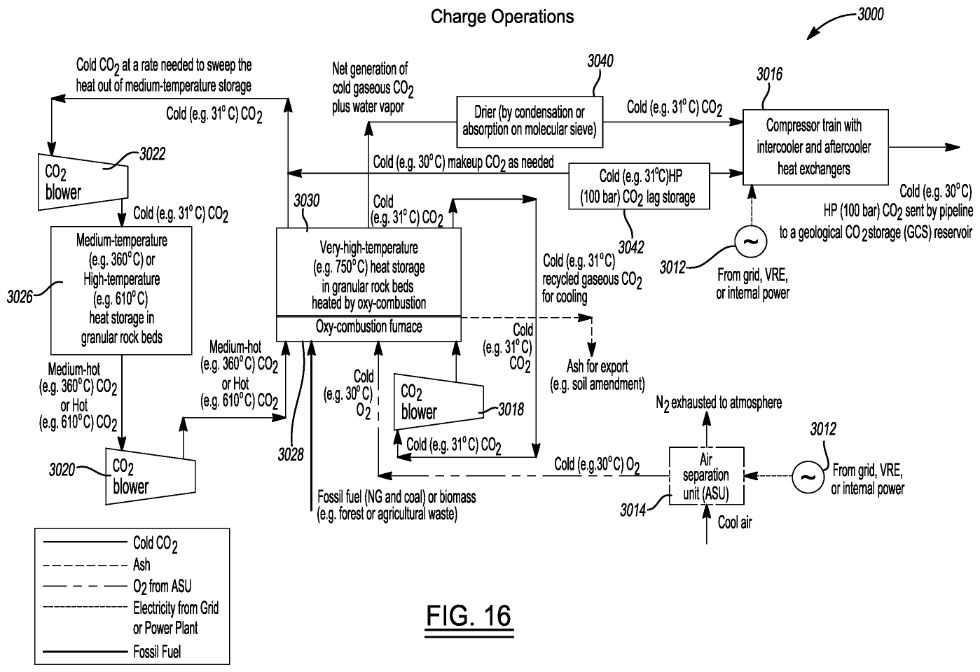

Referring now to FIGS. 16, 17, and 18, a system 3000 and method in accordance with another embodiment of the present disclosure will be discussed. The system 3000 of FIGS. 16, 17, and 18, rather than being applied to Rankine-cycle, steam turbines, makes use of Brayton-cycle turbines that use supercritical CO₂ (sCO₂) as the working fluid. Power cycles based on CO₂ as the working fluid have the potential to yield even higher thermal efficiencies at lower capital cost than state-of-the-art, steam-based, power cycles, such as those used in advanced, ultra-supercritical (AUSC) power plants. When CO₂ is held above its critical temperature and pressure, it acts like a gas, yet has the density of a liquid. In this supercritical state, small changes in temperature or pressure cause dramatic shifts in density, which results in sCO₂ being a highly efficient working fluid in generating power. It should be appreciated that while we refer to supercritical CO₂ as being the working fluid, at some points in the power cycle, it is possible that the either the temperature or the pressure, or both, could be below their corresponding critical values.

As with the previously disclosed embodiments and methods, the embodiment of FIGS. 16, 17, and 18 enables combustion heat to be time-shifted from when it is created to when it is needed to generate electricity. Excess electricity, such as from variable renewable energy (VRE) sources, can be time-shifted by directly using the excess electricity to power the infrastructure needed to generate power with near-zero CO₂ emissions with fossil fuel, or even with negative CO₂ emissions when using biomass as the fuel source. That infrastructure includes O₂ generators, such as air separation units (ASUs), which generate high-purity O₂ for oxy-combustion, and compressors used to compress gaseous CO₂ to sCO₂ for pipeline transportation to a geologic CO₂ storage (GCS) site.

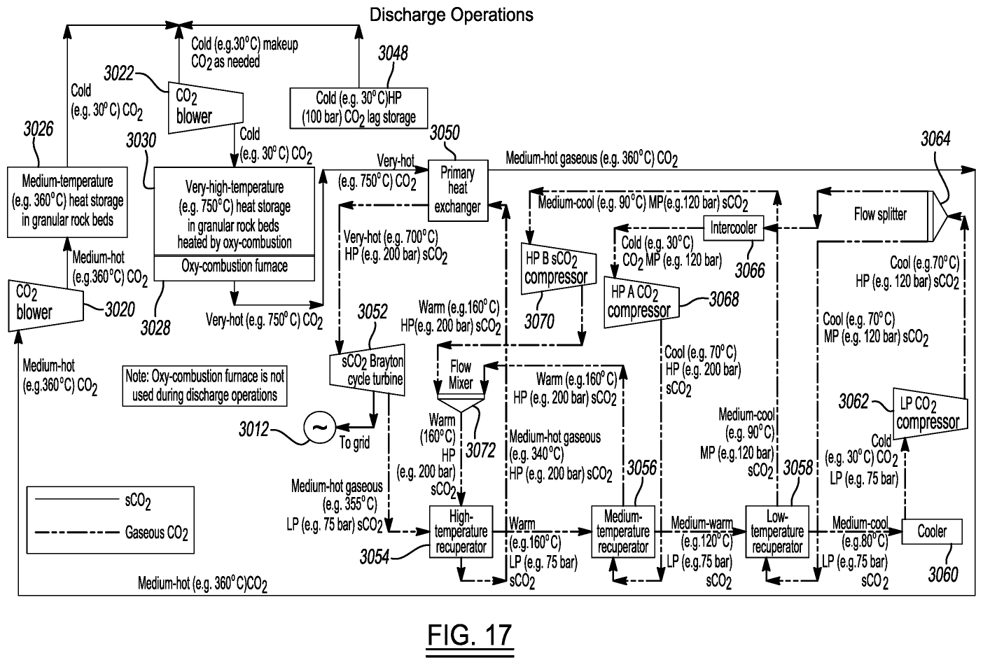

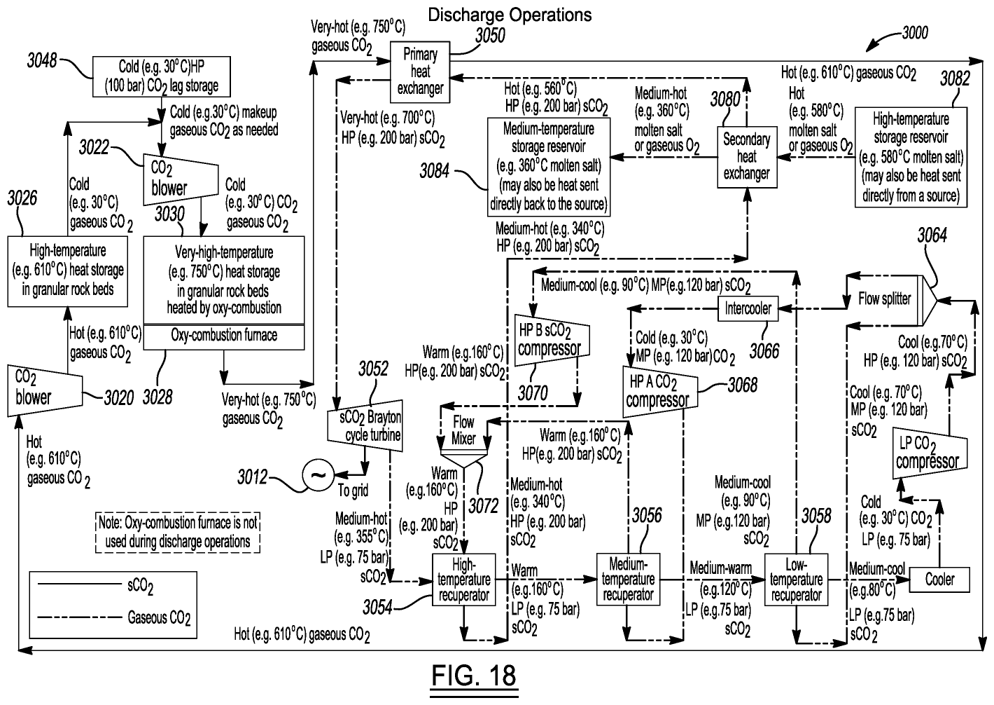

Oxy-combustion creates a mixture of very-hot CO₂ and steam, which is sent to heat granular rock beds in insulated vessels (FIG. 16) until most of the beds reach a target storage temperature. Although in the following description, reference is made to granular rock beds, it should be appreciated that the granular material may also be comprised of manufactured granular material, such as ceramic pebbles. The cooled mixture of CO₂ and water vapor leaving the beds is dried to yield high-purity CO₂, which is then compressed and sent by pipeline to a GCS reservoir. The embodiment of FIGS. 16, 17, and 18 avoids the capital and operating costs of post-combustion CO₂ capture. It also involves indirect heating of the power cycle. When power is needed, very-hot, high-purity, gaseous CO₂ is sent from storage to primary heat exchangers, where it heats sCO₂ that is sent to a Brayton-cycle turbine (to be discussed in connection with FIGS. 17 and 18). A heat-recuperation process, which may involve one or more heat recuperation stages, enables medium-hot, gaseous CO₂ to be sent back to storage. Increasing the number of heat recuperation stages reduces the temperature difference between the very-hot and medium-hot sCO₂, which improves thermal efficiency. Compared to an AUSC steam-turbine plant with a steam temperature of 700° C., this process can reduce fuel use and the quantity of CO₂ generated by up to about 24%, or possibly even more.

With reference to FIG. 16, the various components, and subsystems of the system 3000 are shown, which can be seen to be similar to system 2000 of FIG. 12. Components of the system 3000 in common with those of the system 2000 are denoted with reference numbers increased by 1000. The system 3000 in FIG. 16 includes the components used during a “charge” cycle of operation and includes a dryer subsystem 3040 formed in one example by a molecular sieve. The molecular sieve 3040 provides a drying action on received cold, gaseous CO₂, which includes water vapor which is created during the charge cycle of operation. The dryer subsystem 3040 outputs cold (e.g., about 31° C.) CO₂ for use by the compressor train 3016, and optionally also sent to a cool CO₂ lag storage structure 3042, which would typically consist of a high-pressure steel tank. The components shown in FIG. 16 thus may be understood as forming components of a “charge” subsystem for the system 3000.

FIG. 17 shows additional components used by the system 3000 during the discharge cycle of operation for the case of one-stage heating of sCO₂. These components include one or more primary heat exchangers 3050, which receive very-hot (e.g., 750° C.) gaseous CO₂ from the one or more very-high-temperature, insulated heat-storage vessel(s) 3030, which are filled with granular rock beds. The one or more primary heat exchangers 3050 also receive medium-hot, high-pressure (e.g., 340° C. at 200 bar) sCO₂ from the one or more high-temperature recuperators 3054. This heat-transfer process provides very-hot, high-pressure (e.g., 700° C. at 200 bar) sCO₂ as an input to one or more sCO₂ Brayton-cycle turbines 3052. The one or more sCO₂ Brayton-cycle turbines 3052 provide an output to the AC power grid 3012, and also produce an output of medium-hot, low-pressure (e.g., 355° C. at 75 bar) sCO₂, which is directed to an input of one or more high-temperature recuperators 3054, which are heat exchangers used to recover otherwise wasted heat. The one or more high-temperature recuperators generate a first quantity of warm, low-pressure sCO₂ (e.g., 160° C. at 75 bar) output that is directed to an input of one or more medium-temperature recuperators 3056, which are heat exchangers used to recover otherwise wasted heat. A second quantity of medium-hot, high-pressure (e.g., 340° C. at 200 bar) sCO₂ is directed to an input of the one or more primary heat exchangers 3050.

The one or more medium-temperature recuperators 3056 similarly provide a first quantity of medium-warm, low-pressure (e.g., 120° C. at 75 bar) sCO₂ to one or more low-temperature recuperators 3058. The one or more low-temperature recuperators produce a quantity of medium cool, low-pressure (e.g., 80° C. at 75 bar) sCO₂ which is output to one or more cooler subsystems 3060.

It should be appreciated that three recuperation stages may not be required for the System 3000 and that two recuperation stages (high- and low-temperature) may be sufficient. It may even be possible that only one recuperation stage could be used, but that may waste too much heat to be useful.

With further reference to FIG. 17, the one or more cooler subsystems 3060 provide a cold, low-pressure (e.g., 30° C. at 75 bar) CO₂ output to an input of one or more low-pressure CO₂ compressor(s) 3062. The one or more low-pressure CO₂ compressor(s) 3062 provide cool, medium pressure (e.g., 70° C. at 120 bar) sCO₂ to one or more flow splitters 3064. The one or more flow splitters 3064 provide a first output quantity of the cool, medium-pressure (e.g., 70° C. at 120 bar) sCO₂ to one or more intercoolers 3066, and a second to an input of the one or more low-temperature recuperators 3058. The one or more intercoolers 3066 provide an output of cold, medium-pressure (e.g., 30° C. at 120 bar) CO₂ to an input to one or more first (labeled HP A CO₂ compressor) high-pressure CO₂ compressor(s) 3068, which in turn provide an output of cool, high-pressure sCO₂ (e.g., 70° C. at 200 bar) to an input of the one or more medium-temperature recuperators 3056. One or more second (labeled “HP B sCO₂ Compressor”) high-pressure sCO₂ compressor(s) 3070 is/are used to receive on an input thereof a second quantity of medium-cool, medium-pressure sCO₂ (e.g., 90° C. at 120 bar) output from the one or more low-temperature recuperators 3058. The one or more second high-pressure sCO₂ compressor(s) 3070 provide a first output quantity of warm, high-pressure sCO₂ (e.g., 160° C. at 200 bar) to a first input of one or more flow mixers 3072. A second input of the one or more flow mixers 3072 receives a quantity of warm, high-pressure sCO₂ (e.g., 160° C. at 200 bar) from the one or more medium-temperature recuperators 3056. The one or more flow mixers 3072 provide an output of warm, high-pressure (e.g., 160° C. at 200 bar) sCO₂ back to an input of the one or more high-temperature recuperators 3054. The components 3050-3072 may be viewed as forming a “discharge” subsystem of the system 3000. Components 3054-3072 may also be viewed as forming a “recuperator” subsystem portion of the discharge subsystem.

FIG. 18 shows additional components used by the system 3000 during the discharge cycle of operation for the case of two-stage heating of sCO₂. It should be pointed out that these components are the same as those for FIG. 17, with the addition of three components: (1) one or more secondary heat exchanger(s) 3080, which are used to pre-heat medium-hot high-pressure (e.g., 340° C. at 200 bar) sCO₂, which results in an output of hot high-pressure (e.g., 560° C. at 200 bar) sCO₂ that is then sent to the primary heat exchangers, (2) one or more high-temperature (e.g., 580° C.) storage reservoir(s) 3082, and (3) one or more medium-temperature (e.g., 360° C.) storage reservoir(s) 3084. The heat stored in the one or more high-temperature storage reservoir(s) 3082 may have been derived from renewable heat from solar thermal energy (STE) collectors or it may have been derived from nuclear energy. The one or more secondary heat exchanger(s) 3080 may also directly receive high-temperature (e.g., 580° C.) heat-transfer fluid from a heat source, including a solar thermal energy (STE) facility, with medium-temperature (e.g., 360° C.) heat-transfer fluid being returned directly back to that heat source, which could be a STE facility. The use of these three components by the system 3000 is described in greater detail later in this disclosure.

### Charge Operation

Referring further to FIG. 16, a charge operation of the system 3000 will now be described. Initially, electricity, including excess electricity from the power grid 3012, and/or electricity from variable renewable energy (VRE) sources, and/or nuclear energy, and/or excess electricity from the power plant itself, is used to power one or more of the air separation units (ASUs) 3014 and the one or more compressor trains 3016 (containing one or more compressor(s), followed by intercooler and aftercooler heat exchangers). The one or more ASUs 3014, or other form of oxygen-generation devices, are used to obtain high-purity (e.g., 95%-99%) O₂ from air. It should be appreciated that other forms of oxygen-generation devices could include those that involve the electrolysis of water, which use electricity to decompose water into pure oxygen gas and pure hydrogen gas. For the rest of this charge operation description, O₂-generation devices will be referred to simply as the ASUs 3014. Cold (e.g., 30° C.), high-purity (e.g., 95%-99%) O₂ from the one or more ASUs 3014, the fuel of choice, and enough cold CO₂ (e.g., 31° C.) for temperature modulation are sent to the one or more oxy-combustion furnaces 3028.

Cool (e.g., 30° C.), high-purity (e.g., 95%-99%) O₂ from the one or more ASU(s) 3014, may be mixed with medium-hot (e.g., 360° C.) CO₂ from the one or more insulated, medium-temperature heat-storage vessel(s) 3026, and also with an additional fuel of choice (e.g., natural gas, coal, coke, petroleum, petroleum coke, tires, solid waste, or biomass, or a combination thereof.) It should be appreciated that mixing medium-hot (e.g., 360° C.) CO₂ with cool (e.g., 30° C.), high-purity (e.g., 95%-99%) O₂ and the fuel of choice reduces the amount of fuel required to attain the target temperature (e.g., 750° C.).

The fuel of choice is combusted in cool (e.g., 30° C.) high-purity (e.g., 95%-99%) O₂ inside the one or more oxy-combustion furnace(s) 3028 to generate very-hot (e.g., 750° C.), high-purity (e.g., 95%-99%) gaseous CO₂ and a small quantity of steam. Very-hot (e.g., 750° C.), high-purity (e.g., 95%-99%) gaseous CO₂ created in the one or more oxy-combustion furnace(s) 3028 is sent to the one or more insulated, very-high-temperature vessel(s) 3030 to heat the one or more granular rock beds contained therein.

Combusting fossil fuel or biomass in high-purity O₂ creates a high flame temperature. To maintain a target combustion temperature (e.g., 750° C.), additional cold (e.g., 31° C.) gaseous CO₂ is recirculated through the one or more granular rock beds inside the one or more very-high-temperature vessel(s) 3030 with the assistance of the one or more CO₂ blower(s) 3018 and/or 3020. Recirculation of CO₂ also helps to evenly distribute heat in the one or more granular rock beds.

The one or more granular rock beds are not fully heated during thermal-charging operations. Heating continues until most (e.g., 90%) of the one or more granular rock beds has been heated to the target, storage temperature (e.g., 750° C.), which places the thermal front within 10% of the cold end of the one or more granular rock beds. This assures that the downstream portion (e.g., 10%) of the granular rock beds remains relatively unheated, so gaseous CO₂ that exits the one or more granular rock beds is cold (e.g., 31° C.), thereby limiting the loss of heat, as gaseous CO₂ is sent to the one or more compressor trains 3016. Note that this temperature is preferably chosen to be just above the dew point of the CO₂/steam mixture, which is a function of the fuel used, along with the stoichiometry of the input fuel/oxidant mixture. This prevents condensation and moisture buildup in the one or more granular rock beds within the one or more very-high-temperature heat storage vessel(s) 3030.

The cold (e.g., 31° C.) mixture of gaseous CO₂ and water vapor, which is just above its dew point, leaves the downstream portion of the one or more granular rock beds within the one or more very-high-temperature heat storage vessel(s) 3030. The portion of the cold (e.g., 31° C.) CO₂ that was generated by oxy-combustion is sent to the dryer 3040. The dryer 3040 separates the water vapor from the CO₂ by condensation or by adsorption on to a suitable medium, such as a molecular sieve. The cold (e.g., 31° C.) dry CO₂ is then sent to the one or more compressor trains 3016 to produce high-pressure (e.g., 100 bar) CO₂ suitable for transportation in a pipeline to a GCS site.

With the assistance of one or more CO₂ blower(s) 3022, the portion of the cold (e.g., 31° C.) CO₂ leaving the one or more insulated, very-high-temperature heat-storage vessel(s) 3030 that was not generated by oxy-combustion is sent to the cold end of the one or more insulated, medium-temperature (360° C.) heat-storage vessel(s) 3026, where it cools the granular rock beds contained therein. This process drives medium-hot (360° C.) CO₂ out of the hot end of the one or more insulated, medium-temperature (360° C.) heat-storage vessel(s), which, with the assistance of one or more CO₂ blower(s) 3020, is sent to the one or more oxy-combustion furnaces 3028, as described earlier. This process prepares the one or more insulated, medium-temperature (360° C.) heat-storage vessel(s) 3026 to receive medium-hot (360° C.) CO₂ during the following discharge operation.

It should be appreciated that the one or more insulated, medium-temperature (e.g., 360° C.) storage vessels 3026 pertain to the case of one-stage heating of sCO₂, shown in FIG. 17. For the case of two-stage heating of sCO₂, shown in FIG. 18, hot (e.g., 610° C.) gaseous CO₂ will leave the one or more primary heat exchanger(s) 3050 during the discharge operation. In that case, the one or more insulated medium-temperature (e.g., 360° C.) storage vessel(s) 3026 operate at a higher temperature (e.g., 610° C.) because they receive hot (e.g., 610° C.) gaseous CO₂ from the one or more primary heaters. For that case, during charge operations, hot (e.g., 610° C.) gaseous CO₂ will be sent to the one or more oxy-combustion furnace(s), where it is mixed with cool (e.g., 30° C.), high-purity (e.g., 95%-99%) O₂ and the fuel of choice.

### Discharge Operation

Referring again to FIG. 17, the process flow description for the discharge operation of the system 3000 for one-stage heating of sCO₂ will now be provided. Note that this description is shown for a specific sCO₂ Brayton-cycle process, involving three heat-recuperation stages. There are similar sCO₂ Brayton-cycle processes, such as with two recuperation stages, for which the present system and method, using a process of indirect heating with gaseous CO₂, is equally applicable to. An important distinction is that the sCO₂ loop in the Brayton-cycle process operates between a very-hot (e.g., 750° C.) sCO₂ temperature and a medium-hot (e.g., 360° C.) sCO₂ temperature.

The high-grade, thermal-discharge process may typically involve using the one or more insulated, medium-temperature and very-high-temperature heat storage vessel(s) 3026 and 3030, respectively, which as described above are each filled with one or more granular rock beds. These vessels 3026 and 3030 may be operated in parallel to allow the closed-loop recirculation of very-hot (e.g., 750° C.) gaseous CO₂ to medium-hot (e.g., 360° C.) gaseous CO₂ to continuously operate during discharge operations. This makes it possible for medium-hot (e.g., 360° C.) gaseous CO₂ to always be returned to at least one of the insulated, medium-temperature vessels 3026 containing the one or more granular rock beds.

With the assistance of the one or more of the CO₂ blower(s) 3022, the thermal-discharge process begins with cold (e.g., 30° C.) gaseous CO₂ from the cold end of the one or more insulated, medium-temperature vessel(s) 3026, containing the one or more granular rock beds, being blown into the cold end of the one or more insulated, very-high-temperature vessel(s) 3030, containing the one or more granular rock beds. Because this is a closed-loop process, the one or more granular rock beds contained in the one or more insulated, medium-temperature vessel(s) 3026 have already been cooled during the charge cycle. Cold (e.g., 31° C.) gaseous CO₂ that had left the one or more insulated, very-high-temperature vessel(s) 3030 had cooled the one or more medium-temperature vessel(s) 3026 to prepare it for the discharge cycle.

Cold (e.g., 30° C.) gaseous CO₂ flows from the cool end to the hot end of the one or more insulated, very-high-temperature vessel(s) 3030, where it is heated by the one or more granular rock beds contained therein, to become very-hot (e.g., 750° C.) gaseous CO₂, which leaves the hot end of the one or more insulated, very-high-temperature vessel(s) 3030.

With the assistance of the one or more CO₂ blower(s) 3022, cold (e.g., 30° C.), gaseous CO₂ continues to be blown into the cool end of the one or more insulated, very-high-temperature vessel(s) 3030, where it is heated by the very hot granular rock beds contained therein. This process displaces very hot (e.g., 750° C.) gaseous CO₂ out of the hot end of the one or more insulated, very-high-temperature vessel(s) 3030 until only a relatively small percentage (e.g., 10%) of the one or more granular rock beds contained therein remains at the target, high-grade temperature (e.g., 750° C.).

Very hot (e.g., 750° C.) gaseous CO₂ that leaves the one or more insulated, very-high-temperature vessel(s) 3030, which contain the one or more granular rock beds, is sent to the one or more primary heat exchanger(s) 3050. This heat-transfer process causes the very-hot (e.g., 75° C.) gaseous CO₂ to become medium-hot (e.g., 360° C.) gaseous CO₂. This process also transfers heat to the medium-hot, high-pressure (e.g., 340° C. at 200 bar) sCO₂, which has left the one or more high-temperature recuperators 3054, causing it to become very-hot, high-pressure (e.g., 700° C. at 200 bar) sCO₂, which is sent to the one or more sCO₂ Brayton-cycle turbines 3052.

Very-hot, high-pressure (e.g., 700° C. at 200 bar) sCO₂ enters the one or more sCO₂ Brayton-cycle turbines 3052 where it is used to generate electricity for the grid 3012. This process creates medium-hot, low-pressure (e.g., 355° C. at 75 bar) sCO₂ that exits the one or more sCO₂ Brayton-cycle turbines 3052, which is then sent to the one or more high-temperature recuperators 3054.

Medium-hot, low-pressure (e.g., 355° C. at 75 bar) sCO₂ is sent from the one or more Brayton-cycle turbines 3052 to the one or more high-temperature recuperators 3054, which transfer heat from the medium-hot, low-pressure (e.g., 355° C. at 75 bar) sCO₂ to the warm, high-pressure (e.g., 160° C. at 200 bar) sCO₂ that has left the one or more flow mixers 3072. The warm, high-pressure (e.g., 160° C. at 200 bar) sCO₂ is heated to become medium-hot, high-pressure (e.g., 340° C. at 200 bar) sCO₂, which is sent to the one or more primary heat exchanger(s) 3050. This process also cools the medium-hot, low-pressure (e.g., 355° C. at 75 bar) sCO₂ to become warm, low-pressure (e.g., 160° C. at 75 bar) sCO₂, which is sent to the one or more medium-temperature recuperators 3056 if a three-stage recuperation process is being used (as shown in FIG. 17). If a two-stage recuperation process is used, the warm, low-pressure (e.g., 160° C. at 75 bar) sCO₂ is sent directly to the one or more low-temperature recuperators 3058. However, the following description will be directed to the use of the three-stage recuperation system (recuperators 3054, 3056 and 3058) shown in FIG. 17.

Warm, low-pressure (e.g., 160° C. at 75 bar) sCO₂ that leaves the one or more high-temperature recuperators 3054 is sent to the one or more medium-temperature recuperators 3056, which transfer heat from the warm, low-pressure (e.g., 160° C. at 75 bar) sCO₂ to the cool, high-pressure (e.g., 70° C. at 200 bar) sCO₂ that has left the one or more first high-pressure sCO₂ compressor(s) 3068. The cool, high-pressure (e.g., 70° C. at 200 bar) sCO₂ is heated to become warm, high-pressure (e.g., 160° C. at 200 bar) sCO₂, which is sent to the one or more flow mixers 3072. This process cools the warm, low-pressure (e.g., 160° C. at 75 bar) sCO₂ to become medium-warm, low-pressure (e.g., 120° C. at 75 bar) sCO₂, which is sent to the one or more low-temperature recuperators 3058.

Medium-warm, low-pressure (e.g., 120° C. at 75 bar) sCO₂ that leaves the one or more medium-temperature recuperators 3056 is sent to the one or more low-temperature recuperators 3058. The one or more low-temperature recuperators 3058 transfer heat from the medium-warm, low-pressure (e.g., 120° C. at 75 bar) sCO₂ to the cool, medium-pressure (e.g., 70° C. at 120 bar) sCO₂ that has left the one or more flow splitters 3064. The cool, medium-pressure (e.g., 70° C. at 120 bar) sCO₂ is heated to become medium-cool, medium-pressure (e.g., 90° C. at 120 bar) sCO₂, which is sent to the one or more second high-pressure sCO₂ compressor(s) 3070. This process also causes the low-temperature recuperator 3058 to cool the medium-warm, low-pressure (e.g., 120° C. at 75 bar) sCO₂ to become medium-cool, low-pressure (e.g., 80° C. at 75 bar) sCO₂, which is then sent to the one or more coolers 3060.

Medium-cool, low-pressure (e.g., 80° C. at 75 bar) sCO₂ that leaves the one or more low-temperature recuperators 3058 is sent to the one or more coolers 3060, where the medium-cool, low-pressure (e.g., 80° C. at 75 bar) sCO₂ is cooled to become cold, low-pressure (e.g., 30° C. at 75 bar) CO₂, which is then sent to the one or more low-pressure CO₂ compressor(s) 3062.

The cold, low-pressure (e.g., 30° C. at 75 bar) CO₂ that leaves the one or more coolers 3060 is sent to the one or more low-pressure CO₂ compressor(s) 3062, where it becomes cool, medium-pressure (e.g., 70° C. at 120 bar) sCO₂, which is then sent to the one or more flow splitters 3064.

The cool, medium pressure (e.g., 70° C. at 120 bar) sCO₂ that leaves the one or more low-pressure sCO₂ compressor(s) 3062 is split into two streams by the one or more flow splitters 3064. One stream is sent to the one or more low-temperature recuperators 3058 where it is heated by medium-warm, low-pressure (e.g., 120° C. at 75 bar) sCO₂, which causes the cool, medium-pressure (e.g., 70° C. at 120 bar) sCO₂ to become medium-cool, medium-pressure (e.g., 90° C. at 120 bar) sCO₂, which is then sent to the one or more second high-pressure sCO₂ compressor(s) 3070. The other stream is sent to the one or more intercoolers 3066 where it is cooled to become cold, medium-pressure (e.g., 30° C. at 120 bar) CO₂, before being sent to the one or more first high-pressure CO₂ compressor(s) 3068.

Medium-cool, medium-pressure (e.g., 90° C. at 120 bar) sCO₂ that leaves the one or more low-temperature recuperators 3058 is sent to the one or more second high-pressure sCO₂ compressor(s) 3070, where it becomes warm, high-pressure (e.g., 160° C. at 200 bar) sCO₂, which is then sent to one or more flow mixers.

Cold, medium-pressure (e.g., 30° C. at 120 bar) CO₂ that leaves the one or more intercoolers is sent to the one or more HP “A” CO₂ compressor(s) 3068, where it becomes cool, high-pressure (e.g., 70° C. at 200 bar) sCO₂, before being sent to the one or more medium-temperature recuperators 3056.

Warm, high-pressure (e.g., 160° C. at 200 bar) sCO₂ that leaves the one or more second high-pressure sCO₂ compressor(s) 3070 is sent to the one or more flow mixers 3072.

Cool, high-pressure (e.g., 70° C. at 200 bar) sCO₂ that leaves the one or more first high-pressure CO₂ compressor(s) 3068 is sent to the one or more medium-temperature recuperators 3056, where it is heated by warm, low-pressure (e.g., 160° C. at 75 bar) sCO₂ to become warm, high-pressure (e.g., 160° C. at 200 bar) sCO₂, before being sent to the one or more flow mixers. As stated earlier, this process cools the warm, low-pressure (e.g., 160° C. at 75 bar) sCO₂, which has left the one or more high-temperature recuperators 3054, to become medium-warm, low-pressure (e.g., 120° C. at 75 bar) sCO₂. This sCO₂ is then sent to the one or more low-temperature recuperators 3058.

The two streams of warm, high-pressure (e.g., 160° C. at 200 bar) sCO₂ that enter the one or more flow mixers 3072 are combined into one stream of warm, high-pressure (e.g., 160° C. at 200 bar) sCO₂, which is then sent to the one or more high-temperature recuperators 3054.

The combined stream of warm, high-pressure (e.g., 160° C. at 200 bar) sCO₂ enters the one or more high temperature recuperators 3054 where it is heated by medium-hot, low-pressure (e.g., 355° C. at 75 bar) sCO₂ that has left the one or more sCO₂ Brayton-cycle turbines 3052. This process causes the warm, high-pressure (e.g., 160° C. at 200 bar) sCO₂ to become medium-hot, high-pressure (e.g., 340° C. at 200 bar) sCO₂, which is sent to the one or more primary heat exchanger(s) 3050, thereby completing the sCO₂ loop for the one-stage sCO₂-heating process.

Referring to FIG. 18, the process flow description for the discharge operation of the system 3000 for two-stage heating of sCO₂ will now be provided. It should be noted that the process described above for the one-stage sCO₂-heating process also applies to the two-stage sCO₂-heating process, with the minor exception of the source of the high-pressure (e.g., 200 bar) sCO₂ feeding the one or more primary heat exchanger(s) 3050. The sCO₂ loop for the two-stage sCO₂-heating process includes the use of one or more secondary heat exchanger(s) 3080, which function as pre-heaters that are used to pre-heat warm high-pressure (e.g., 340° C. at 200 bar) sCO₂ before that warm high-pressure sCO₂ enters the one or more primary heat exchanger(s) 3050 to become very-hot, high-pressure (e.g., 700° C. at 200 bar) sCO₂. The one or more secondary heat exchanger(s) 3080 are used to pre-heat the medium-hot high-pressure (e.g., 340° C. at 200 bar) sCO₂ to become hot high-pressure (e.g., 560° C. at 200 bar) sCO₂, before hot high-pressure sCO₂ is sent to the one or more primary heat exchanger(s) 3050 to become very-hot high-pressure (e.g., 700° C. at 200 bar) sCO₂. Because the description of the recuperation subsystem presented for the one-stage sCO₂-heating process also applies to two-stage heating of sCO₂, we do not repeat that description here.

Referring again to FIG. 18, a quantity of warm high-pressure (e.g., 340° C. at 200 bar) sCO₂ leaving the one or more high-temperature recuperators 3054 is sent to the one or more secondary heat exchanger(s) 3080.

A quantity of hot (e.g., 580° C.) heat-transfer fluid, such as hot molten salt or hot gaseous CO₂, leaves the one or more high-temperature (e.g., 580° C.) storage reservoir(s) 3082, which may be comprised of one or more high-temperature molten salt tanks or one or more insulated high-temperature storage vessel(s) that contain granular rock beds. The hot (e.g., 580° C.) heat-transfer fluid may have also been sent directly from a heat source, including a solar thermal energy (STE) facility or a nuclear power plant.

A quantity of hot (e.g., 580° C.) heat-transfer fluid, such as hot molten salt or hot gaseous CO₂, leaving the one or more high-temperature (580° C.) storage reservoir(s) 3082, is sent to the one or more secondary heat exchanger(s) 3080, where it is used to heat a quantity of warm high-pressure (e.g., 340° C. at 200 bar) sCO₂ leaving the one or more high-temperature recuperators 3054. This process results in a quantity of hot high-pressure (e.g., 560° C. at 200 bar) sCO₂ and a quantity of medium-hot (e.g., 360° C.) heat-transfer fluid, such as medium-hot molten salt or medium-hot gaseous CO₂.

A quantity of medium-hot (e.g., 360° C.) heat-transfer fluid, such as medium-hot molten salt or medium-hot gaseous CO₂, leaving the one or more secondary heat exchanger(s) 3080 is sent to the one or more medium-temperature (e.g., 360° C.) storage reservoir(s) 3084, which may be comprised of either one or more medium-temperature molten salt tanks or one or more insulated medium-temperature storage vessel(s) that contain granular rock beds. The medium-hot (e.g., 360° C.) heat-transfer fluid may also be sent directly back to the source of the hot (e.g., 580° C.) heat-transfer fluid, including a solar thermal energy (STE) facility or a nuclear power plant.

A quantity of hot, high-pressure (e.g., 560° C. at 200 bar) sCO₂ leaving the one or more secondary heat exchanger(s) 3080 is sent to the one or more primary heat exchanger(s). This process results in a quantity of very-hot hot high-pressure (e.g., 700° C. at 200 bar) sCO₂ and a quantity of hot (e.g., 610° C.) gaseous CO₂.

With the assistance of one or more CO₂ blower(s) 3020, a quantity of hot (e.g., 610° C.) gaseous CO₂ leaving the one or more primary heat exchanger(s) 3050 is sent to the one or more insulated high-temperature (e.g., 610° C.) storage vessel(s) that are filled with granular rock beds, which have been cooled during the previous charge operation, as described earlier in this disclosure.

A quantity of hot (e.g., 610° C.) gaseous CO₂ transfers its heat to the granular rock beds contained within the one or more insulated high-temperature (e.g., 610° C.) storage vessel(s) 3026. This process results in cool (e.g., 30° C.) gaseous CO₂ that leaves the cool end of the one or more insulated high-temperature (e.g., 61° C.) storage vessel(s) 3026 that are filled with granular rock beds.

With the assistance of one or more CO₂ blower(s) 3022, a quantity of cold (e.g., 30° C.) gaseous CO₂ is sent to the one or more insulated very-high-temperature (e.g., 750° C.) storage vessel(s) 3030 that contain granular rock beds. This completes the sCO₂ loop for the two-stage sCO₂-heating process.

It will be appreciated that all the temperatures and pressures mentioned throughout the present disclosure are approximate and used for the purpose of illustrating and explaining operation of the various embodiments described herein. It is, of course, possible to use different combinations of temperature and pressure to suit the needs of a specific application.

The compact size of sCO₂ turbines enables deployment over a wide range of scales: from micro-grid-scale (1-10 MWe) power plants to large, utility-scale, (50-500 MWe or more) power plants. When biomass is a potential fuel source, micro-grid-scale power plants can be distributed to be in closer proximity to those sources. Using two or more fuels at a power plant, including waste biomass stored on-site, plus pipeline-supplied natural gas, can increase its resiliency in withstanding a failure of fuel supply (FSS) scenario, such as might be caused by a power-grid cyber-attack. The systems and methods of the present disclosure may enable such power plants to continue to provide reliable power at critical facilities, such as data centers, hospitals, and military installations, which could prevent power failures in the local grid, regardless of the cause, from affecting those facilities.

### Systems and Methods for Producing Carbon-Neutral and Carbon-Negative Industrial Heat

The present disclosure also discloses new embodiments which use one or more of granular-media heat storage, pressurized hot-water storage in tanks, hot-oil storage in tanks, reservoir thermal energy storage (RTES), renewable heat, renewable and excess electricity, and combustion heat from the oxy-combustion of fossil fuel and/or biomass to generate carbon-neutral and carbon-negative electricity and industrial heat needed for manufacturing applications requiring significant amounts of heat. In one example the various embodiments disclosed herein may be tailored for cement manufacturing applications. The various embodiments discussed herein can be used to generate carbon-neutral or carbon-negative heat for a wide variety of additional manufacturing applications including, but not limited to, (1) clean hydrogen (H₂) production by steam methane reforming (SMR) and water-gas shift and (2) fractional distillation of crude oil. Granular-media heat storage to enable combustion heat and heat generated by electrical furnaces to be time-shifted from when it is created to when it is needed for industrial applications. As explained in the following discussion, granular media can include, without limitation, rock, crushed rock, mined aggregate, iron pore pellets or manufactured media, such as ceramic pebbles, ceramic blocks, and concrete blocks. A key advantage of the presently disclosed embodiments using an oxy-combustion approach (to be discussed in connection with FIG. 1) is that high-purity CO₂ is generated, which can be dried and compressed for transportation to a user of CO₂ or to a geological CO₂ sequestration (GCS) site without the use of post-combustion, CO₂-capture technology, such as amine-stripping. A key advantage of the hybrid-heating approach described herein is that renewable heat can replace a significant fraction of combustion heat and avoid CO₂ emissions by displacing fuel (FIGS. 2-5). The embodiments described herein also avoid CO₂ emissions by efficiently decarbonizing combustion.

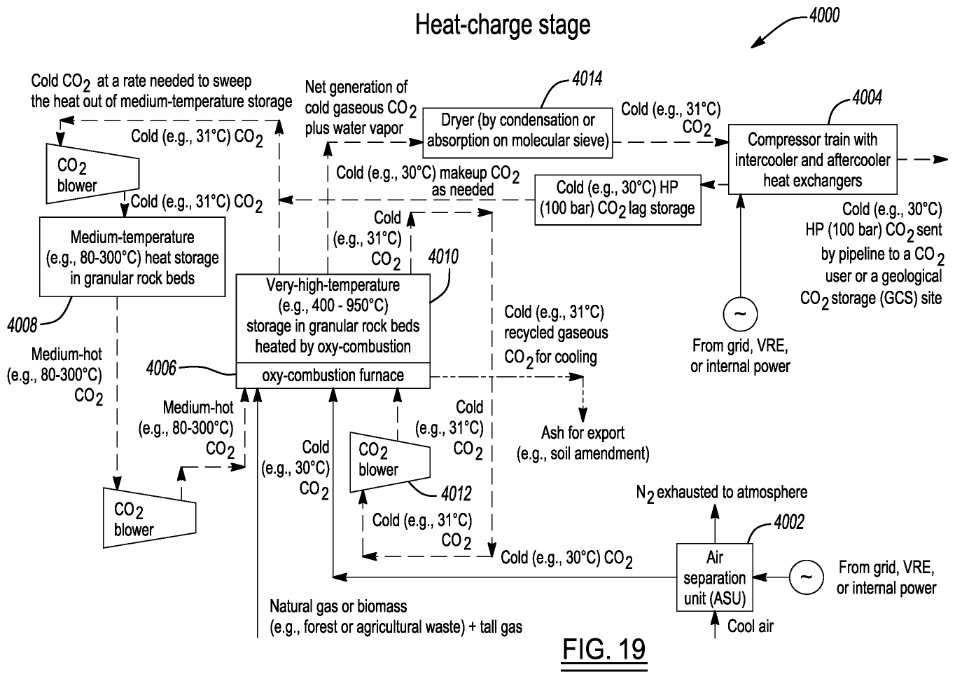

Referring to FIG. 19, the heat-charge stage will now be described with regard to a heat generating system 4000. Initially, electricity, including electricity from the power grid, which may include excess electricity from the power grid, and/or electricity from variable renewable energy (VRE) sources, and/or nuclear energy, and/or excess electricity from a power plant itself, is used to power one or more of the air separation units (ASUs) 4002 and one or more compressor train(s) 4004 (containing one or more compressors, followed by intercooler and aftercooler heat exchangers). The one or more ASUs 4002, or other form of oxygen-generation devices, are used to obtain high-purity (e.g., 95%-99%) O₂ from air. For the rest of this charge operation description, O₂-generation devices will be referred to simply as the “ASUs 4002”.

Cold (e.g., 30° C.), high-purity (e.g., 95%-99%) O₂ from the ASUs 4002, the fuel of choice, and enough cold CO₂ (e.g., 31° C.) for temperature modulation, are sent to one or more oxy-combustion furnace(s) 4006 (hereinafter simply “the oxy-combustion furnace 4006”). Cool (e.g., 30° C.), high-purity (e.g., 95%-99%) O₂ from the ASU(s) 4002 may be mixed with warm to medium-hot (e.g., 80-300° C.) CO₂ from one or more medium-temperature heat-storage vessels 4008 (hereinafter simply “medium-temperature heat storage vessel 4008”), and also with an additional fuel of choice (e.g., and without limitation, natural gas, coal, coke, petroleum, petroleum coke, tires, fuel oil, hydrogen, solid waste, or biomass, including agricultural waste, forest waste, municipal solid waste (MSW), or a combination thereof.) It should be appreciated that mixing warm to medium-hot (e.g., 80-300 CO₂) CO₂ with cool (e.g., 30° C.), high-purity (e.g., 95%-99%) O₂ and the fuel of choice reduces the amount of fuel required to attain the target temperature (e.g., 400-950° C.).

The fuel of choice is combusted in cool (e.g., 30° C.) high-purity (e.g., 95%-99%) O₂ inside the oxy-combustion furnace 4006 to generate very-hot (e.g., 400-950° C.), high-purity (e.g., 95%-99%) gaseous CO₂ and a small quantity of steam. Very-hot (e.g., 400-950° C.), high-purity (e.g., 95%-99%) gaseous CO₂ created in the oxy-combustion furnace 4006 is sent to one or more insulated, very-high-temperature vessel(s) 4010 (hereinafter simply “very-high-temperature vessel 4010”) to heat one or more granular-media bed(s) contained therein.

Combusting fossil fuel or biomass in high-purity O₂ creates a high flame temperature. To maintain a target combustion temperature (e.g., 400-950° C.), additional cold (e.g., 31° C.) gaseous CO₂ is recirculated through the one or more granular-media bed(s) inside the one or more very-high-temperature vessel(s) with the assistance of one or more CO₂ blower(s) 4012 (hereinafter simply “CO₂ blower 4012”). Recirculation of CO₂ also helps to evenly distribute heat in the one or more granular-media bed(s).

It will be understood that the one or more granular-media bed(s) are most typically not fully heated during the heat-charge stage. Heating continues until most (e.g., 90%) of the one or more granular-media bed(s) has been heated to the target, storage temperature (e.g., 400-950° C.), which places the thermal front within 10% of the cold end of the one or more granular-media bed(s). This assures that the downstream portion (e.g., 10%) of the granular-media beds remains relatively unheated, so gaseous CO₂ that exits the one or more granular-media bed(s) is cold (e.g., 31° C.), thereby limiting the loss of heat, as gaseous CO₂ is sent to the compressor train 4004. Note that this temperature is preferably chosen to be just above the dew point of the CO₂/steam mixture, which is a function of the fuel used, along with the stoichiometry of the input fuel/oxidant mixture. This prevents condensation and moisture buildup in the one or more granular-media bed(s) within the very-high-temperature heat storage vessel 4010.

The cold (e.g., 31° C.) mixture of gaseous CO₂ and water vapor, which is just above its dew point, then leaves the downstream portion of the one or more granular-media bed(s) within the very-high-temperature heat storage vessel 4010. The portion of the cold (e.g., 31° C.) CO₂ that was generated by oxy-combustion is sent to one or more dryer(s) 4014 (hereinafter simply “dryer 4014”). The dryer 4014 separates the water vapor from the CO₂ by condensation or by adsorption on to a suitable medium, such as a molecular sieve. The cold (e.g., 31° C.) dry CO₂ is then sent to the compressor train 4004 to produce high-pressure (e.g., 100 bar) CO₂ suitable for transportation by truck or in a pipeline to CO₂ users or to a GCS site.

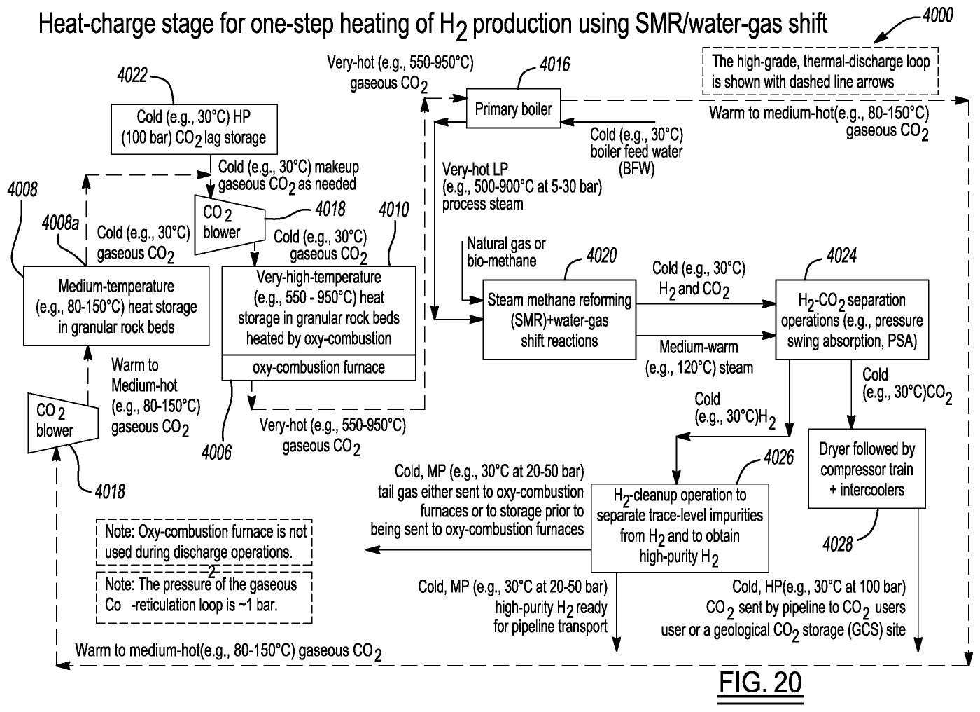

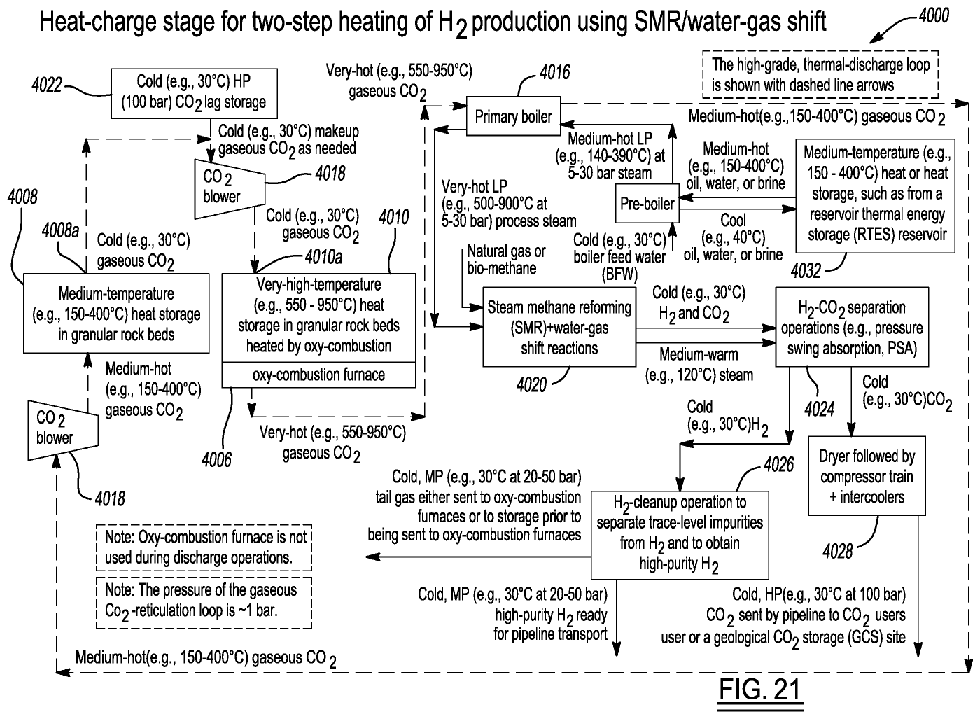

Referring now to FIGS. 20 and 21, a heat-discharge stage will now be described for clean H₂ production using steam methane reforming (SMR) and water-gas shift, using the system 4000. It will be appreciated that the system 4000 includes several additional subsystems for carrying out the heat-discharge stage, and those additional subsystems will now be described. It will also be appreciated that the heat-discharge stage can involve either a one step or two step heating process. The two step heating process can be applied when either waste heat or renewable heat, such as from geothermal or solar thermal energy (STE), is available to heat boiler feedwater (BFW) in one or more pre-boiler(s) 4030 (hereinafter simply “pre-boiler” 4030). The steam leaving pre-boiler 4030 is sent to one or more primary boiler(s) 4016 (hereinafter simply “primary boiler 4016”) that boost the temperature of the steam. The one-step process applies either to the case where one or more pre-boilers 4030 are not present or when one or more pre-boilers are not in operation because waste or renewable heat is not available. The following description applies to the one-step, heating process (FIG. 20).

The heat-discharge stage may typically involve using the medium-temperature and very-high-temperature heat storage vessels 4008 and 4010, respectively, which as described earlier are each filled with one or more granular-media bed(s). These vessels may be operated in parallel to allow the closed-loop recirculation of very-hot (e.g., 550-950° C.) gaseous CO₂ to warm to medium-hot (e.g., 80-150° C.) gaseous CO₂ to continuously operate during the heat-discharge stage. This makes it possible for warm to medium-hot (e.g., 80-150° C.) gaseous CO₂ to always be returned to medium-temperature vessel 4008 containing the one or more granular-media bed(s). The returned heat is used to reduce fuel consumption during the heat-charge stage.

With the assistance of one or more of the CO₂ blower(s) 4018 (hereinafter simply “CO₂ blowers 4018”), the heat-discharge stage begins with a first quantity of cold (e.g., 31° C.) gaseous CO₂ from a cold end 4008a of the medium-temperature vessel 4008, containing the one or more granular-media bed(s), being blown into a cold end 4010a of the very-high-temperature vessel 4010 containing the one or more granular-media bed(s). Because this is a closed-loop process, the one or more granular-media bed(s) contained in the medium-temperature vessel 4008 have already been cooled during the heat-charge stage. Cold (e.g., 31° C.) gaseous CO₂ that had left the very-high-temperature vessel 4010 had cooled the medium-temperature vessel 4008 to prepare it for the heat-discharge stage.

The first quantity of cold (e.g., 31° C.) gaseous CO₂ flows from the cool end 4010a to a hot end 4010b of the very-high-temperature vessel 4010, where it is heated by the one or more granular-media bed(s) contained therein, to become a second quantity of very-hot (e.g., 550-950° C.) gaseous CO₂. This very-hot gaseous CO₂ leaves the hot end 4010b of the very-high-temperature vessel 4010.

With the assistance of the CO₂ blowers 4018, a first quantity of cold (e.g., 31° C.) gaseous CO₂ continues to be blown into the cool end 4010b of the very-high-temperature vessel 4010, where it is heated by the very hot granular-media beds contained therein. This process displaces the second quantity of very hot (e.g., 550-950° C.) gaseous CO₂ out of the hot end 4010b of the very-high-temperature vessel 4010 until only a relatively small percentage (e.g., 10%) of the one or more granular-media bed(s) contained therein remains at the target, high-grade temperature (e.g., 550-950° C.).

The second quantity of very hot (e.g., 550-950° C.) gaseous CO₂ leaving the very-high-temperature vessel 4010, which contains the one or more granular-media bed(s), and a third quantity of cold (e.g., 30° C.) boiler feedwater, are sent to the primary boiler 4016. This process creates a fourth quantity of very-hot, low-pressure steam (e.g., 500-900° C. at a pressure of 5-30 bar) and a fifth quantity of warm to medium-hot (e.g., 80-150° C.) gaseous CO₂. The fourth quantity of very-hot, low-pressure (e.g., 500-900° C. at a pressure of 5-30 bar) steam is sent to one or more steam hydrocarbon (e.g., methane) reformer(s) 4020 (hereinafter simply “hydrocarbon reformer 4020”). The fifth quantity of warm to medium-hot (e.g., 80-150° C.) gaseous CO₂ is sent to the medium-temperature heat-storage vessel 4008.

A sixth quantity consisting of at least one of natural gas/CH4, bio-methane, or some other suitable hydrocarbon and a fourth quantity of very-hot, low-pressure (e.g., 500-900° C. at a pressure of 5-30 bar) steam is fed to the steam hydrocarbon reformer 4020 where, in the presence of a catalyst, it reacts to produce a seventh quantity, consisting of a mixture of hot, low-pressure (e.g., 500-900° C. at a pressure of 5-30 bar) steam, H₂, CO, and CO₂. It shall be appreciated that this mixture goes through a series of water-gas shift reactions.

The description of the SMR/water-gas shift and H₂-CO₂ separation processes is the same as for the two-step, heating process, which is given below. The following description applies to the two-step, heating process, for which reference is made to FIG. 21. The first four operations described above for the one-step. heating process described above apply here as well. A first quantity of medium-hot (e.g., 150-400° C.) heat-transfer fluid, which can comprise at least one of oil, water, or brine, is sent from the medium-temperature heat or heat storage 4032 (hereinafter “medium-temperature heat or heat storage 4032”) to the pre-boiler 4030, where it heats a second quantity of cold (e.g., 30° C.) boiler feedwater to create a third quantity of hot, low-pressure (e.g., 140-390° C. at a pressure of 5-30 bar) steam and a fourth quantity of cool (e.g., 40° C.) heat-transfer fluid, which can comprise at least one of oil, water, or brine. The third quantity of hot, low-pressure steam (e.g., 140-390° C. at a pressure of 5-30 bar) is sent to the primary boiler 4016. The fourth quantity of cool (e.g., 40° C.) heat-transfer fluid, which can comprise at least one of oil, water, or brine, is sent to at least one of one or more cool storage reservoir(s) 4022 (hereinafter simply “cool storage reservoir 4022”) or the medium-temperature heat or heat storage 4032. The third quantity of hot, low-pressure steam (e.g., 140-390° C. at a pressure of 5-30 bar) leaving the pre-boiler 4030 is sent to the primary boiler 4016, along with a fifth quantity of very hot (e.g., 550-950° C.) gaseous CO₂ that leaves the very-high-temperature vessel 4010, which contains the one or more granular-media bed(s). This third quantity of hot, low-pressure steam is sent to the primary boiler 4016 to form a sixth quantity of very-hot, low-pressure (e.g., 500-900° C. at a pressure of 5-30 bar) steam and a seventh quantity of medium-hot (e.g., 150-400° C.) gaseous CO₂. The seventh quantity of medium-hot (e.g., 150-400° C.) gaseous CO₂ is sent to the medium-temperature storage vessel 4008, where it heats the one or more granular-media bed(s) contained therein and forms the eighth quantity of cold (e.g., 31° C.) CO₂. This cold quantity of CO₂ is then sent to the high-temperature (e.g., 550-950° C.) heat-storage vessel 4010, which completes the gaseous CO₂-recirculation loop. Note that this temperature, for example, 31° C., is preferably chosen to be just above the dew point of the CO₂/steam mixture.

A ninth quantity consisting of at least one of natural gas/CH4, bio-methane, or some other suitable hydrocarbon and a sixth quantity of very-hot, low-pressure (e.g., 500-900° C. at a pressure of 5-30 bar) steam are fed to the steam hydrocarbon reformer 4020 where, in the presence of a catalyst, they react to produce a tenth quantity consisting of a mixture of hot, low-pressure (e.g., 500-900° C. at a pressure of 5-30 bar) steam, H₂, CO, and CO₂. It shall be appreciated that this mixture goes through a series of SMR/water-gas shift reactions. The following description applies to both the one-step, heating process (FIG. 20) and the two-step, heating process (FIG. 21). 1. A first quantity consisting of a mixture of cold, low-pressure (e.g., 30° C. at a pressure of 5-30 bar) H₂ and CO₂ leaving the SMR/water-gas shift reactor 4020, is sent to at least one of H₂-CO₂ separation subsystem 4024 for performing H₂-CO₂ separation operation(s). These H₂-CO₂ separation operations include at least one of one or more amine-stripping method(s), one or more membrane-separation method(s), one or more pressure swing adsorption (PSA) method(s), or any other method suitable for separating H₂ from CO₂. A second quantity consisting of a mixture of cold (e.g., 30° C.) H₂ and trace levels of impurities that leaves the H₂-CO₂ separation subsystem 4024 is sent to one or more H₂-cleanup subsystems 4026 (hereinafter simply H₂-cleanup subsystem 4026″) to perform one or more H₂ cleanup operation(s). These H₂ cleanup operations separate the trace-level impurities from H₂ to generate a third quantity of cold, medium-pressure, (e.g., 30° C. at a pressure of 20-50 bar) high-purity H₂ and a fourth quantity of cold, medium-pressure (e.g., 30° C. at a pressure of 20-50 bar) tail gas. The H₂ cleanup subsystem 4026 uses one or more H₂-cleanup operation(s) involving at least one of the one or more membrane-separation method(s), the one or more pressure swing adsorption (PSA) method(s), or any other method suitable for separating trace-level impurities from H₂. The third quantity of cold, medium-pressure (e.g., 30° C. at a pressure of 20-50 bar) high-purity H₂ is ready for at least one of truck or pipeline transport to users of H₂ or an H2-storage facility and, with additional compression, truck and pipeline transport to users of H₂ or a H₂-storage facility. The fourth quantity of cold, medium-pressure (e.g., 30° C. at a pressure of 20-50 bar) tail gas is ready to be sent to at least one of the oxy-combustion furnace 4006 or the one or more storage tanks (not shown), prior to the stored tail gas being sent to the oxy-combustion furnace 4006. A fifth quantity of cold (e.g., 30° C.) CO₂ leaving the H₂-CO₂ separation subsystem 4024 may be sent to one or more dryers 4028 (hereinafter simply “dryer 2028”), which separates the water vapor from the CO₂ by condensation or by adsorption on to a suitable medium, such as a molecular sieve to form a sixth quantity of cold (e.g., 30° C.) dry CO₂. It shall be appreciated that the dryer 2028 operates in the same fashion as the dryer 2014 in FIG. 19. The sixth quantity of cold (e.g., 30° C.) dry CO₂ is then sent to the compressor train 4004 to produce high-pressure (e.g., 100 bar) CO₂ suitable for transportation by truck or in a pipeline to CO₂ users or to a GCS site.

A quantity of electricity from at least one of the one or more electricity-generation units using the embodiments of one or the other of the above-incorporated by reference publications, or the electrical grid, are sent to the H₂-CO₂ separation subsystem 4024, the H₂-cleanup subsystem 4026, the dryer 4028, and the CO₂ compressor train 4004, which include one or more intercooler(s). It should be appreciated that the embodiments described herein which are similar to those of the previously mentioned incorporated by reference publications are designed to dispatch electricity with near-zero or negative CO₂ emissions.

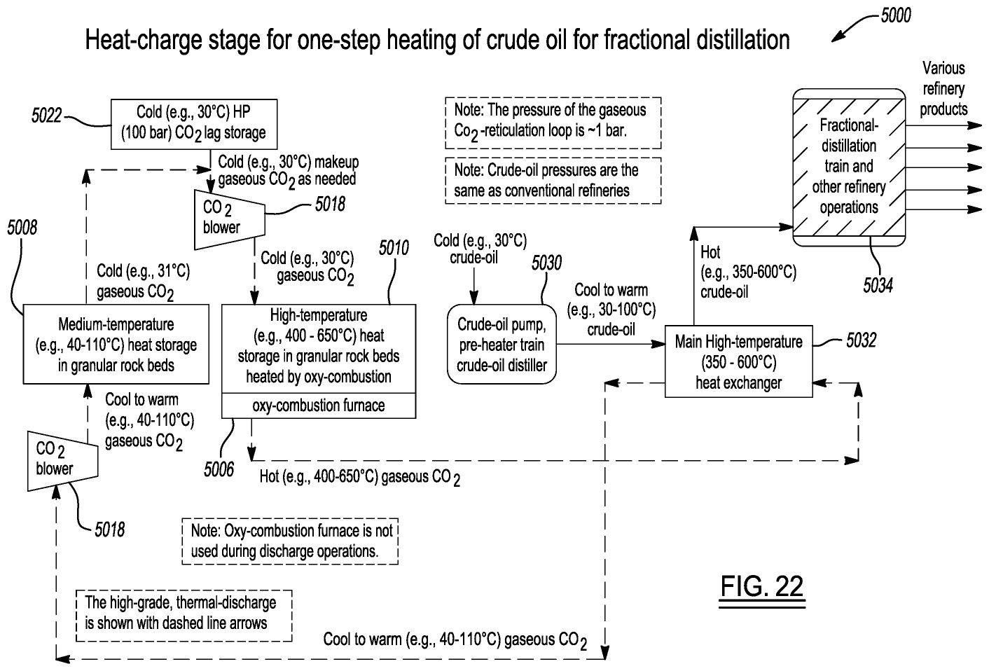

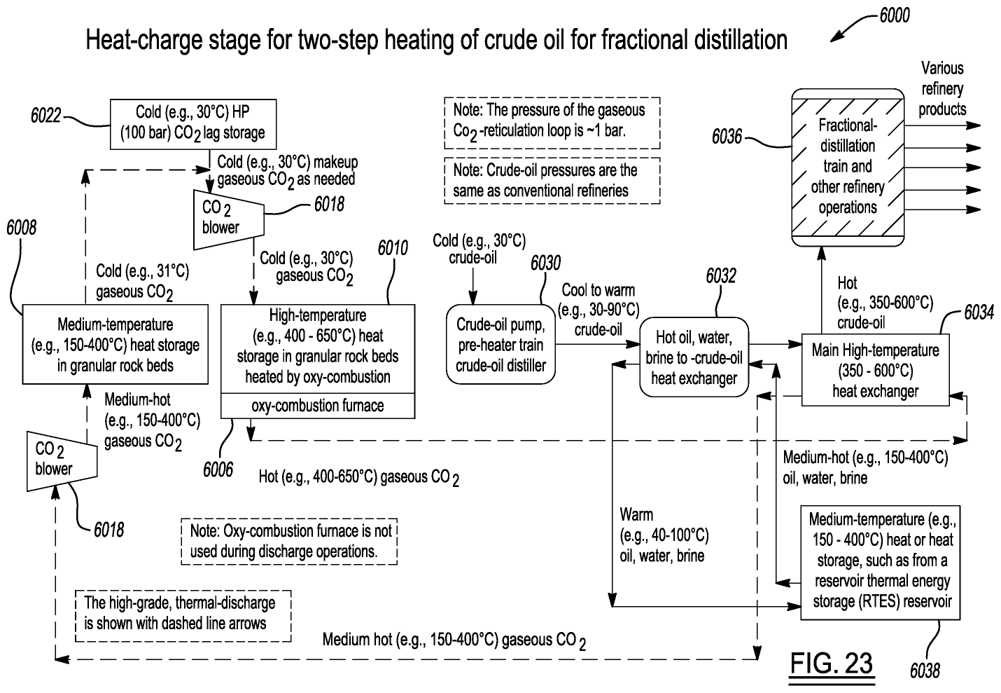

Referring to FIGS. 22 and 23, a heat discharge system 5000 is shown for the fractional distillation of crude oil. Components in comment with those described for the system 4000 are denoted with reference numbers increased by 1000. It shall be appreciated that the heat-discharge subsystem 5000 can involve either a one-step or two-step heating process. The two-step heating process can be applied when either waste heat or renewable heat, such as from geothermal or solar thermal energy (STE), is available to heat crude oil. The one-step process can be used if either of the following two conditions holds. The first condition pertains to when either waste or renewable heat sources are sufficiently hot to heat crude oil to the required temperature of the fractional-distillation train. Because of the high-temperature requirements of crude-oil refineries, it shall be appreciated that this first condition will be difficult to meet. Including an oxy-combustion heat source assures a supply of heat is always available to meet the temperature requirements of an oil refinery. The second condition pertains to when waste heat or renewable heat (either directly or stored) is not available to heat crude oil. The one-step, heating process applies either to the case where hot oil/water/brine-to-crude-oil heat exchangers are not present or when they are not in operation because waste heat or renewable heat is not available. It should be also appreciated that during the heat-discharge stage, pressures along the gaseous CO₂-recirculation loop are always close to 1 bar and that crude-oil pressures are the same as in a conventional crude-oil refinery.

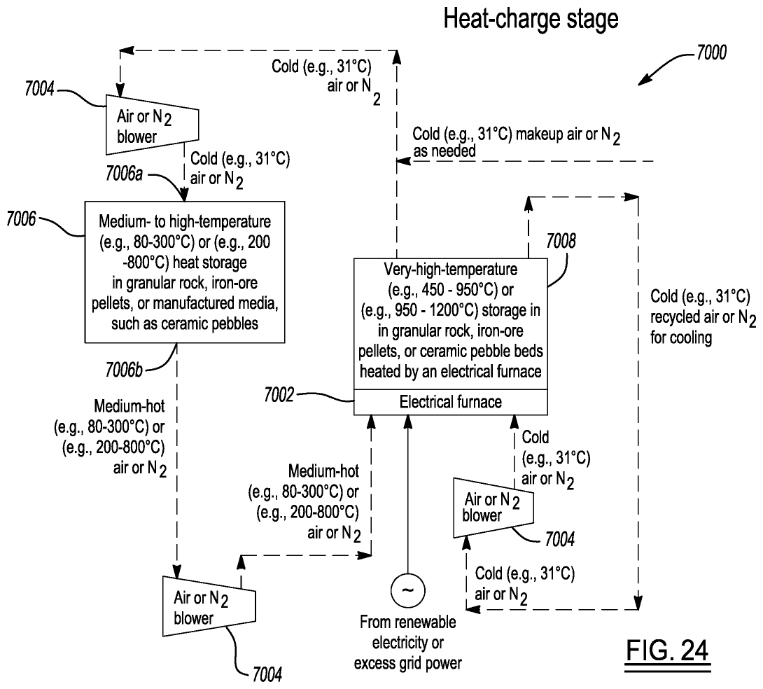

For a description of the one-step heating process using the system 5000, using oxy-combustion heat, reference will be made first specifically to FIG. 22. Initially, with the assistance of one or more CO₂ blower(s) 5018, the heat-discharge stage begins when a first quantity of cold (e.g., 30° C.) gaseous CO₂ is sent to one or more high-temperature (e.g., 400-650° C.) insulated, heat-storage vessel(s) 5010, which are filled with one or more granular-media bed(s), to form a second quantity of hot (e.g., 400-650° C.) gaseous CO₂. It shall be appreciated that the one or more high-temperature (400-650° C.) granular bed(s) have been heated during the heat-charge stage described in connection with FIG. 19 and FIG. 24.

With the assistance of one or more crude-oil pump(s) of a pump/pre-heater/desalter subsystem 5030, a third quantity of cool to warm (e.g., 30-100° C.) crude oil, which has left the one or more desalter(s) of the subsystem 5030, together with the second quantity of hot (400-650° C.) gaseous CO₂, are sent to one or more main high-temperature (e.g., 400-650° C.) heat exchanger(s) 5032 to form a fourth quantity of cool to warm (e.g., 40-110° C.) gaseous CO₂ and a fifth quantity of hot (350-600° C.) crude oil. It shall be appreciated that most refineries require temperatures up to ˜400° C., while those that produce heavy byproducts, such as asphalt cement binder, may require temperatures as high as 600° C.

The fifth quantity of hot (350-600° C.) crude oil is sent to one or more fractional-distillation train(s) 5034, to produce a sixth quantity of various refinery products. It should be appreciated that the various refinery products are the same as those in conventional crude-oil refineries. These refinery products can include, without limitation, at least one of LPG, gasoline, diesel, jet fuel, fuel oil, kerosine, lubricating oils, waxes, bitumen, and asphalt cement binder. With the assistance of the one or more CO₂ blower(s) 5018, the fourth quantity of cool to warm (40-110° C.) gaseous CO₂ is sent to the medium-temperature (e.g., 40-110° C.) heat-storage vessel 5008 to heat the one or more granular-media bed(s) contained therein. Heating continues until most (e.g., 90%) of the one or more granular-media bed(s) have reached the target temperature (e.g., 40-110° C.). This produces the first quantity of cool (e.g., 31° C.) CO₂, which is sent to the high-temperature (e.g., 400-650° C.) heat-storage vessel 5010, which completes the gaseous CO₂-recirculation loop.

Note that the temperature of the first quantity of cool CO₂ (e.g., 31° C.) is preferably chosen to be just above the dew point of the CO₂/steam mixture. It shall be appreciated that an eighth quantity of cold (e.g., 30° C.) CO₂ may be sent from the one or more high-pressure (e.g., 100 bar) lag-storage vessel(s) 5022 to provide make-up CO₂ needed to maintain adequate flow in the CO₂-recirculation loop.

Turning now to a description of the two-step heating process that uses waste heat and/or renewable heat, together with oxy-combustion heat, reference will be made specifically to the heat discharge subsystem 6000 of FIG. 23. It will be understood that components in common with the subsystem 5000 will be labelled with reference numbers increased by 1000. Initially, with the assistance of one or more CO₂ blower(s) 6018, a first quantity of cold (e.g., 30° C.) gaseous CO₂ is sent to one or more high-temperature (e.g., 400-650° C.) insulated, heat-storage vessel(s) 6010, which are filled with one or more granular-media bed(s), to form a second quantity of hot (e.g., 400-650° C.) gaseous CO₂. It shall be appreciated that the one or more high-temperature (e.g., 400-650° C.) heat storage bed(s) have been heated during the heat-charge stage (described in connection with FIG. 19; see also FIG. 24, to be discussed in the following paragraphs). A second quantity of medium-hot (e.g., 150-400° C.) heat-transfer fluid, which can comprise of at least one of oil, water, or brine from medium-temperature heat or heat storage 6038 (hereinafter simply “medium-temperature heat or heat storage 6038”), and, with the assistance of one or more crude-oil pump(s) of a pump/pre-heater/desalter subsystem 6030, a third quantity of cool to warm (e.g., 30-90° C.) crude oil, which has left one or more desalter(s) of the pump/pre-heater/desalter subsystem 6030, are sent to the one or more hot oil/water/brine-to-crude-oil heat exchanger(s) 6032 to form a fourth quantity of warm (e.g., 40-100° C.) heat-transfer fluid, which can comprise of at least one of oil, water, or brine, and a fifth quantity of medium-hot (e.g., 140-390° C.) crude oil. It shall be appreciated that the medium-temperature (e.g., 150-400° C.) heat-transfer fluid is sent from the medium-temperature heat or heat storage 6038, which may comprise at least one of (1) one or more source(s) of waste heat, (2) one or more solar thermal energy (STE) collector field(s), (3) one or more pressurized, hot-water storage vessel(s), (4) one or more hot-oil storage vessel(s), and (4) one or more reservoir thermal energy storage (RTES) reservoir(s). The second quantity of hot (400-650° C.) gaseous CO₂ and the fifth quantity of medium-hot (e.g., 140-390° C.) crude oil are sent to one or more main high-temperature (e.g., 400-650° C.) heat exchanger(s) 6034 to form a sixth quantity of medium-hot (e.g., 150-400° C.) gaseous CO₂ and a seventh quantity of hot (350-600° C.) crude oil. The seventh quantity of hot (350-600° C.) crude oil is sent to one or more fractional-distillation train(s) 6036 to produce an eighth quantity of various refinery products. It should be appreciated that the various refinery products are the same as those in conventional crude-oil refineries.

With the assistance of the one or more CO₂ blower(s) 6018, the sixth quantity of medium-hot (150-400° C.) gaseous CO₂ is sent to the medium-temperature (e.g., 150-400° C.) heat-storage vessel 6008 to heat the one or more granular-media bed(s) contained therein. Heating continues until most (e.g., 90%) of the one or more granular-media bed(s) have reached the target temperature (e.g., 150-400° C.). This produces a first quantity of cool (e.g., 31° C.) CO₂, which is sent to the high-temperature (e.g., 400-650° C.) heat-storage vessel 6010, which completes the gaseous CO₂-recirculation loop. Note that this temperature (e.g., 31° C.) is preferably chosen to be just above the dew point of the CO₂/steam mixture. It shall be appreciated that a nineth quantity of cold (e.g., 30° C.) CO₂ may be sent from one or more high-pressure (e.g., 100 bar) lag-storage vessel(s) 6022 to provide make-up CO₂ needed to maintain adequate flow in the CO₂-recirculation loop.

Carbon Neutral and Carbon-Negative Iron and Steel production

The present disclosure is also directed to various embodiments and methods that are well suited for generating carbon-neutral or negative hydrogen (H₂), carbon monoxide (CO), and heat for iron and steel production; in particular, the hydrogen direct reduction (HDR) of iron ore to produce direct reduced iron (DRI) and pre-heating scrap metal for an electric arc furnace (EAF). As with the preceding incorporated by reference publications, the present disclosure uses granular-media heat storage to enable electrical-furnace heat (FIG. 1) and oxy-combustion heat (FIG. 2) to be time-shifted from when it is created to when it is needed for industrial applications. Granular media can include rock, crushed rock, manufactured media, or iron-ore pellets. Heat can also be stored in scrap metal, which is fed to an electric arc furnace (EAF). An advantage of oxy-combustion is that high-purity CO₂ is generated, which can be dried and compressed for transportation to a user or to geological CO₂ sequestration (GCS) site without requiring post-combustion, CO₂-capture technology. The systems and methods in this disclosure can provide carbon-neutral or negative heat for iron and steel production and, in particular, meet key needs for decarbonizing DRI and EAF operations: (1) supplying carbon-neutral or negative H₂ and CO₂ using proven, mature components, and (2) heating iron-ore pellets with carbon neutral or negative heat, which is fed to a DRI shaft furnace, and (3) supplying carbon-neutral or negative heat to pre-heat scrap metal, which is fed to an EAF. This disclosure presents systems and methods for delivering decarbonized heat and decarbonized reducing gas to a DRI shaft furnace: (1) storing decarbonized heat in iron-ore pellets, which are fed to the DRI shaft furnace and (2) generating and sending very-hot decarbonized H₂ and CO₂ reducing gas to the DRI shaft furnace. This disclosure also presents systems and methods for pre-heating scrap metal with decarbonized heat before it is sent to an EAF, using mature components, to reduce power needed by EAF electrodes and to reduce the time required to melt scrap metal and DRI product that are fed to an EAF.

The embodiments of this disclosure are intended to overcome the major implementation challenges of the prior art. The first challenge is that SOEC technology is not mature enough for commercial deployment and it lacks materials that can withstand the high temperatures and pressures required by the SOEC/DRI process. The embodiments in this disclosure overcome this challenge by using SMR/water-gas shift reactors, which are mature and widely deployed, to generate decarbonized H₂ and CO working gas. The second challenge is that the SOEC/DRI process transfers heat to the shaft furnace by heating the H₂ reduction gas, which will require very large and expensive heat exchangers and the re-heating of recirculated H₂. The embodiments in this disclosure heat iron-ore pellets directly with very-hot air or N₂, generated by electrical or oxy-combustion furnaces.

The third implementation challenge with the SOEC/DRI process is that it relies on battery storage to time-shift VRE electricity so that it is available for continuous DRI production. The embodiments in this disclosure time-shift VRE electricity entirely with heat storage instead of battery storage. Heat storage in iron-ore pellets is used to time-shift VRE electricity by allowing the electrical furnaces that heat those pellets to rely entirely on electricity from VRE sources. Heat storage allows the very-hot iron-ore pellets to be sent into the DRI shaft furnace whenever needed to for continuous DRI production. Heat storage also enables H₂ and CO₂ reducing gas to be generated continuously, entirely with decarbonized heat from VRE electricity.

As noted above, the prior art for manufacturing steel with melted scrap metal in an EAF is limited to finding ways to deliver VRE electricity to the electrodes in an EAF. Prior developed approaches also address reducing the electricity needed by recuperating heat from the EAF off gas to pre-heat scrap metal before it is sent to the EAF. However, heating scrap metal with electrodes in an EAF is very energy intensive. The embodiments in this disclosure overcome this drawback by generating carbon-neutral or negative heat to pre-heat scrap metal before it is sent to the EAF. This present disclosure also includes novel embodiments for recuperating heat, which is sent back into heat storage and used to reduce electricity needed for electrical furnaces and fuel consumption in the oxy-combustion furnaces. Altogether, the embodiments in this disclosure may be able to reduce electricity needed to power the EAF electrodes by up to 75%. Furthermore, embodiments in the previously mentioned incorporated by reference publications can be used to supply carbon-neutral or negative electricity to power the EAF electrodes.

It shall be appreciated that in the following description, granular media can include, without limitation, at least one of rock, crushed rock, mined aggregate, manufactured granular media, or iron-ore pellets. Referring now to a heat charge system 7000 shown in FIG. 24(1), a heat-charge stage using electrical furnaces will now be described.

Initially, electricity, including excess electricity from the power grid and/or electricity from variable renewable energy (VRE) sources is used to power one or more electrical furnaces 7002. With the assistance of one or more air or N₂ blower(s) 7004, a first quantity of warm to hot (e.g., 80-300° C. or 200-800° C.) air or N₂ from one or more insulated, medium-temperature heat-storage vessel(s) 7006 is mixed with a second quantity of cold (e.g., 31° C.) air or N₂ to form a third quantity, with the third-quantity mixture being sent to the one or more electrical furnaces 7002. It should be appreciated that mixing warm to hot (e.g., 80-300° C. or 200-800° C.) air or N₂ with cold (e.g., 31° C.) air or N₂ reduces the amount of electricity required to attain the target storage temperature (e.g., 450-950° C. or 950-1200° C.). The third quantity of air or N₂ is sent to one or more insulated, very-high-temperature vessel(s) 7008 to heat one or more granular-media bed(s) contained therein. This process continues until most (e.g., 90%) of the granular beds have attained the target storage temperature (e.g., 450-950° C. or 950-1200° C.).

With the assistance of the one or more air or N₂ blower(s) 704, a fourth quantity of cold (e.g., 31° C.) air or N₂ that leaves the one or more granular-media bed(s) inside the one or more very-high-temperature vessel(s) 7008 is sent to a first port 7006a of the one or more medium-to high-temperature heat-storage vessel(s) 7006, which cools the one or more granular bed(s) therein and drives medium-hot to hot (e.g., 80-300° C. or 200-800° C.) air or N₂ out of through a second port 7006b thereof. This completes the heat-charge loop. This process continues until most (e.g., 90%) of the one or more medium-to-high-temperature, heat-storage vessel(s) 7006 has been cooled to a sufficiently cold temperature (e.g., 31° C.).

To maintain a target storage temperature (e.g., 450-950° C. or 950-1200° C.), cold air (e.g., 31° C.) or N₂ is recirculated through the one or more granular-media bed(s) inside the one or more very-high-temperature vessel(s) 7008 with the assistance of the one or more air or N₂ blower(s) 7004. Recirculation of air or N₂ also helps to evenly distribute heat in the one or more granular-media bed(s) of the vessel(s) 7008.

The one or more granular-media bed(s) are not fully heated during the heat-charge stage. Heating continues until most (e.g., 90%) of the one or more granular-media bed(s) within the vessel(s) 7008 has been heated to the target storage temperature (e.g., 450-950° C. or 950-1200° C.). This places the thermal front within 10% of the cold end of the one or more granular-media bed(s). This assures that the downstream portion (e.g., 10%) of the granular-media beds within the vessel(s) 7008 remains relatively unheated. In this manner air or N₂ that exits the one or more granular-media bed(s) therefrom is cold and above its dew point (e.g., 31° C.), thereby limiting the loss of heat.

It shall be appreciated that in the following description, granular media can include, without limitation, at least one of rock, crushed rock, mined aggregate, manufactured media, such as ceramic pebbles, ceramic blocks, or concrete blocks, or iron-ore pellets. Still other types of granular media may be suitable for use, and the above-listing of such media is therefore intended to be non-limiting.

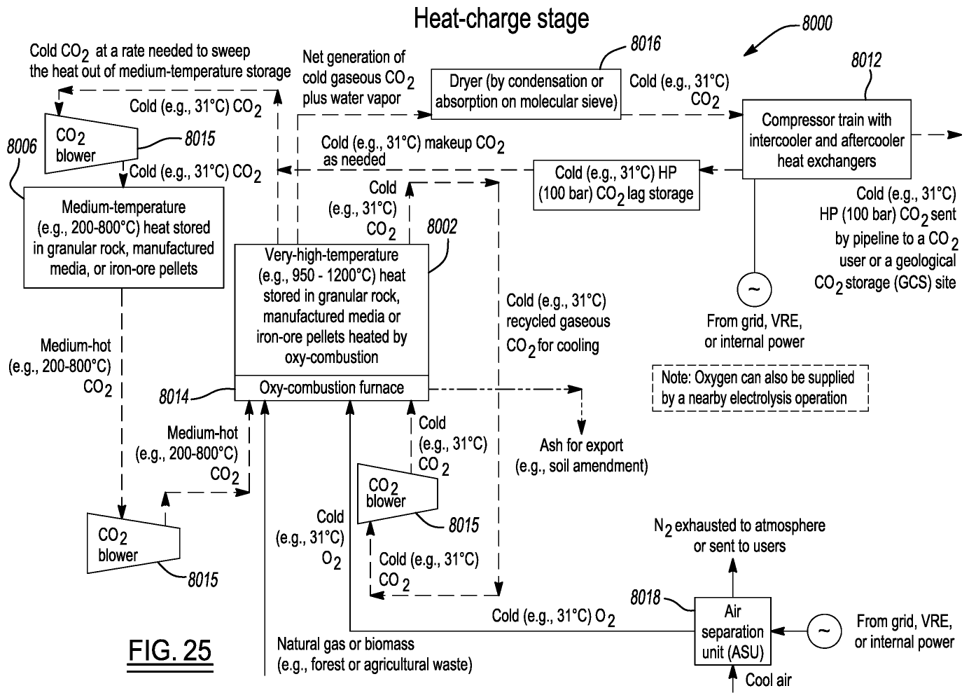

Referring to FIG. 25, the structure and operation of a system 8000 for carrying out a heat-charge stage with oxy-combustion will now be described. Components of the system 8000 in common with those of the system 7000 have like reference numbers increased by 1000. Initially, electricity, including excess electricity from the power grid and/or electricity from variable renewable energy (VRE) sources is used to power one or more of the air separation units (ASUs) 8018 and one or more compressor train(s) 8012 containing one or more compressor(s), followed by one or more intercooler and aftercooler heat exchanger(s). The one or more ASUs 8018, or other form of oxygen-generation devices, are used to obtain high-purity (e.g., 95%-99%) O₂ from air. For the rest of this charge-stage description, O₂-generation devices will be referred to simply as the ASUs or O₂ generators. Cold (e.g., 30° C.), high-purity (e.g., 95%-99%) O₂ from the one or more oxygen generators, the fuel of choice, and enough cold CO₂ (e.g., 31° C.) for temperature modulation, are sent to one or more oxy-combustion furnace(s) 8014. Cold (e.g., 31° C.), high-purity (e.g., 95%-99%) O₂ from the one or more ASU(s) 8018 may be mixed with warm to hot (e.g., 200-800° C.) CO₂ from the one or more insulated, medium-temperature heat-storage vessel(s) 8006, and also with an additional fuel of choice (e.g., and without limitation, natural gas, coal, coke, petroleum, petroleum coke, tires, fuel oil, hydrogen, solid waste, or biomass, including agricultural waste, forest waste, municipal solid waste (MSW), or a combination thereof.) It should be appreciated that mixing warm to hot (e.g., 200-800° C.) CO₂ with cold, high-purity O₂ (e.g., e.g., 31° C. and 95%-99% O₂) and the fuel of choice reduces the amount of fuel required to attain the target storage temperature (e.g., 950-1200° C.).

The fuel of choice is combusted in cold (e.g., 31° C.) high-purity (e.g., 95%-99%) O₂ inside the one or more oxy-combustion furnace(s) 8014 to generate very-hot (e.g., 950-1200° C.), high-purity (e.g., 95%-99%, dry-basis) gaseous CO₂ and stoichiometrically equivalent quantity of steam. Very-hot (e.g., 950-1200° C.), high-purity (e.g., 95%-99% dry-basis) gaseous CO₂, plus the steam created in the one or more oxy-combustion furnace(s), is sent to the one or more insulated, very-high-temperature vessel(s) 8002 to heat the one or more granular-media bed(s) contained therein.

Combusting fossil fuel or biomass in high-purity O₂ creates a high flame temperature. To maintain a target combustion and storage temperature (e.g., 950-1200° C.), additional cold, gaseous CO₂ above its dew point (e.g., 31° C.) is recirculated through the one or more granular-media bed(s) inside the one or more very-high-temperature vessel(s) 8002 with the assistance of one or more CO₂ blower(s) 8015. Recirculation of CO₂ also helps to evenly distribute heat in the one or more granular-media bed(s) of the vessel(s) 8002.

It will be appreciated that the one or more granular-media bed(s) are not fully heated during the heat-charge stage. Heating continues until most (e.g., 90%) of the one or more granular-media bed(s) within the vessel(s) 8002 has been heated to the target storage temperature (e.g., 950-1200° C.), which places the thermal front within 10% of the cold end of the one or more granular-media bed(s) therein. This assures that the downstream portion (e.g., 10%) of the one or more granular-media bed(s) therein remains relatively unheated, so gaseous CO₂ and water vapor that exits the one or more granular-media bed(s) is cold and above its dew point (e.g., 31° C.). This limits the loss of heat as gaseous CO₂ is sent to the one or more compressor train(s) 8012. Note that this temperature is preferably chosen to be just above the dew point of the CO₂/water vapor mixture, which is a function of the fuel used, along with the stoichiometry of the input fuel/oxidant mixture. This prevents condensation and moisture buildup in the one or more granular-media bed(s) within the one or more very-high-temperature heat-storage vessel(s) 8002.

The cold (e.g., 31° C.) mixture of gaseous CO₂ and water vapor, which is just above its dew point, leaves the downstream portion of the one or more granular-media bed(s) within the one or more very-high-temperature heat-storage vessel(s) 8002. The portion of the cold (e.g., 31° C.) CO₂ that was generated by oxy-combustion is sent to a dryer subsystem 8016. The dryer subsystem 8016 separates the water vapor from the CO₂ by condensation or by adsorption on to a suitable medium, such as a molecular sieve. The cold (e.g., 31° C.) dry CO₂ is then sent to the one or more compressor train(s) 8012 to produce high-pressure (e.g., 100 bar) CO₂, which is suitable for transportation by truck, or in a pipeline, or by any other suitable means, to CO₂ users and/or GCS sites.

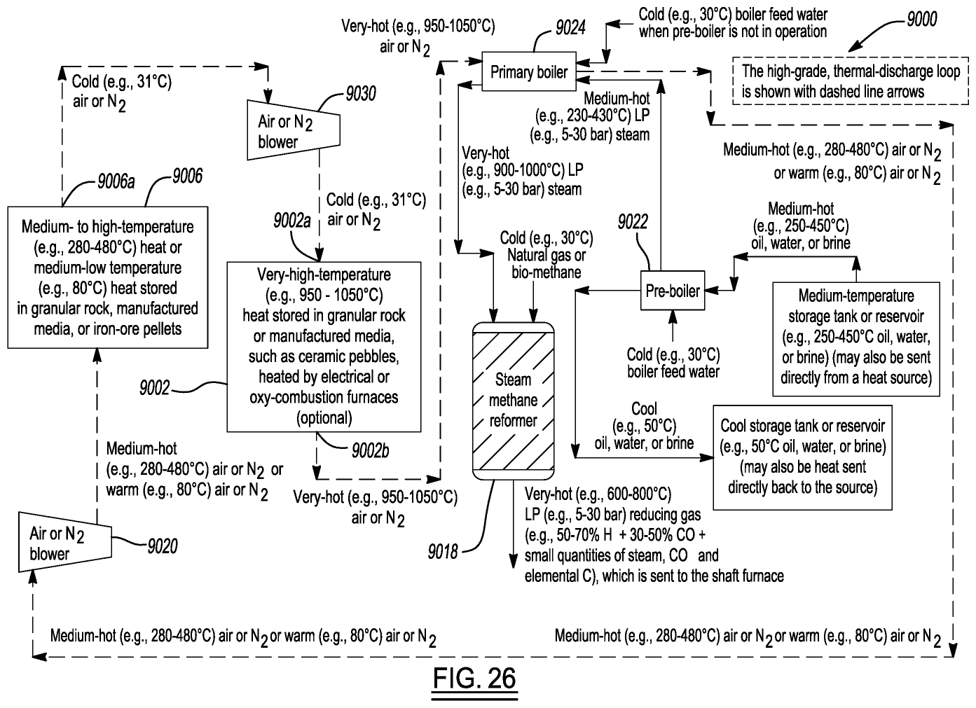

Referring now to FIG. 26, a system 9000 and method of operation will be described for a heat-discharge stage which supplies carbon-neutral or negative heat to a steam methane reformer (SMR) operations to produce a very-hot mixture of H₂ and CO reducing gas. With the assistance of one or more air or N₂ blower(s) 9020, a first quantity of cold (e.g., 31° C.) air or N₂ from a cold end 9006a of the one or more insulated, medium-temperature vessel(s) 9006 containing one or more granular-media bed(s), is blown into a cold end 9002a of one or more insulated, very-high-temperature vessel(s) 9002 containing one or more granular-media bed(s).

The first quantity of cold (e.g., 31° C.) air or N₂ flows into the cold end 9002a and to a hot end of 9002b of the one or more insulated, very-high-temperature vessel(s) 9002 where it is heated by the one or more granular-media bed(s) contained therein. This produces a second quantity of very-hot (e.g., 950-1050° C.) air or N₂ which leaves the hot end 9002b of the one or more insulated, very-high-temperature vessel(s) 9002. With the assistance of the one or more air or N₂ blower(s) 9020, a first quantity of cold (e.g., 31° C.) air or N₂ continues to be blown into the cold end 9002a of the one or more insulated, very-high-temperature vessel(s) 9002, where it is heated by the very hot granular-media beds contained therein. This process displaces the second quantity of very hot (e.g., 950-1050° C.) air or N₂ out of the hot end 9002b of the one or more insulated, very-high-temperature vessel(s) 9002 until only a relatively small percentage (e.g., 10%) of the one or more granular-media bed(s) contained therein remains at the target storage temperature (e.g., 950-1050° C.). It shall be appreciated that the process of cooling most (e.g., 90%) of the one or more granular-media bed(s) in the one or more very-high-temperature vessel(s) 9002 prepares them to receive heat during the subsequent heat-charge stage.

Referring further FIG. 26, a two-step heating process of SMR operations will now be described. The description of the one-step heating process follows the description of the two-step heating process. Initially a third quantity of cold (e.g., 30° C.) boiler feed water and a fourth quantity of medium-hot (e.g., 250-450° C.) water, brine, or oil are sent to one or more pre-boiler(s) 9022 to form a fifth quantity of cold (e.g., 50° C.) water, brine, or oil and a sixth quantity of medium-hot (e.g., 230-430° C.) steam. The second quantity of very-hot, medium-hot (e.g., 950-1050° C.) air or N₂ and the sixth quantity of medium-temperature (e.g., 230-430° C.) steam are sent to one or more primary boiler(s) 9024 to form a seventh quantity of medium-hot (e.g., 280-480° C.) air or N₂ and an eighth quantity of very-hot (e.g., 900-1000° C.) steam.

With the assistance of the one or more air or N₂ blower(s) 9020, the seventh quantity of medium-hot (e.g., 280-480° C.) air or N₂ is sent to one or more granular bed(s) in one or more insulated, medium-temperature, heat-storage vessel(s) 9006, where it heats the granular beds therein and forms an eighth quantity of cold (e.g., 31° C.) air or N₂. With the assistance of the one or more air or N₂ blower(s) 9020 described, this eighth quantity of cold (e.g., 31° C.) air or N₂ is sent to the cold end 9006a of the one or more insulated, medium-temperature vessel(s) 9006 to complete the heat-transfer loop.

The eighth quantity of very-hot (e.g., 900-1000° C.) steam and a ninth quantity of cold (e.g., 30° C.) natural gas or biomethane are sent to the one or more steam methane reformer (SMR) subsystem(s) 9018, which performs one or more SMR operation(s) to produce a tenth quantity of very-hot (e.g., 600-800° C.) reducing gas. This reducing gas consists of about 50-70% H2 and 30-50% CO, plus small quantities of steam, CO₂, and elemental C. It shall be appreciated that, depending on the desired mixture of H₂ and CO in the reducing gas, the one or more SMR operation(s) may or may not require the use of one or more water-gas shift reactor(s).

The tenth quantity of very-hot (e.g., 600-800° C.) H₂ and CO reducing gas and elemental C is sent to one or more direct reduced iron (DRI) shaft furnace(s) for the hydrogen direct reduction (HDR) of iron ore, which will be described below.

Referring further to FIG. 26, the following describes the one-step heating process of involving the SMR operations. Initially a third quantity of cold (e.g., 30° C.) boiler feed water and a second quantity of very-hot (e.g., 950-1050° C.) air or N₂ are sent from the hot end of the one or more very-high-temperature insulated heat-storage vessel(s) 9002b to the one or more primary boiler(s) 9024 to form an eighth quantity of very-hot (e.g., 900-1000° C.) steam and an eleventh quantity of warm (e.g., 80° C.) air or N₂. With the assistance of the one or more air or N₂ blower(s) 9020, the eleventh quantity of warm (e.g., 80° C.) air or N₂ is sent to the one or more medium-low-temperature insulated heat-storage vessel(s) 9006 to heat the one or more granular bed(s) therein. With the assistance of one or more air or N₂ blowers 9030, cool (e.g., 31° C.) air or N₂ is sent to the one or more very-high-temperature, heat-storage vessel(s) 9002 to complete the high-temperature, heat-transfer loop. The eighth quantity of very-hot (e.g., 900-1000° C.) steam and the ninth quantity of cold (e.g., 30° C.) natural gas or biomethane are sent to the one or more steam methane reformer (SMR) subsystem(s) 9018 to carry out the one or more SMR operation(s), as described above.

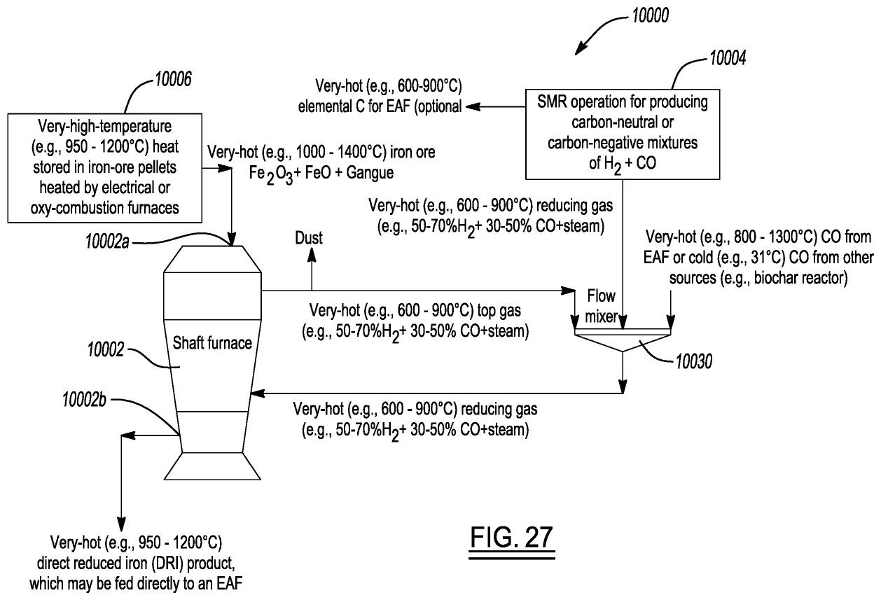

Referring now to FIG. 27, a system 10000 will be discussed for carrying out the heat-discharge stage to supply very-hot iron-ore pellets and very-hot H₂ and CO reducing gas to one or more direct reduced iron (DRI) shaft furnace(s) 10002. This process is used for the hydrogen direct reduction (HDR) of iron ore to produce very-hot DRI. It shall be appreciated that the heat-discharge stage can involve supplying endothermic heat to the DRI shaft furnace, using a combination of two heat-transfer media: (1) very-hot iron-ore pellets and (2) very-hot H₂ and CO reducing gas.

Optionally, with the assistance of the one or more of gas blower(s) (not shown), the heat-discharge stage begins with receiving one or more quantities fluids from one or more diverse external fluid sources. This receiving operation may include receiving a first quantity of a very-hot (e.g., 600-900° C.) mixture of reducing gas (e.g., 50-70% H2, 30-50% CO and a small quantity of steam), having been sent from the one or more steam methane reforming (SMR) operation(s) 10004, as well as receiving a second quantity of very-hot (e.g., 900-1300° C.) CO from an external source, such as an electric arc furnace (EAF), as well as receiving a third quantity of very hot (e.g., 600-900° C.) “top gas” (e.g., 50-70% H₂, 30-50% CO and a small quantity of steam), having been sent from close to a top 10002a of the one or more DRI shaft furnace(s) 10002. These fluids are sent to one or more flow mixer(s) 10030 to form a fourth quantity of very-hot (e.g., 600-900° C.) reducing gas (e.g., 50-70% H₂, 30-50% CO and a small quantity of steam), with the fourth quantity being sent to the one or more shaft furnace(s) 10002, about one-third of the way up from a bottom 10002b thereof. It shall be appreciated that the DRI shaft furnace 10002 is actually not a furnace, because combustion is not required to supply endothermic heat and, therefore, could be even more accurately called a DRI shaft reactor.

A fifth quantity of very-hot (e.g., 950-1200° C.) iron-ore pellets (e.g., Fe₂O₃+FeO+Gangue) is fed from one or more very-high temperature insulated heat-storage vessel(s) 10006 into a port 10002c at the top of the shaft furnace 10002, where it mixes with the fourth quantity of very-hot (e.g., 600-900° C.) reducing gas (e.g., 50-70% H₂, 30-50% CO and a small quantity of steam) to form a third quantity of very-hot (e.g., 600-900° C.) top gas (e.g., 50-70% H₂, 30-50% CO) and a small quantity of steam, as described above, and a sixth quantity of very-hot (e.g., 950-1200° C.) direct reduced iron (DRI). It shall be appreciated that it may be necessary to remove some dust from the top gas. It shall also be appreciated that the very-hot (e.g., 950-1200° C.) iron-ore pellets were heated during the heat-charge stage by decarbonized heat created by at least one of one or more electrical furnace(s) (FIG. 24, component 7002) and one or more oxy-combustion furnace(s) (FIG. 25, component 8014).

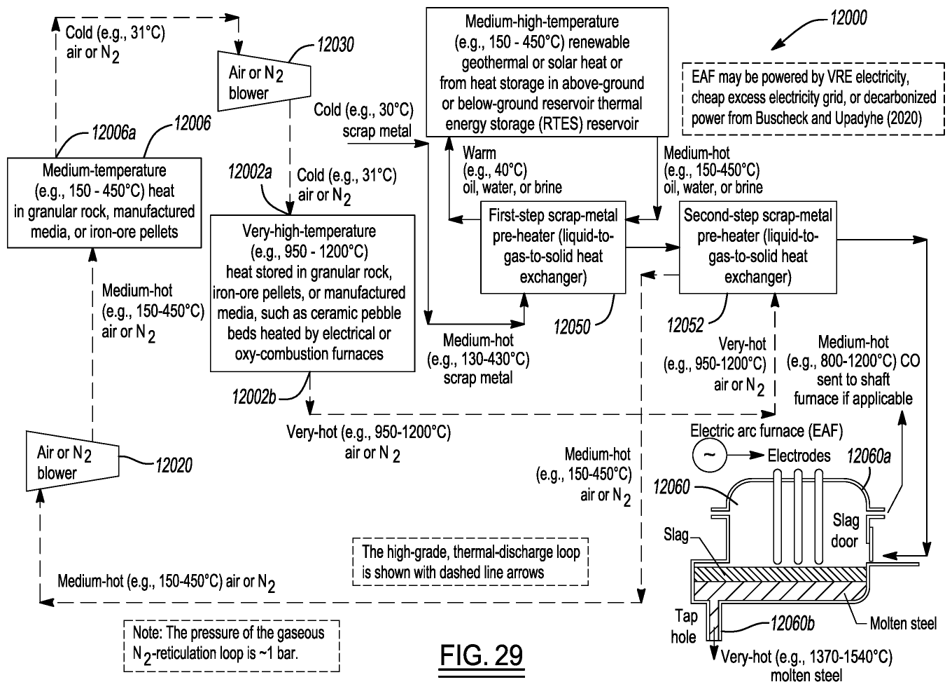

For an integrated iron and steel plant, the sixth quantity of very-hot (e.g., 950-1200° C.) direct reduced iron (DRI) can be fed directly to one or more electric arc furnace(s) (EAF), as described in the following paragraphs and in connection with FIG. 29. It shall be appreciated that directly feeding very-hot DRI product to an EAF reduces the power required by the EAF electrodes (see FIG. 29). It shall also be appreciated that sending very-hot DRI product to one or more EAF(s) can also can substantially reduce the time required to melt the DRI product to molten steel, which can significantly increase the number of melts an EAF steel-mill plan can accomplish in a given day, and thereby significantly increase the throughput of the EAF steel mill.

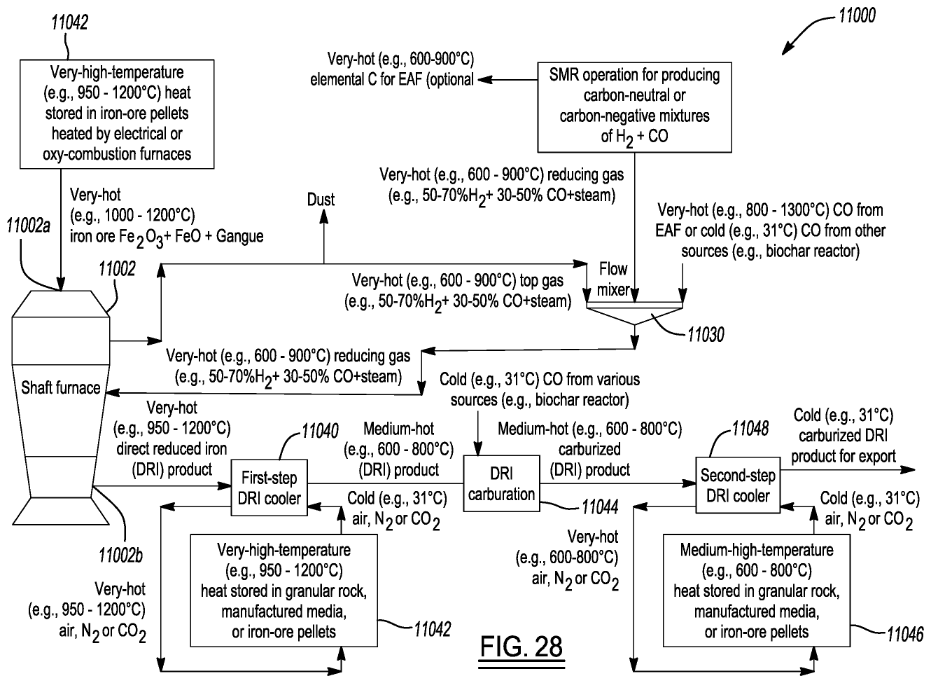

Referring to FIG. 28, a heat-discharge system 11,000 for carrying out a heat-discharge stage will now be described. The heat-discharge stage supplies very-hot iron-ore pellets and very-hot H₂ and Co reducing gas for hydrogen direct reduction (HDR) of iron ore to produce cold, carburized direct reduced iron (DRI). This cold, DRI may be exported to a separate steel-making facility. The previous description applies for the generation of the sixth quantity of very-hot (e.g., 950-1200° C.) direct reduced iron (DRI).

The sixth quantity of very-hot (e.g., 950-1200° C.) DRI product and a seventh quantity of cold (e.g., 31° C.) air, N₂, or CO₂ are sent to one or more first-step DRI cooler(s) 11,040 to form an eighth quantity of very-hot (e.g., 950-1200° C.) air, N₂, or CO₂ and a ninth quantity of medium-hot (e.g., 600-800° C.) DRI product. The eighth quantity of very-hot (e.g., 950-1200° C.) air, N₂, or CO₂ is sent to one or more granular bed(s) in one or more very-high-temperature, heat-storage vessel(s) 11,042, which heats the one or more granular bed(s) contained therein and cools the air, N₂, or CO₂ to become a seventh quantity of cold (e.g., 31° C.) air, N₂, or CO₂, which is available to be sent to the one or more first-step DRI cooler(s) 11,040 to complete the cooling loop. The heat remaining in the one or more very-high-temperature, heat-storage vessel(s) 10,042 can be used in the one or more SMR operation(s) or, if the granular media is iron-ore pellets, it may be fed to a top of 11,002a of the one or more DRI shaft furnace(s) 11,002.

The ninth quantity of medium-hot (e.g., 600-800° C.) DRI product and a tenth quantity of cold (e.g., 31° C.) CO are sent to a DRI-carburation subsystem 11,044 to perform a DRI operation to form an eleventh quantity of medium-hot (e.g., 600-800° C.), carburized DRI product. It shall be appreciated that the source of the cold (e.g., 31° C.) CO may be a biochar reactor. The eleventh quantity of medium-hot (e.g., 600-800° C.), carburized DRI product and a twelfth quantity of cold (e.g., 31° C.) air, N₂, or CO₂, having been sent from one or more medium-temperature, heat-storage vessel(s) 11,046, are sent to one or more second-step DRI cooler(s) 11,048 to form a thirteenth quantity of medium-hot (e.g., 600-800° C.) air, N₂, or CO₂ and a fourteenth quantity of cold (e.g., 31° C.), carburized DRI product, which are available for export to a separate steel-making facility.

With the assistance of one or more air, N₂, or CO₂ blower(s) (not shown), the thirteenth quantity of medium-hot (e.g., 600-800° C.) air, N₂, or CO₂ is returned to one or more medium-temperature, heat-storage vessel(s) 11,046, which heats the one or more granular-media bed(s) therein and completes the heat-transfer loop for the one or more second-step DRI cooler(s) 11,048. It shall be appreciated that the heat left in the one or more medium-temperature, heat-storage vessel(s) 11,046 is used during the heat-charge stage to reduce at least one of the electricity required by the one or more electrical furnace(s) (FIG. 29) or the fuel needed by the one or more oxy-combustion furnace(s) (FIG. 25).

Referring to FIG. 29, a system 12,000 for carrying out a heat-discharge stage of operation will now be described for pre-heating scrap metal for an electric arc furnace (EAF) steel mill. The following description begins with a two-step, scrap-metal, pre-heating process. It should be appreciated that the first step of scrap-metal pre-heating is optional. The description of the one-step scrap-metal pre-heating process follows the description of the two-step, scrap-metal, pre-heating process. The heat-discharge stage may typically involve using the one or more insulated, medium-temperature and very-high-temperature heat-storage vessel(s) 12,006 and 12,002, respectively, which are each filled with one or more granular-media bed(s). These vessels may be operated in parallel to allow the closed-loop recirculation of very-hot (e.g., 950-1200° C.) air or N₂ to medium-hot (e.g., 150-450° C.) air or N₂ to continuously operate during the heat-discharge stage. This makes it possible for medium-hot (e.g., 150-450° C.) air or N₂ to always be returned to at least one of the insulated, medium-temperature vessel(s) 12,006, containing the one or more granular-media bed(s). The returned heat is used to reduce electricity use (see FIG. 24) or fuel consumption (see FIG. 25) during the heat-charge stage.

With the assistance of one or more of air or N₂ blower(s) 12020, the heat-discharge stage begins with a first quantity of cold (e.g., 31° C.) air or N₂ from a first port 12,006a at a cold end of the one or more insulated, medium-temperature vessel(s), containing the one or more granular-media bed(s), being blown into a first port 12002a at a cold end of the one or more insulated, very-high-temperature vessel(s) 12,002, containing the one or more granular-media bed(s). Because this is a closed-loop process, the one or more granular-media bed(s) contained in the one or more insulated, medium-temperature vessel(s) 12,006 have already been cooled during the heat-charge stage (see FIGS. 19 and 20). Cold (e.g., 31° C.) air or N₂ that had left the one or more insulated, very-high-temperature vessel(s) 12,002 had cooled the one or more medium-temperature vessel(s) 12,006 during the heat-charge stage to prepare it to receive heat during the heat-discharge stage.

The first quantity of cold (e.g., 31° C.) air or N₂ flows from the cold end to a hot end of the one or more insulated, very-high-temperature vessel(s) 12,002, where it is heated by the one or more granular-media bed(s) contained therein, to become a second quantity of very-hot (e.g., 950-1200° C.) air or N₂, which leaves the hot end through a second port 12,002b of the one or more insulated, very-high-temperature vessel(s) 12,002. With the assistance of one or more air or N₂ blower(s) 12,030, a first quantity of cold (e.g., 31° C.) air or N₂ continues to be blown into the cold end of the one or more insulated, very-high-temperature vessel(s) 12,002 through the first port 12,002a, where it is heated by the very hot granular-media beds contained therein. This process displaces the second quantity of very hot (e.g., 950-1200° C.) air or N₂ out of the hot end through the second port 12,002b of the one or more insulated, very-high-temperature vessel(s) 12,002 until only a relatively small percentage (e.g., 10%) of the one or more granular-media bed(s) contained therein remains at the target storage temperature (e.g., 950-1200° C.). It should be appreciated that this prepares the one or more very-high-temperature vessel(s) 12,002 to receive heat during a subsequent heat-charge stage.

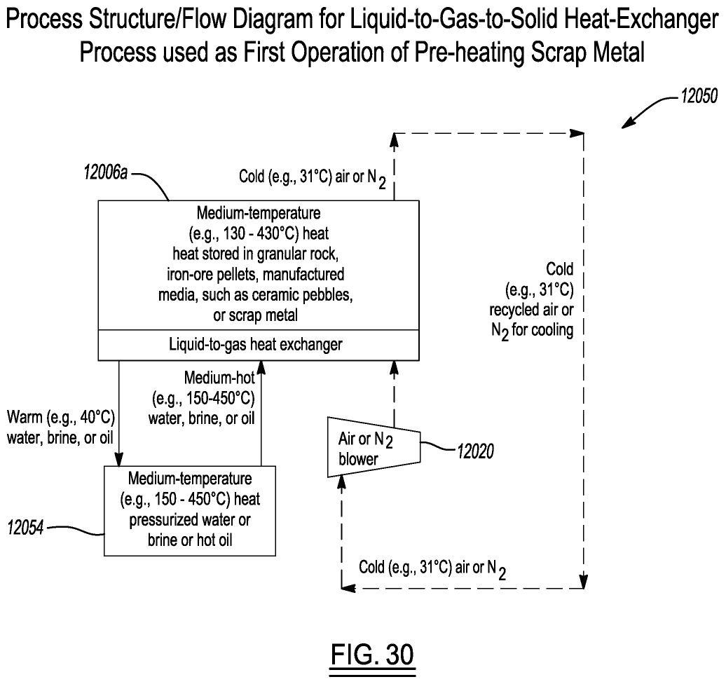

Referring further to FIG. 29 and also to FIG. 30, the following description is for a two-step, scrap-metal preheating process using the system 12,000. For this preheating process one or more first liquid-to-gas-to-solid heat exchanger systems 12,050 (FIGS. 29 and 30) and one or more second scrap metal pre-heater heat exchanger systems 12052 (FIG. 29) are employed. A breakout of the subsystems and operations for the heat exchanger system 12,050 is shown in FIG. 30.

Initially a third quantity of medium-hot (e.g., 150-450° C.) water, brine or oil 12,054 shown in FIG. 30, and with the assistance of the one or more air or N₂ blower(s) 12,020 a fourth quantity of cold (e.g., 31° C.) air or N₂ as well, are sent to the one or more first-step, liquid-to-gas-to-solid heat exchanger(s) 12,050. This produces a fifth quantity of medium-hot (e.g., 130-430° C.) air or N₂, which heats a sixth quantity of cold (e.g., 30° C.) scrap metal to form a seventh quantity of medium-hot (e.g., 130-430° C.) scrap metal and an eighth quantity of cold (e.g., 31° C.) air or N₂, which is returned to the air or N₂ blower 12,020, described above.

The second quantity of very hot (e.g., 950-1200° C.) air or N₂ and seventh quantity of medium-hot (e.g., 130-430° C.) hot scrap metal are sent to the one or more second-step scrap-metal pre-heater(s) 12,052 which produces an eighth quantity of medium-hot (e.g., 150-450° C.) air or N₂, as well as a ninth quantity of very-hot (e.g., 950-1200° C.) scrap metal and a tenth quantity of medium-hot (e.g., 150-450° C.) air or N₂.

With the assistance of the one or more air or N₂ blower(s) 12,020, the tenth quantity of medium-hot (e.g., 150-450° C.) air or N₂ is sent to one or more granular bed(s) in one or more medium-temperature, heat-storage vessel(s) 12,006, which heats the granular beds therein and forms an eleventh quantity of cold (e.g., 31° C.) air or N₂. This quantity of cold (e.g., 31° C.) air or N₂ is then sent to the one or more air or N₂ blower(s) 12,020, to complete the very-high-temperature, heat-transfer loop. It should be appreciated that the heat left in the one or more medium-temperature heat-storage vessel(s) 12006 is used during the subsequent heat-charge stage to reduce at least one of the electricity required by the one or more electrical furnace(s) (FIG. 24) or the fuel required by the one or more oxy-combustion furnace(s) (FIG. 25).

The ninth quantity of very-hot (e.g., 950-1200° C.) scrap metal is then sent to one or more electric arc furnaces (EAFs) 12060 and a twelfth quantity of electricity is sent to one or more EAF electrode(s) 12,060a to form a thirteenth quantity of very-hot (e.g., 800-1300° C.) CO. This thirteenth quantity of very-hot (e.g., 800-1300° C.) CO can then be sent to one or more DRI shaft furnace(s) or the one or more DRI carburation operation(s), plus a fourteenth quantity of molten steel, which exits the one or more EAFs 12060 through the one or more tap hole(s) 12060b thereof. The molten steel can be sent to various steel-making operations. It shall be appreciated that power required for the one or more EAF electrode(s) 12,060a can be carbon-neutral or negative, using the systems and methods disclosed in the publications mentioned above which have been incorporated by reference into the present application.

Referring further to FIG. 29, the following description will now be provided for a one-step, scrap-metal, pre-heating process. Initially a second quantity of very-hot (e.g., 950-1200° C.) air or N₂ and a sixth quantity of cold (e.g., 30° C.) scrap metal are sent to the one or more second-step, scrap-metal pre-heater(s) 12052 to form a fifteenth quantity of cold (e.g., 40° C.) air or N₂ and a ninth quantity of very-hot (e.g., 950-1200° C.) scrap metal. With the assistance of one or more air or N₂ blower(s) 12030, the fifteenth quantity of cold (e.g., 40° C.) air or N₂ is blown into the top of the one or more very-high-temperature, heat-storage vessel(s) 12002 through first port 12002a, completing the high-temperature, heat-transfer loop. The ninth quantity of very-hot (e.g., 950-1200° C.) scrap metal is sent to the one or more EAF(s) 12060 as described above.

It will also be appreciated that that all temperatures and pressures mentioned throughout the foregoing discussion are approximate and used for the purpose of helping to more fully explain the various operations carried out by the various systems described herein, and are therefore non-limiting. It is, of course, possible to use different combinations of temperature and pressure to suit any specific application.

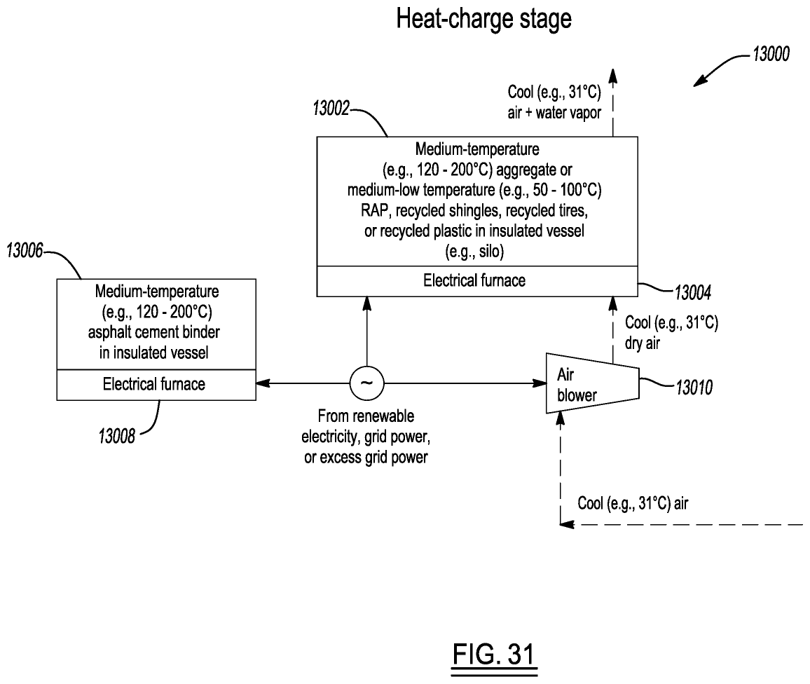

### Systems and Methods for Manufacturing Low-Carbon Warm Mix Asphalt (WMA) and Hot Mix Asphalt (HMA) (FIGS. 31-33)

The embodiments in this disclosure can replace combustion heat with renewable energy in the form of electricity from variable renewable energy (VRE), such as photovoltaic (PV) solar power and clean hydrogen (H₂), as shown in Figures, to be discussed in the following paragraphs. The systems and methods discussed herein use granular media to function as a heat-storage medium that enables renewable energy or excess energy, such as from a power grid, to be time-shifted from when it is available to when it is needed by an industrial process. These systems and methods described herein use heated granular media to function as a heat-transfer medium, which directly transfers stored heat to warm mix asphalt (WMA) and hot mix asphalt (HMA) industrial processes.

Note also that the heated granular media is also a raw material used in WMA or HMA manufacturing plants. The granular heat-storage/heat-transfer media can include, without limitation, aggregate, including virgin aggregate, and recycled materials, such as, without limitation, reclaimed asphalt pavement (RAP), reclaimed roofing shingles, reclaimed tires, reclaimed plastic, or other reclaimed materials, for use as raw materials in a WMA or HMA manufacturing plant. Simply for convenience, all of the foregoing reclaimed materials mentioned above may be referred throughout the following discussion collectively as “reclaimed waste materials” (“RWM”).

The virgin aggregate may be composed of at least a portion of at least one of sand, gravel, crushed rock, or a combination thereof. The systems and methods described herein enable the raw materials that feed a HMA or WMA plants to contain a high fractional content of recycled materials, such as RAP or one or more of other RWM materials, thus reducing the quantity of virgin aggregate required by the plant. With specific regard to RAP, it will be appreciated that RAP typically contains virgin aggregate, which will have resulted in CO₂ emissions during mining and crushing operations, and asphalt cement binder, which will have resulted in CO₂ emissions when it was produced at a crude-oil refinery. The systems and methods described herein can reduce the required quantities of (1) freshly-produced asphalt cement binder and (2) mined virgin aggregate required for the production of a given quantity of HMA or WMA over pre-existing processes.

The systems and methods of the present disclosure produce not just operational benefits, but energy-saving and environmental benefits as well. The energy required to crush RAP using the systems and methods disclosed herein is less than that required to crush mined rock to the particle sizes required by WMA and HMA plants, reducing associated CO₂ emissions. The embodiments of the systems and methods described herein are also highly beneficial in that they operate at lower temperatures than a conventional WMA or HMA plant. This limits aggregate degradation to dust, thus reducing the loss of a valuable raw material as well as reducing bag-house filtration costs, all while still maintaining the strength of the aggregate.

The much lower process temperatures required by the systems and methods described herein also limit the volatilization and oxidation of asphalt cement binder, thus reducing the loss of a valuable raw material. This also helps to reduce noxious atmospheric emissions that cause “blue smoke” and objectionable odors that can make it difficult to locate HMA plants close to population centers.

Replacing virgin aggregate and fresh asphalt cement binder with RAP or possibly one or more other ones of RWMs can also result in a large percentage of the raw materials that feed a WMA or HMA plant being locally sourced, thus reducing transportation costs, wear and tear on roads, and associated CO₂ emissions. The systems and methods disclosed herein also reduce the need to site WMA and HMA plants close to aggregate quarries, allowing the WMA and HMA plants to be sited closer to population centers where asphalt pavement projects are more frequently needed and undertaken. Altogether, the systems and methods disclosed herein play an important role in enabling a circular economy, that is, by reducing CO₂ emissions by virtue of recycling, replacing the heat generated by the combustion of fossil fuel with heat generated from VRE sources, such as PV solar power, and by implementing more efficient, sustainable industrial practices.

Referring to FIG. 31, a heat-charge system 13000 in accordance with another embodiment of the present disclosure for performing asphalt mixing will now be discussed. The system in this example includes at least one first insulated temperature storage vessel or subsystem 13002 for storing medium-temperature (e.g., 120-200° C.) aggregate or medium-low-temperature (e.g., 50-100° C.) reclaimed asphalt pavement (RAP). Optionally, a plurality of first insulated temperature storage vessels or subsystems may be used. Merely for convenience, the one or more first thermally insulated storage vessel(s) or subsystem(s) 13002 will be referred to throughout the following discussion simply as the first “insulated storage vessel” 13002. The first insulated storage vessel 13002 in one embodiment is a silo. The first insulated storage vessel 13002 includes at least one associated furnace, which in one example is an electrical furnace 13004. One or more second insulated temperature storage subsystems or vessels 13006 is/are included for storing medium-temperature (e.g., 120-200° C.) an asphalt binding component, and will be referred to throughout the following discussion simply as the second “insulated storage vessel 13006”. In one example, without limitation, the asphalt binding component may be asphalt cement binder. At least one second furnace, which in one example is a second electrical furnace 13008, is associated with the second insulated storage vessel 13006.

Initially, electricity, including electricity from an electrical power grid, which may include excess electricity from an electrical power grid, and/or electricity from one or more variable renewable energy (VRE) sources may be used to power the one or more electrical furnaces 13004 and/or 13008, as well as one or more air blower(s) 13010. With the assistance of the one or more air blower(s) 13010, a first quantity of cool (e.g., 31° C.) air is sent to the one or more electrical furnace(s) 13004 to produce at least one of a second quantity of medium-temperature (e.g., 120-200° C.) air or medium-low-temperature (e.g., 50-100° C.) air. It shall be appreciated that the first quantity of cool air is sufficient to generate a second quantity of medium-temperature air or medium-low-temperature air at the desired target storage temperature.

The second quantity of air is sent to the first insulated storage vessel 13002 to heat the one or more granular-media bed(s) contained therein. This process continues until most (e.g., 90%) of the one or more granular bed(s) has attained the target storage temperature (e.g., about 120-200° C. for aggregate and about 50-100° C. for RAP). It shall be appreciated that the first insulated storage vessel 13002 may resemble a storage silo that is typically used at WMA and HMA plants. Electricity, including electricity from the power grid, which may include excess electricity from the power grid, and/or electricity from VRE sources may also be used to power the one or more electrical furnace(s) 13008 used to heat the asphalt binder component (e.g., asphalt cement binder), which is stored in the second insulated storage vessel 13006.

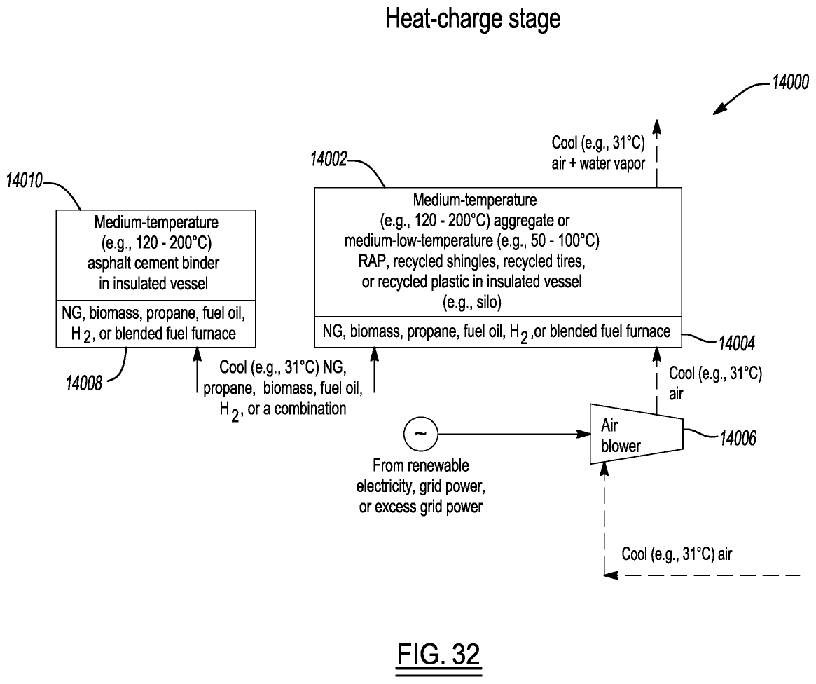

Referring now to FIG. 32, a system 14000 in accordance with another embodiment for generating heat useful in asphalt mix production will be described. The system 14000 is somewhat similar to the system 13000 in that the system 14000 incorporates at least one thermally insulated storage vessel(s) 14002 (and optionally a plurality of such insulated storage vessels 14002) for storing medium-temperature (e.g., 120-200° C.) aggregate and/or medium-to-low-temperature (e.g., 50-100° C.) RAP. The at least one storage vessel 14002 may include one or more silos. At least furnace 14004 (or optionally a plurality of furnaces 14004) is included which is associated with the storage vessel 14002, and which can be powered by one or more of natural gas (NG), propane, fuel oil, hydrogen (H₂), biomass, or even a combination thereof. At least one air blower 14006 is also included for providing cool (e.g., 31° C.) air to the one or more furnaces 14004. Optionally a plurality of the air blowers 14006 may be used.

One or more second insulated temperature storage subsystems or vessels 14006 is/are included for storing medium-temperature (e.g., 120-200° C.) an asphalt binding component, and will be referred to throughout the following discussion simply as the second “insulated storage vessel 14010”. In one example, without limitation, the asphalt binding component may be asphalt cement binder. At least one second furnace 14008 (or optionally a plurality of furnaces 14008) is included which is associated with the storage vessel 14006, and which can be powered by one or more of natural gas (NG), propane, fuel oil, hydrogen (H₂), biomass, or even a combination thereof to heat the asphalt binder component (e.g., asphalt cement binder), which is stored in the second insulated storage vessel 14010.

Merely for convenience, for the following description, reclaimed asphalt pavement (RAP) is used to refer to at least one of RAP, reclaimed roofing shingles, reclaimed tires, reclaimed plastic, or some other recycled material (i.e., some other RWM material) that an operator deems to be appropriate for the manufacture of WMA or HMA. The third quantity of air is sent to the storage vessel 14004 to heat the one or more granular-media bed(s) (i.e., aggregate and/or RAP) contained therein. This process continues until most (e.g., 90%) of the one or more granular bed(s) has attained the target storage temperature (e.g., 120-200° C. for aggregate and 50-100° C. for RAP). It shall be appreciated that the insulated storage vessel 14002 may be formed by one or more conventional storage silos.

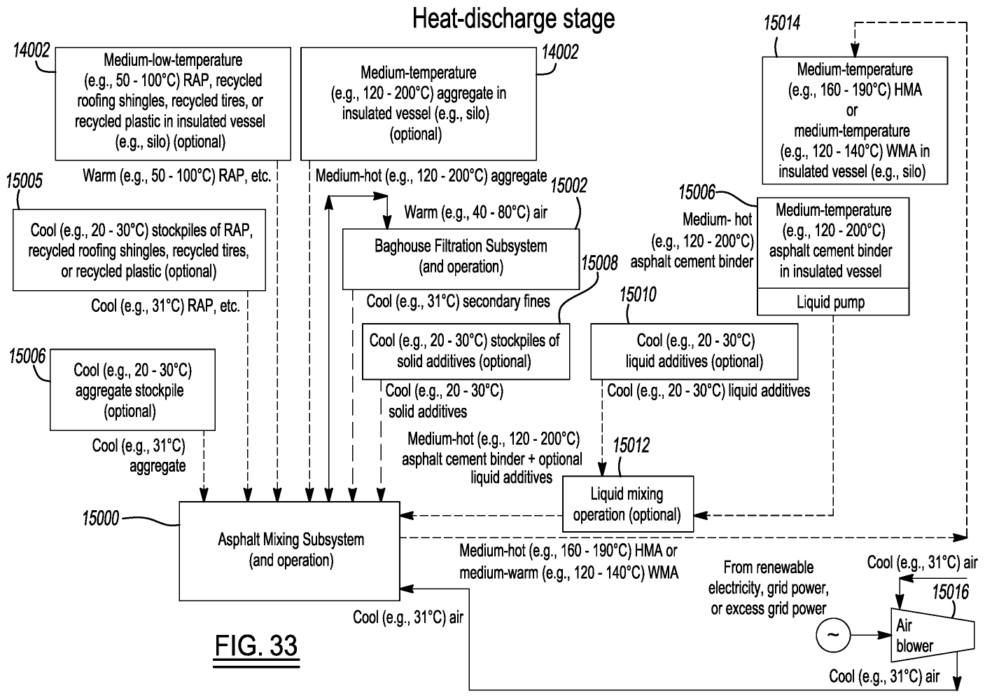

Referring now to FIG. 33, a heat-discharge stage of operation using one or more of the subsystems of systems 13000 or 14000 will be described. The heat-discharge operation in this example uses two thermally insulated storage vessels 14002 to help carry out the heat-discharge operation, which is carried out to manufacture warm mix asphalt (WMA) or hot mix asphalt (HMA). With the assistance of at least one conveyance subsystem (and optionally a plurality of conveyance subsystems, not shown), and with the additional assistance of a liquid pump 15006, a first quantity of medium-hot (e.g., 120-200° C.) aggregate, a second quantity of medium-hot (e.g., 120-200° C.) asphalt binding component (e.g., asphalt cement binder), an optional third quantity of at least one of cool (e.g., 20-30° C.) RAP (or RWM) or warm (50-100° C.) RAP (or RWM), an optional fourth quantity of cool aggregate, an optional fifth quantity of cool (e.g., 20-30° C.) secondary fines, and an optional sixth quantity of cool (e.g., 20-30° C.) solid additives are sent to an asphalt mixing subsystem 15000. Optionally, with the assistance of a liquid mixing operation 15012, a seventh quantity of cool (e.g., 20-30° C.) liquid additives may be mixed with the second quantity of medium-hot (e.g., 120-200° C.) asphalt binding component to form an optional eighth quantity of a medium-hot (e.g., 120-200° C.) mixture of asphalt binding component and liquid additives, which may be sent to an asphalt mixing subsystem 15000. With the assistance of one or more air blower(s), a nineth quantity of cool (e.g., 31° C.) air may be sent to an asphalt mixing subsystem 15000. The asphalt mixing subsystem 15000 may form a portion of either of systems 13000 or 14000, or it may be a separate subsystem apart from the systems 13000 and 14000. The asphalt mixing subsystem 15000 produces a tenth quantity of at least one of WMA (e.g., 120-140° C.) or HMA (e.g., 160-190° C.) and an eleventh quantity of warm (40-80° C.) air, which may be sent to at least one baghouse filtration subsystem 15002 (or optionally a plurality of baghouse filtration subsystems 15002) for performing at least one baghouse filtration operation. With the assistance of at least one conveyance subsystem (not shown; more than one conveyance subsystem may also be used), the WMA (e.g., at 120-140° C.) or hot HMA (e.g., at 160-190° C.) is sent to at least one insulated storage vessel 15014 (or optionally a plurality of insulated storage vessels 15014). It shall be appreciated that the one or more insulated storage vessels may also be formed by well-known storage silos.

With all of the embodiments and operations discussed herein, all of the temperatures and pressures mentioned throughout the patent disclosure are approximate and used for the purpose of illustrating and explaining the various embodiments and operations. It is, of course, possible to use different combinations of temperature to suit specific WMA or HMA operations.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A system for storing and time-shifting at least one of electrical power, excess electrical power, or renewable electrical power, to create low-carbon heat for future use in assisting with a production of an asphalt paving material manufacturing component, the system comprising:
a first thermally insulated storage subsystem containing a quantity of an asphalt paving material manufacturing component;
a first furnace configured to heat the asphalt paving material manufacturing component using an available supplemental energy source;
a second thermally insulated storage subsystem configured to store a quantity of asphalt binder;
a second furnace operably associated with the second thermally insulated storage subsystem for heating the quantity of asphalt binder; and
an air blower configured to supply a quantity of air to the first furnace to assist in heating during a heat-charge phase of operation of the system in which both the quantity of asphalt paving material manufacturing component and the quantity of asphalt binder are pre-heated.

2. The system of claim 1, wherein the supplemental energy source includes at least one of;
electrical power from an electrical power grid;
excess electricity from an electrical power grid;
electricity from a renewable electricity power source;
natural gas (NG);
propane;
fuel oil;
biomass;
H₂; or
a mixture thereof.

3. The system of claim 2, further comprising the supplemental energy source.

4. The system of claim 1, wherein the first furnace comprises an electrical furnace configured to be powered using energy from at least one of the power grid or the renewable electricity power source.

5. The system of claim 1, wherein the first furnace comprises a furnace configured to be powered from at least one of natural gas (NG), propane, fuel oil, H₂, biomass, or a mixture thereof.

6. The system of claim 1, wherein the second furnace comprises a furnace powered by at least one of:
electrical power received from an electrical power grid;
electrical power received from a renewable electrical power source;
biomass;
natural gas (NG);
propane;
fuel oil;
H₂; or
a combination thereof.

7. The system of claim 1, wherein the air blower delivers the quantity of air to the first furnace.

8. The system of claim 1, wherein the asphalt paving material manufacturing component comprises aggregate, and the aggregate comprises at least one of sand, gravel, crushed rock, or a mixture thereof.

9. The system of claim 8, wherein the first thermally insulated storage subsystem is configured to store the aggregate at a temperature of between 120-200° C.

10. The system of claim 1, wherein the second thermally insulated storage subsystem is configured to store the asphalt binder at a temperature of between 120-200° C.

11. The system of claim 1, wherein the asphalt paving material manufacturing component comprises at least one of:
reclaimed asphalt pavement (RAP);
reclaimed asphalt shingles;
reclaimed tires;
reclaimed plastic; or
a combination thereof.

12. The system of claim 11, wherein the first thermally insulated storage subsystem is configured to store the at least one of RAP, reclaimed asphalt shingles, reclaimed tires, reclaimed plastic, or combination thereof at a temperature between 50-100° C.

13. The system of claim 1, further comprising an asphalt paving material mixing subsystem for receiving the at least one of aggregate, RAP, reclaimed asphalt shingles, reclaimed tires, reclaimed plastic, or combination thereof, together with the quantity of asphalt binder, during a heat-discharge phase of operation of the system, and generating at least one of:
hot mixed asphalt (HMA); or
warm mixed asphalt (WMA).

14. The system of claim 13, wherein the asphalt mixing subsystem is configured for receiving a quantity of cool air, and the system further comprising one or more air blowers.

15. The system of claim 13, wherein the asphalt mixing subsystem is configured to output a quantity of warm air, and the system further comprising:
a baghouse filtration system configured to receive the quantity of warm air and to generate a quantity of cooled secondary fines having a temperature below the warm air, the cooled secondary fines being output to an input of the asphalt mixing subsystem.

16. The system of claim 13, further comprising a thermally insulated asphalt mix storage subsystem for storing at least one of the HMA or the WMA output by the asphalt mixing subsystem.

17. The system of claim 16, wherein the thermally insulated asphalt mix storage subsystem comprises a storage vessel for containing at least one of:
the HMA at a temperature range of between 160-190° C.; or
the WMA at a temperature range of between 120-140° C.

18. A system for storing and time-shifting at least one of electrical power from a power grid, excess electrical power from a power grid, or renewable electrical power, to create low-carbon heat for use in preheating components used in manufacturing asphalt mix, and for manufacturing asphalt mix, the system comprising:
a first thermally insulated storage subsystem containing a quantity of at least one of aggregate, reclaimed asphalt pavement (RAP), reclaimed asphalt shingles, reclaimed tires, or reclaimed plastic for use in manufacturing asphalt mix;
a first furnace configured to heat the at least one of the aggregate, the RAP, the reclaimed asphalt shingles, the reclaimed tires, or the reclaimed plastic using an available supplemental energy source;
a second thermally insulated storage subsystem configured to store a quantity of asphalt binder;
a second furnace operably associated with the second thermally insulated storage subsystem for heating the quantity of asphalt binder; and
an air blower configured to supply a quantity of air to the first furnace to assist in a heating during a heat-charge phase of operation of the system;
an asphalt mixing subsystem configured to carry out a heat-discharge operation including:
receiving at least one of the aggregate, RAP, reclaimed asphalt shingles, reclaimed tires, reclaimed plastic or a mixture thereof, and the asphalt binder; and
mixing the at least one of aggregate, RAP reclaimed asphalt shingles, reclaimed tires, reclaimed plastic or mixture thereof, and the asphalt binder to produce at least one of hot mixed asphalt (HMA) or warm mixed asphalt (WMA).

19. The system of claim 18, further comprising one or more air blowers, and the asphalt mixing subsystem configured to receive a quantity of cool air.

20. The system of claim 18, further comprising a baghouse filtration system configured to receive a quantity of warm air generated by the asphalt mixing subsystem and to generate a quantity of cooled secondary fines, the cooled secondary fines being output to an input of the asphalt mixing subsystem.

21. The system of claim 18, wherein the first thermally insulated storage subsystem is configured to heat at least one of:
the aggregate to a temperature of between 120-200° C.; or
the at least one of RAP, reclaimed asphalt shingles, reclaimed tires, or reclaimed plastic to a temperature of between 50-100° C.

22. The system of claim 18, wherein the second furnace is configured to store the asphalt binder component at a temperature of between 120-200° C., and wherein the asphalt binder component comprises asphalt cement binder.

23. A method for storing and time-shifting at least one of electrical power, excess electrical power, or renewable electrical power, to create low-carbon heat for future use in assisting with a production of asphalt mix, the method comprising:
using a first thermally insulated storage subsystem to store at least one of a quantity of aggregate or a quantity of at least one of reclaimed asphalt pavement (RAP), reclaimed asphalt shingles, reclaimed tires, or reclaimed plastic;
using a first furnace to heat at least one of:
the aggregate, using an available supplemental energy source, to a temperature of between 120-200° C.; or
the at least one of RAP, reclaimed asphalt shingles, reclaimed tires, reclaimed plastic or a mixture thereof, using the available supplemental energy source, to a temperature between 50-100° C.
using a second thermally insulated storage subsystem to store a quantity of asphalt binder;
using a second furnace to heat the quantity of asphalt binder; and
supplying a quantity of air to at least one of the first furnace to assist in heating during a heat-charge phase of operation in which both the quantity of asphalt manufacturing component and the quantity of asphalt binder are pre-heated.
